(19) United States
(12) Patent Application Publication
(10) Pub. No.: US 2025/0053845 A1
(43) Pub. Date: Feb. 13, 2025

(54) NON-GAUSSIAN STATE GENERATION USING CLUSTER STATES

(71) Applicants: University of Virginia Patent Foundation, Charlottesville, VA (US); The Royal Melbourne Institute of Technology, Melbourne (AU)

(72) Inventors: Miller Thomas Eaton, Waldorf, MD (US); Carlos Gonzalez-Arciniegas, Charlottesville, VA (US); Olivier Pfister, Charlottesville, VA (US); Rafael Alexander, Reservoir, Victoria (AU); Nicolas Menicucci, Hawthorn, Victoria (AU)

(73) Assignees: University of Virginia Patent Foundation, Charlottesville, VA (US); The Royal Melbourne Institute of Technology, Melbourne (AU)

(21) Appl. No.: 18/715,074

(22) PCT Filed: Nov. 29, 2022
(86) PCT No.: PCT/US2022/051295

§ 371 Date: May 30, 2024

Related U.S. Application Data
(60) Provisional application No. 63/284,721, filed on Dec. 1, 2021.

(51) Int. Cl. G06N 10/60; G06N 10/40

(52) U.S. Cl. CPC G06N 10/60; G06N 10/40

(57) ABSTRACT

Methods are disclosed for generating, manipulating, and controlling non-Gaussian quantum states in continuous variable cluster quantum states usable for quantum computing. Some methods can be used to generate, transport, and enlarge Schrödinger-Cat states embedded in the CV cluster quantum state. Some methods can be used to transform Schrödinger-Cat states embedded in the CV quantum cluster state to grid states (such as Gottesman-Kitaev-Preskill states) and enlarge the grid states. In certain embodiments, some of the methods may be used to generate and control non-Gaussian states in macronode cluster quantum states such as cluster states comprising two-mode macronodes.

### CROSS-REFERENCE TO RELATED APPLICATION

This application claims priority to U.S. Provisional Patent Application No. 63/284,721, filed Dec. 1, 2021, titled “Non-Gaussian state generation using cluster states,” the entire contents of which are incorporated by reference herein and made part of this specification.

### BACKGROUND

### Technical Field

This disclosure relates to methods of generating and manipulating various quantum states. In particular, the methods described herein may be used to generate and manipulate various quantum states of a continuous variable cluster state, notably quantum states required for universal and fault-tolerant quantum computation (QC).

### Description of Related Art

Quantum computation (QC) holds the potential to solve problems intractable to classical computation by manipulating quantum information across large-scale entangled states. Implementations of quantum computing protocols and algorithms remain challenging due to the presence of errors, quantum decoherence, and difficulties in scaling the number of quantum resource (e.g., qubits). Measurement-based QC over continuous variable (CV) cluster sates is an alternative method of quantum computing that may solve some of the existing problems through the use of massively scalable CV cluster states, which can be experimentally generated, e.g., at room temperature and in the optical domain. Such CV cluster states may have tens to thousands or millions of entangled qumodes, the equivalent of qubits in discrete QC. Under this paradigm, the cluster state acts as an up-front resource substrate for QC, where all calculations are enacted through measurements on the substrate.

### SUMMARY

The systems, methods, and devices of this disclosure each have several innovative aspects, no single one of which is solely responsible for all of the desirable attributes disclosed herein. Some implementations are summarized in this section, and other implementations are disclosed elsewhere in this specification. Details of one or more implementations of the subject matter described in this specification are set forth in the accompanying drawings and the description below.

This disclosure describes methods and systems for generating, manipulating and controlling non-Gaussian quantum states in continuous variable cluster quantum states usable for quantum computing. Some methods can be used to generate, transport, and enlarge Schrödinger-Cat states embedded in the CV cluster quantum state. Some methods can be used to transform Schrödinger-Cat states embedded in the CV quantum cluster state to grid states (such as Gottesman-Kitaev-Preskill states) and enlarge the grid states. In various implementations, a grid state may comprise an approximate grid state. In certain embodiments, some of the methods may be used to generate and control non-Gaussian states in macronode cluster quantum states such as cluster states comprising macronodes of two or more modes. In some cases, some of the methods may be used to generate compass states in a cluster state or in a macronode cluster state.

Certain embodiments of the present disclosure relate to a method of generating a cat state embedded in a one-dimensional (1D) canonical cluster state generated by a source of entangled cluster state modes. The method may include: receiving a pair of entangled modes of the 1D canonical cluster state where the pair of entangled modes includes a first mode having a first initial state and a second mode having a second initial state, selecting the first mode of the pair of entangled modes, performing photon subtraction on the first mode by at least splitting a first optical field associated with the first mode into a first portion and a second portion of the first optical field, performing a photon-number-resolving detection on the first portion to transform the first initial state of the first mode to a non-Gaussian state, performing a first homodyne detection on the second portion to teleport the non-Gaussian state of the first mode to the second mode and transform the second initial state of the second mode to a teleported non-Gaussian state; and performing a feed-forward Gaussian operation on the second mode to transform the teleported non-Gaussian state of the second mode to the first cat state embedded in the 1D canonical cluster state.

In some cases, the method described above may be used to generate a compass state embedded in the 1D canonical cluster state. For example, the method described above, may further include: performing photon subtraction by splitting a second optical field associated with the first cat state of the second mode into a third portion and a fourth portion of the second optical field; performing a photon-number-resolving detection on the third portion; performing a homodyne detection on the fourth portion to teleport the cat state to a fourth mode of the 1D cluster state causing transformation of an initial state of the fourth mode to a third non-Gaussian state; and performing a feed-forward Gaussian operation on the third non-Gaussian state to transform the state of the fourth mode to the compass state embedded in the 1D canonical cluster state.

Certain embodiments of the present disclosure relate to a method of generating a squeezed cat state embedded in a one dimensional (1D) canonical cluster state generated by a source of entangled state modes. In some cases, the method may include: receiving a pair of entangled modes from the source of entangled cluster state modes, selecting a first mode of the pair of entangled modes in the 1D canonical cluster state, performing a squeezing operation on the first mode of the pair of entangled modes in the cluster state to squeeze the state of the first mode, and performing a photon-number-resolving detection on the squeezed state of the first mode to transform the state of a second mode of the pair of the entangled modes to a squeezed cat state embedded in the 1D canonical cluster state, wherein the second mode is an unmeasured mode.

Certain embodiments of the present disclosure relate to a method of preserving an amplitude of a cat state transported from a first mode of a cluster state to a second mode of the cluster state, the method may include: receiving a pair of entangled modes from a source of entangled cluster state modes comprising the first mode and the second mode; performing photon subtraction by at least splitting light associated with the first mode into a first portion and a second portion, wherein the first mode comprises a first cat state having a first amplitude and a first nodal location; performing a photon-number-resolving detection on the first portion; performing a homodyne detection on the second portion to teleport the first cat state to a non-Gaussian state of the second mode; and performing a feed-forward Gaussian operation on the second mode to transform the non-Gaussian state to a second cat state in a second nodal location that has a transport distance from the first nodal location, wherein the second cat state has a second amplitude that has reduced decay relative to the first amplitude compared to a cat state that is transported over the same transport distance without performing photon subtraction.

Certain embodiments of the present disclosure relate to a method of enlarging cat states embedded within a cluster state. In some cases, the method may include: receiving a pair of entangled modes in the cluster state, the pair of entangled modes comprising a first mode prepared in a first cat state and a second mode prepared in a second cat state, where the first cat state includes a superposition displacement along the p-quadrature, and the second cat state includes a cat state identical to the first cat state rotated by π/2, performing a homodyne detection on the first mode to transform the state of the second mode from the second cat state to a non-Gaussian state, performing a feed-forward Gaussian operation on the second mode to transform the non-Gaussian state to an enlarged cat state embedded in the cluster state, where the enlarged cat state has an amplitude larger than the amplitude of the first or the second cat state.

Certain embodiments of the present disclosure relate to a method of breeding grid states in a cluster state having embedded cat states. In some cases, the method may include: receiving a pair of entangled modes in the cluster state, the pair of entangled modes including a first mode prepared in a first cat state and a second mode prepared in a second cat state, wherein the first cat state has a superposition displacement along the q-quadrature, and the second cat state is rotated by π/2 with respect to the first cat state, performing a homodyne detection on the first mode to transform the state of the second mode to a first displaced grid state, and performing a feed-forward Gaussian operation on the second mode to transform the first displaced grid state to a grid state embedded in the cluster state.

Certain embodiments of the present disclosure relate to a method of estimating a phase of an operator configured to operate on a cluster state, the method may include: receiving a first mode of the cluster state, where the first mode comprises quantum information; receiving a second mode of the cluster state, wherein the second mode is in a squeezed cat state; performing a homodyne measurement on the second mode to teleport the squeezed cat state to a transformed state of the first mode; performing a feed-forward Gaussian operation on the first mode to generate an output state from the transformed state; and estimating the phase of the operator by at least measuring the output state and processing the result of the output state measurement.

Certain embodiments of the present disclosure relate to a method of teleporting states of modes of a macronode of a one-dimensional (1D) macronode cluster state to a non-Gaussian state, the method may include: performing photon subtraction by splitting light associated with a first mode of the macronode in the macronode cluster state into a first portion and a second portion; performing a photon-number-resolving detection on the first portion; performing a p-basis homodyne detection on the second portion and performing a q-basis homodyne detection on a second mode of the macronode, to teleport states of the first and the second mode to a third mode of a neighboring macronode causing transformation of a state of the third mode to the non-Gaussian state.

Certain embodiments of the present disclosure relate to a method of teleporting states of modes of a macronode of a one-dimensional (1D) macronode cluster state to a non-Gaussian state, the method may include: performing a first photon subtraction by splitting light associated with a first mode of the macronode mode in the macronode cluster state, into a first portion and a second portion; performing a second photon subtraction by splitting light associated with a second mode of the macronode mode in the macronode cluster state, into a third portion and a fourth portion; splitting the second portion into a second transmitted portion and a second reflected portion; splitting the third portion into a third transmitted portion and a third reflected portion; forming a first mixed portion by interfering the second reflected portion and the third transmitted portion; forming a second mixed portion by interfering the third reflected portion and the second transmitted portion; performing a first photon-number-resolving detection on the first mixed portion; performing a second photon-number-resolving detection on the second mixed portion; performing a p-basis homodyne detection on the first portion and performing a q-basis homodyne detection on the fourth portion, to teleport states of the first and the second mode to a third mode of a neighboring macronode causing transformation of a state of the third mode to the non-Gaussian state; and performing a feed-forward operation on the third mode to remove a displacement of the non-Gaussian state.

Certain embodiments of the present disclosure relate to a method of teleporting states of modes of a macronode of a one-dimensional (1D) macronode cluster state to a non-Gaussian state, the method may include: performing a p-basis homodyne detection on a first mode of the macronode in the 1D macronode cluster state to teleport a state of the first mode to a third mode of a neighboring macronode; performing a first photon subtraction by splitting light associated with a second mode of the macronode in the 1D macronode cluster state, into a first portion and a second portion; performing a second photon subtraction by splitting light associated with a third mode of a neighboring macronode mode in the macronode cluster state, into a third portion and a fourth portion; splitting the second portion into a second transmitted portion and a second reflected portion; splitting the third portion into a third transmitted portion and a third reflected portion; forming a first mixed portion by interfering the second reflected portion and the third transmitted portion; forming a second mixed portion by interfering the third reflected portion and the second transmitted portion; performing a first photon-number-resolving detection on the first mixed portion; performing a second photon-number-resolving detection on the second mixed portion; performing a q-basis homodyne detection on the first portion to teleport the state of the second mode to the third mode causing transformation of a state of the third mode to the non-Gaussian state; and performing a feed-forward operation on the third mode to remove a displacement of the non-Gaussian state.

Certain embodiments of the present disclosure relate to a method of teleporting states of a macronodes of a one-dimensional (1D) macronode cluster state to a non-Gaussian state, the method may include: performing a squeezing operation on the first mode of the macronode in the 1D macronode cluster state, to generate a first squeezed state of the first mode; performing a photon-number-resolving detection on the first squeezed state; performing a p-basis or a q-basis homodyne detection on a second mode of the macronode to teleport a state of the second mode to a third mode of a neighboring macronode causing transformation of a state of the third mode to the non-Gaussian state; and performing a feed-forward operation on the third mode to remove a displacement of the non-Gaussian state.

Certain embodiments of the present disclosure relate to a quantum system for generating a first cat state embedded in a one-dimensional (1D) canonical cluster state, where the 1D canonical cluster state is a continuous variable (CV) quantum cluster state of a plurality of modes, and wherein each individual mode of the plurality of modes comprises an optical field, the system may include: a quantum apparatus configured to generate the plurality of modes forming the 1D canonical cluster state, the plurality of modes comprising at least one pair of entangled modes comprising a first mode having a first initial state and a second mode having a second initial state; a measurement system configured to control and perform measurement on optical fields of the individual modes of the plurality of modes, the measurement system comprising: a beam splitter configured to split the optical fields; a homodyne measurement device; a photon counter; and a controller comprising: a non-transitory memory configured to store specific computer-executable instructions for controlling and measuring the optical fields; and an electronic processor in communication with the non-transitory memory and configured to execute the specific computer-executable instructions to at least: select a first mode of the pair of entangled modes and split a first optical field associated with the first mode into a first portion and a second portion of the first optical field using the beam splitter; perform a photon-number-resolving detection on the first portion using the photon counter, wherein the photon-number-resolving detection transforms the initial state of the first mode to a non-Gaussian state; perform a homodyne detection on the second portion using the homodyne measurement device, to teleport the non-Gaussian state to the second mode to transform the state of the second mode from the second initial state to a teleported non-Gaussian state; and perform a feed-forward Gaussian operation on the second mode to transform the teleported non-Gaussian state of the second mode to the first cat state embedded in the 1D canonical cluster state.

Certain embodiments of the present disclosure relate to a method of teleporting states of a macronode in a one-dimensional (1D) macronode cluster state to a displaced weighted compass state embedded in the 1D macronode cluster state, the method may include: performing a first photon subtraction by splitting light associated with a first mode of the macronode into a first portion and a second portion; performing a photon-number-resolving detection on the first portion; performing a second photon subtraction by splitting light associated with a second mode of the macronode into a third portion and a fourth portion; performing a photon-number-resolving detection on the third portion; and performing a p-basis homodyne detection on the second portion and a q-basis homodyne detection on the fourth portion to teleport the states of the first macronode to a third mode of a neighboring macronode and to transform the state of the third mode to a displaced weighted compass state.

Certain embodiments of the present disclosure relate to a method of generating a first non-Gaussian state embedded in a cluster state, wherein the cluster state is a continuous variable (CV) quantum cluster state, the method may include: performing photon subtraction on a first mode of the cluster state to transform a first initial state of the first mode to a first initial non-Gaussian state, wherein the first mode is entangled to a second mode of the cluster state; and teleporting the first initial non-Gaussian state of the first mode to the second mode to transform a second initial state of the second mode to the first non-Gaussian state of the second mode, embedded in the cluster state.

Certain embodiments of the present disclosure relate to a method of generating a continuous variable (CV) quantum cluster state having an embedded non-Gaussian state, the method may include: receiving a first mode and a second mode each having a squeezed vacuum quantum state; entangling the first mode to the second mode to form an entangled pair; performing photon subtraction on the first mode of the entangled pair to transform an initial state of the first mode to an initial non-Gaussian state; teleporting the initial non-Gaussian state of the first mode to the second mode to transform an initial state of the second mode to a non-Gaussian state of the second mode to a non-Gaussian state; entangling the second mode to a third mode; and entangling the second mode to a fourth mode.

Certain embodiments of the present disclosure relate to a method for generating a squeezed cat state embedded in a cluster state, the method may include: performing a squeezing operation on a first mode of a pair of entangled modes in the cluster state to squeeze the state of the first mode; and performing a photon subtraction on the first mode to transform the state of a second mode of the pair of the entangled modes to the squeezed cat state.

Certain embodiments of the present disclosure relate to a quantum system for generating a non-Gaussian state embedded in a continuous variable (CV) quantum cluster state of a plurality of modes, and wherein each individual mode of the plurality of modes comprises an optical field, the system may include: a quantum apparatus configured to receive a pair of entangled modes of the plurality of modes comprising a first mode having a first initial state and a second mode having a second initial state; a measurement system configured to control and perform measurement on optical fields of the individual modes of the plurality of modes, the measurement system comprising: a photon counter configured to measure a number of photons in optical fields; a homodyne measurement device. The quantum system may further include a controller comprising: a non-transitory memory configured to store specific computer-executable instructions for controlling and measuring the optical fields, and an electronic processor in communication with the non-transitory memory and configured to execute the specific computer-executable instructions to at least: select a first mode of the pair of entangled modes and perform a photon-number-resolving detection on a portion of an optical field associated with the first mode using the photon counter, wherein the photon-number-resolving detection transforms the initial state of the first mode to an initial non-Gaussian state; perform a homodyne detection on the second portion using the homodyne measurement device, to teleport the initial non-Gaussian state to the second mode and to transform the state of the second mode from the second initial state to the non-Gaussian state.

Certain embodiments of the present disclosure relate to a method of preserving an amplitude of a first non-Gaussian state transported from a first nodal location in a cluster state to a second nodal location in the cluster state, the method may include: performing photon subtraction on a first mode at the first nodal location, the first mode comprising the non-Gaussian state and having a first amplitude; performing a homodyne detection on the first mode to teleport the non-Gaussian state to a second non-Gaussian state of a second mode at the second nodal location, wherein the second non-Gaussian state has a second amplitude that has reduced decay relative to the first amplitude compared to a non-Gaussian state that is transported over the same transport nodal distance without performing photon subtraction.

### BRIEF DESCRIPTION OF THE DRAWINGS

The systems, methods, and devices of this disclosure each have several innovative aspects, no single one of which is solely responsible for all of the desirable attributes disclosed herein. Details of one or more implementations of the subject matter described in this specification are set forth in the accompanying drawings and the description below.

FIG. 1A illustrates a teleportation circuit in canonical form.

FIG. 1B illustrates an example quantum circuit representing a conventional process for teleporting states between the nodes of a cluster state.

FIG. 1C illustrates an example process (quantum circuit) representing the Photon-counting Assisted Node Teleportation Method (PhANTM) for transforming the state of a node in a CV cluster state to a cat state of a neighboring node.

FIG. 1D is a flow diagram illustrating an example process that may be used by a quantum computing system to generate a non-Gaussian state.

FIG. 1E is a flow diagram illustrating another example process that may be used by a quantum computing system to generate a non-Gaussian state.

FIG. 2A illustrates a teleportation circuit with photon subtraction.

FIG. 2B illustrates a non-Gaussian subtraction and teleportation circuit.

FIG. 2C illustrates a teleportation circuit that modifies the input followed and applies a Q operator to a power.

FIG. 2D shows an example process (quantum circuit) for generating a squeezed cat state by performing a squeezing operation followed by Photon Number Resolving (PNR) measurement on a node of a canonical 1D cluster state.

FIG. 2E illustrates the Wigner functions of three cat states resulting from the process shown in FIG. 2D after 5 (left diagram), 10 (center diagram), and 15 (right diagram) photon detection events, respectively.

FIG. 2F shows the probability distribution of the photon detection events in the process shown in FIG. 2D.

FIG. 2G is a flow diagram illustrating an example process that may be used by a quantum computing system to generate a non-Gaussian state without photon subtraction.

FIG. 3A illustrates fidelity of Hermit polynomials in Q operator to leading order powers in of Q operator plotted against squeezing level of a cluster state node.

FIG. 3B shows the Wigner functions of the quantum states resulting from applying \hat{Q}^{M} operator to squeezed vacuum for several values of M.

FIG. 3C illustrates results from iterated subtracted teleportation applied to squeezed vacuum with one photon subtracted each instance and stochastic homodyne results. The dotted black line is added as a guide to show the phase of the resultant cat state. Note that the figures have been rescaled to better visualize the fringes

FIG. 4A illustrates a true circuit that represents realistic photon-subtraction during a cluster-state teleportation.

FIG. 4B illustrates the top portion of the circuit shown in FIG. 4A.

FIG. 4C illustrates a teleportation circuit that modifies the input by a function of the Q operator and applies an exponentiated Q operator to a power.

FIG. 5A illustrates transformation of a one-dimensional (1D) cluster state to a cat state by performing PhANTM on the nodes (top diagram), and the Wigner functions of the quantum state at the starting node before performing PhANTM (left bottom diagram) and the Wigner function of the quantum state in the final node after transformation (right bottom diagram).

FIG. 5B illustrates calculated average amplitudes of the cat state generated in FIG. 5A, after 100 trials of performing M steps of PhANTM on the cluster state, plotted against M, for various squeezing levels of the initial states of the nodes of the cluster state.

FIG. 5C illustrates calculated average amplitudes of the resulting cat state in FIG. 2A, for the case starting from an initial state having 17 dB squeezing and after 100 trials of performing M steps of PhANTM, plotted against M. The shaded region depicts two standard deviations in the spread of average amplitudes.

FIG. 6A illustrates the variation of the average amplitude of the cat states transported through a cluster state plotted against the nodal distance over which the cat states are transported. The curves 602 and 604 represent cat states transported using homodyne measurement and the curves 606 and 604 represent cat states transported using the PhANTM process. The dashed curves 604 and 608 represent a cat state having an initial amplitude of 4, and the solid curves 602 and 606 represent a cat state having an initial amplitude of 2.

FIG. 6B shows an alternate representation of the data in FIG. 6A for 80 trajectories at each initial condition, where the radial direction indicates cat-state amplitude, the polar coordinate gives cat state phase, and different shades show the number of node-teleportations from the initial conditions (black dots denoted by arrows).

FIG. 7A illustrates an example method of transforming a (two dimensional) 2D Gaussian cluster state to a 1D cluster state comprising cat states (left diagram), and the Wigner functions of the resulting cat states (right diagram).

FIG. 7B illustrates generation of cat states embedded within a higher-dimensional cluster state by performing measurements on 1D quantum wires. Orange blocks indicate a step of the PhANTM algorithm (attempted photon subtraction, homodyne detection, and feed-forward displacement) and white rings indicate P-basis homodyne measurements. The red nodes represent fully de-Gaussified cat states.

FIG. 8A illustrates an example quantum circuit for teleporting through an ancillary state.

FIG. 8B illustrates an example process (quantum circuit) for enlarging a cat state or generating a grid state by performing a homodyne measurement followed by feedforward displacement on a node in a cat state entangled to another node in another cat state.

FIG. 8C shows the Wigner functions of the initial cat states of node 1 and node 2, and the enlarged cat state generated by the process of FIG. 8A or FIG. 8B.

FIG. 8D shows the Wigner functions of the initial cat states of node 1 and node 2, and the grid state generated by the process of FIG. 8A or 8B.

FIG. 9A shows an average Gottesman-Kitaev-Preskill (GKP) qunaught obtained by performing Gaussian operations and measurements within the cluster state on a pair of states generated from the PhANTM algorithm.

FIG. 9B is a histogram of a fit parameters for the GKP qunaughts bred from all states obtained by the PhANTM algorithm.

FIG. 10 illustrates an example of a breeding process for generating grid states by performing homodyne measurements on nodes of a cluster state and the corresponding Wigner functions of each node during the process.

FIG. 11 illustrates another example of a breeding process for generating grid states by performing homodyne measurements on nodes of a cluster state and the corresponding Wigner functions of each node during the process.

FIG. 12A illustrates a conventional process for estimating a phase of a unitary operator using an ancilla qubit.

FIG. 12B illustrates a process for estimating a phase of a unitary operator configured to operate on a cluster state, using a squeezed Schrödinger cat state.

FIG. 13A illustrates a 1D macromode cluster state comprising two-mode macronodes.

FIG. 13B illustrates an example process (quantum circuit) for teleporting the states of two modes of a macronode of the macromode cluster state shown in FIG. 10A to a third node of a neighboring macronode.

FIG. 14A illustrates a process for teleporting the states of two nodes of a macronode of the macromode cluster state shown in FIG. 13A to a cat state of a third node of a neighboring macronode using photon subtraction from a node of the neighboring macronode.

FIG. 14B illustrates a process for teleporting the states of two nodes of a macronode of the macromode cluster state shown in FIG. 13A to a cat state of a node of a neighboring macronode using coherent photon subtraction from the two nodes of the macronode.

FIG. 14C illustrates a process for teleporting the states of two nodes of a macronode of the macromode cluster state shown in FIG. 13A to a cat state of a node of a neighboring macronode, using coherent photon subtraction from a node of the macronode and the third node of the neighboring macronode.

FIGS. 15A and 15B show two example processes for teleporting the states of two nodes of a macronode in a macronode cluster state to a cat state of a third node of a neighboring macronode using a squeezing operation followed by a PNR (herein referred to as squeezed PNR) detection, performed on a node of the macronode.

FIG. 16A illustrates a circuit representing a local teleportation ‘gadget’ that uses arbitrary and potentially non-Gaussian ancillary inputs to impart non-Gaussianity on a macronode cluster state through teleportation.

FIG. 16B illustrates an equivalent circuit transition between momentum states |m₂> and |m₁>.

FIG. 16C illustrates the ended circuit of FIG. 16B representing an EPR pair.

FIG. 16D is a diagrammatic representation of an operators transferred, or ‘bounced’, from one mode to the other across an EPR pair.

FIG. 17A illustrates an example macronode teleportation circuit that includes finite squeezing.

FIG. 17B illustrates another example macronode teleportation circuit that includes finite squeezing.

FIG. 17C illustrates another example macronode teleportation circuit that includes finite squeezing.

FIG. 17D illustrates another example macronode teleportation circuit that includes finite squeezing.

FIG. 17E illustrates another example macronode teleportation circuit that includes finite squeezing.

FIG. 17F illustrates another example macronode teleportation circuit that includes finite squeezing.

FIG. 18A illustrates the effects of the Q-basis homodyne measurement result on the middle wire in the macronode teleportation scheme with photon subtraction occurring before the P-basis measurement.

FIG. 18B illustrates sending a weighted cat state into one round of PhANTM. Here the initial state is set with A²=⅘, α=4, and s₁=0 while the cluster state is squeezed by 15 dB.

FIG. 19A illustrates a PhANTM step measurement where a loss channel of efficiency η is included before PNR detection (A), before homodyne detection (B), or immediately after squeezing before the Ĉ_{Z} gate is applied (C).

FIG. 19B illustrates Wigner logarithmic negativity (WLN) for a single PhANTM step post-selected on an n=2 photon subtraction and an m=0 homodyne detection with 11 dB of squeezing in the cluster state where losses occur at either A, B, or C locations in the PhANTM step measurement for FIG. 19A. The black dashed line indicates the WLN for the ideal (lossless) case.

FIG. 20A illustrates WLN of the embedded state resulting from performing M PhANTM steps where losses occur after squeezed state preparation, before homodyne detection, and before PNR detection. Curves are shown for no loss and losses of 0.1%, 0.5%, and 1%, and the indicated loss occurs at all locations (A, B, and C in FIG. 19A) at each PhANTM step, and at the same locations for the normal teleportation step to reorient the state before the next round of PhANTM.

FIG. 20B illustrates Wigner functions of the embedded states after the M=10 PhANTM step for the given loss.

FIG. 21A illustrates WLN of the embedded state after a single PhANTM step post-selected on a two-photon subtraction where there was a residual displacement error of Δα before PNR detection. Real and imaginary values of Δα were considered separately.

FIG. 21B illustrates Wigner function of an embedded state with no error (panel b). Wigner function for displacement error of Δα=0.2 (panel c), and for displacement error of Δα=0.2i (panel d).

FIG. 22A illustrates transformation of a one-dimensional (1D) cluster state to a compass state by performing consecutive PhANTM operations on the nodes of the cluster state.

FIG. 22B illustrates the Wigner function of an initial vacuum state (left) of a first node of the cluster state shown in FIG. 22A, and the Wigner function of a compass state (right) of the last node of the cluster state transformed by the last PhANTM operation of a sequence of PhANTM operations performed on the cluster state.

FIG. 23 shows an example process for teleporting the states of two nodes of a macronode in a two-node macronode cluster state to a compass state of a third node of a neighboring macronode.

FIG. 24 illustrates an example implementation of an annihilation operator based on a beamsplitter and PNRD.

FIG. 25A illustrates an example quantum circuit for subtraction-assisted teleportation.

FIG. 25B illustrates another example quantum circuit for subtraction-assisted teleportation.

FIG. 26 illustrates Wigner functions of quantum states resulting from iterated PhANTM where measurement results are stochastic. Each Wigner function plotted shows what state is now Ĉ_{Z}′ed to the cluster after the M-th step (black numbering on top left) where the number of subtraction photons from the corresponding step is shown in red at the bottom of each panel.

FIG. 27 illustrates an example quantum circuit for teleportation through a state including a product of cat-like operators acting on squeezed vacuum.

FIG. 28A illustrates an example quantum circuit for breeding cat states.

FIG. 28B illustrates another example quantum circuit for breeding cat states.

FIG. 29A is a block diagram of an example quantum computing system.

FIG. 29B is a block diagram of an example optical quantum computing platform may be used to generate, control, and manipulate photonic CV clusters.

FIG. 29C is a block diagram of an example photonic quantum circuit that may be used to embed a non-Gaussian state in a cluster state.

### DETAILED DESCRIPTION

Although certain embodiments and examples are disclosed below, inventive subject matter extends beyond the specifically disclosed embodiments to other alternative embodiments and/or uses and modifications and equivalents thereof.

Quantum computation (QC) holds the potential to solve problems intractable to classical computation by coherently manipulating quantum information across large-scale entangled states. Implementations, however, remain challenging due to the presence of errors, quantum decoherence, and difficulties in scaling the number of resource qubits.

Measurement-based QC over continuous variables (CV) cluster sates is an alternative method of quantum computing that may solve some of the existing problems through the use of massively scalable CV cluster states, which can be experimentally generated, e.g., at room temperature and in optical domain. Such CV cluster states may have tens to thousands or millions of entangled qumodes, the equivalent of qubits in discrete QC. Under this paradigm, the cluster state acts as an up-front resource substrate for QC, where all calculations are enacted through measurements on the substrate.

CV cluster states may comprise a plurality of entangled qumodes (also referred to as modes), where each qumode is entangled to it nearest neighboring qumodes. A mode or a qumode may comprise an optical field. In some cases, CV cluster states may comprise position-quadrature and momentum-quadrature entangled qumodes. In some cases, these qumodes may comprise squeezed states of light. In some cases, a squeezed state may comprise a finitely squeezed vacuum state. The initial states of the qumodes before formation of the cluster state may comprise squeezed vacuum states having similar or different squeezing levels. In some examples, two qumodes may be entangles via a controlled Z-gate (Ĉ_{Z}). In some examples, the process of entangling two qumodes may comprise time multiplexing. In some cases, despite the finite squeezing of the initial states, CV cluster sates may be used in fault-tolerant universal QC, provided they are supplemented with non-Gaussian resource states or gates.

In some cases, a quantum cluster may comprise a plurality of entangled modes or qumodes. In some cases, a mode or a qumode may comprise an optical field (e.g., a resonant optical field in an optical cavity). In various embodiments disclosed herein, an entangled state, a two-qumode entangled state, a cluster state, or other quantum states, may comprise a state of one or more modes, one or more qumodes. For example, two entangled modes may comprise two optical fields that are in an entangled state, and a quantum cluster may comprise a plurality of optical fields being in a cluster state. In some examples, a cluster state may comprise a canonical cluster state comprising Gaussian states. In some cases, a cluster sate may be represented by a graph (herein referred to as a cluster graph) comprising of nodes where a node represents a qumode, a.k.a. a mode of the cluster state. As such, the state of a node may represent the state of the corresponding mode, a.k.a. qumode, and the operations performed on the cluster state may be interchangeably expressed based on modes or nodes. For example, teleporting a mode or performing a homodyne measurement (also referred to as homodyne detection) on a mode may be expressed as teleporting a respective node or performing a homodyne measurement on the respective node (in the cluster graph). In some cases, a quantum cluster may comprise a plurality of entangled modes or nodes of a hybrid nature, where some nodes may represent modes or qumodes comprising optical fields while other nodes may represent bosonic fields in other physical manifestations including but not limited to microwave fields in superconducting cavities or motional degrees of freedom of trapped ions, and still other nodes may represent discrete qubits such as transmons, trapped ion, quantum dots, or other qubit implementations. In the method described below, performing an operation on a node, on a mode, can refer to performing the operation on the optical field (light) associated with the mode or node, or on the quantum state of the node or the mode. In some implementations, the methods described below may be used to introduce and control non-Gaussian states in a CV cluster state or a CV portion of a hybrid cluster state. In some cases, the method described below may be applied to nodes that are entangled to one or more discrete qubits.

In various implementations, the connections between the nodes (or modes) of a canonical cluster state may comprise control-Z gates. In some implementations, the canonical cluster state can be a state having nodes connected via control-Z gates up to local unitary operations on every node. In the method and processes described below, a homodyne measurement performed on a node of canonical cluster state may comprise a p-quadrature measurement unless otherwise specified.

In some cases, a cluster state may comprise nodes connected via control-X gates. It would be understood by those skilled in the art that in such cluster states the initial quantum state at each node may be rotated by π/2 (compared to cluster state comprising nodes with with control-Z gate connections), and the processes and method described herein may be used to generate and manipulate non-Gaussian states in such cluster states using q-quadrature homodyne measurement (instead of p-quadrature homodyne measurement).

In some cases, a quantum state may be teleported from a first node (or mode) of the cluster graph (or the cluster state) to a second node (or mode) of the cluster graph (or the cluster state). In some such cases, after teleportation, a quantum state of the second node may be transformed to a teleported state. In some cases, the teleported state may comprise a state identical to the quantum state of the first node. In some such cases, after teleportation, a quantum state of the second node (the teleported state) may comprise a quantum state different from the quantum state of the first node. For example, the quantum state of the second node may be rotated and/or translated with respect to the quantum state of the first mode. In some cases, the state of the first node may be modified during teleportation. For example, the state of the first node can be Gaussian and the modified teleported state of the second node can be non-Gaussian (e.g., a cat state).

CV clusters are advantageous over discrete qubit-based methods for QC, primarily because of their massive scalability in both the frequency and time domains. In many cases, a CV cluster state may be canonical cluster state comprising Gaussian states. However, certain operations (e.g., quantum error coding) that may be needed for universal quantum computing, rely on non-Gaussian resources, such non-Gaussian states (e.g., cat states or Gottesman-Kitaev-Preskill states). In some cases, non-Gaussian operations equivalent to non-Clifford operations on qubits, are required for CV cluster states to achieve an exponential speed-up over classical computation and allow for error-correction. As such, introducing non-Gaussianity to CV cluster states and developing protocols for manipulating such states, may enable operations that are useful for universal quantum computing and speed-up measurement-based QC using the resulting CV cluster state (that comprise non-Gaussian states).

Most existing methods and techniques for introducing non-Gaussian states into CV cluster states involve coupling ancillary non-Gaussian states to the CV cluster state. These non-Gaussian states are often challenging to generate, and their generation process is probabilistic in general (sometimes with relatively low probabilities).

Some conventional proposals for generating universal continuous-variable QC rely on generating certain classes of non-Gaussian states such as Gottesman-Kitaev-Preskill (GKP) states, separate from the CV cluster state. As such, implementing these conventional approaches may require attachment of the non-Gaussian states (e.g., GKP) to the CV cluster state to be used for quantum computation and quantum error-correction. This clearly impedes the advantages of cluster state QC, as it requires multiple resources to be generated in addition to the scalable cluster state.

The methods, protocols, and algorithms disclosed herein, may be used to generate, control and manipulate non-Gaussian states within a CV cluster state without using external quantum states. As these methods are primarily developed for CV cluster states, in what follows a CV cluster or a CV quantum cluster (the physical platform comprising entangled qumodes), and the CV cluster states (the quantum states of the CV cluster), may be referred to as cluster and cluster states, respectively.

An example method that may be used to locally embed non-Gaussian states into a cluster state (e.g., a canonic cluster state) is Photon-Number Resolving (PNR) detection that may project a node in the cluster state (e.g., a node in a cluster graph representing the canonical cluster state) into the Fock-basis. In some cases, PNR detection may comprise measuring a number of photons in a portion of an optical field or a light beam absorbed by a PNR detector. In some cases, PNR detection may comprise a single mode PNR detection. A PNR detector may comprise an optoelectronic device that can resolve a number of photons absorbed by generating an electronic signal indicative of a number of photons absorbed by a photon absorbing region (e.g., a semiconductor or semiconductor junction) of the optoelectronic device. In various implementations, the optoelectronic deice may comprise a single photon detector, a superconducting photodetector, a semiconductor photodetector, and the like. In some cases, PNR detection may be achieved using transition-edge sensors, which are currently a mature experimental technology for counting large photon numbers with high efficiency or using fast number-resolving photon detectors comprising superconducting nanowires.

In some embodiments disclosed herein, PNR detection is used to generate non-Gaussian states within a cluster state. In some methods described herein, PNR detection and quantum information processing may be used to generate cat states, grid states (e.g., GKP states), and/or other types of non-Gaussian states embedded in a cluster state. In some implementations, once generated, these non-Gaussian states can be kept in the cluster state and moved across the cluster state to be used as resources for various quantum information processing algorithms. In some cases, the non-Gaussian states generated and embedded in a cluster state may be decoupled from the cluster state, stored and reserved to be used in quantum computing operations outside of the cluster state. Some of the methods disclosed herein may enable preserving, enlarging, and breeding non-Gaussian states already present within a cluster state. In some cases, these methods may comprise Gaussian information processing.

In some embodiments, a non-Gaussian may be generated within an existing cluster using PNR detection alone or combined with other operations (e.g., teleportation, feed forwarding, homodyne detection in P quadrature, Q quadrature, or in a mixed P-Q basis). In some other embodiments, the non-Gaussian state may be generated during formation of the cluster. For example, a non-Gaussian state may be generated and a mode having the non-Gaussian state may be entangled to other modes having Gaussian or non-Gaussian states to form a cluster state comprising non-Gaussian states. The initial state of mode before transformation to a non-Gaussian state or being entangled to another mode of the cluster can be a squeezed vacuum state.

An example of a non-Gaussian state is a Schrödinger-Cat state (herein referred to as cat state). The concept of a Schrödinger-Cat state is based on a thought experiment where a quantum state is in a superposition of at least two classically distinguishable states. In some cases, a “cat state” is any state that can become a Schrödinger cat state through a local Gaussian operation as can be performed with quantum information processing on a cluster state (e.g., a canonical CV cluster state). In various implementations, a Gaussian operation may comprise performing a homodyne measurement on a node (or mode) of the cluster state. In some cases, a cat state or a non-Gaussian state may comprise a superposition of three or more states (e.g., coherent states, squeezed coherent states, or Gaussian states). For example, a three-component or a four-component cat state may comprise a superposition of three or four states squeezed coherent states. In some cases, a non-Gaussian state may comprise a cat-like state. A cat-like state be transformed to a cat state using one or more operations (e.g., PNR detection, homodyne detection, feed forwarding and the like).

In the optical domain, a cat state may comprise a superposition of two coherent optical states having opposite phases. In some cases, photons generated by a laser source may comprise photons in coherent optical states. In some cases, cat states may be used for practical applications including but not limited to tests of fundamental quantum theory, quantum sensing, quantum communication, quantum computation, quantum error-correction, and generation of exotic quantum states such as Gottesman-Kitaev-Preskill (GKP) states.

Although GKP states have been demonstrated experimentally based on circuit QED and trapped ion systems, all-optical generation of optical GKP states with traveling optical fields remains a challenging task. Several methods have been proposed for creating and enlarging cat states and GKP states in optical domain and several approaches have successfully generated low-amplitude cat states. However, these methods rely either on making use of non-deterministic resources, which are themselves challenging to provide or methods with ‘high’ success rates topping out below 10%.

At least some of the methods and systems disclosed herein may enable using large clusters states to generate, amplify, breed, control, and manipulate cat states and grid states (e.g., GKP states) within a cluster state (e.g., a canonical CV cluster state). Given that large cluster states can be generated deterministically, the disclosed methods may be used for efficient and reliable generation and control of non-Gaussian states in optical domain. Given the abundance of quantum states in a large cluster state, consuming a portion of the quantum states for generating non-Gaussian states, may not have a significant impact on the available quantum states for performing QC using the resulting cluster state having Gaussian and non-Gaussian states.

In some implementations, a method of generating non-Gaussian states may comprise a Photon-counting-assisted Node-Teleportation Method (herein referred to PhANTM, PhANTM algorithm, PhANTM protocol), which introduces the required non-Gaussianity directly into the cluster state, e.g., through measurement (e.g., detection), and feed-forward displacements performed on the nodes of the cluster. These feed-forward displacements are Gaussian and already considered within the realm of necessary operations for measurement-based QC. The disclosed methods may not use external resources beyond photon-number detection, homodyne detection (also referred to as homodyne detection), linear optics, and feed-forward displacements operations performed on the cluster state. In some implementations, PhANTM may be used to generate, embed, and preserve Schrödinger cat states within the canonical cluster state through measurement. In various implementations, performing a measurement on a node of the cluster may decouple the node from the cluster.

In some cases, the PhANTM algorithm can be used to preserve cat states already present within a cluster state, and probabilistically enlarge (i.e., increase the amplitude of) cat states embedded with a cluster state, and breed and/or enlarge grid states using Gaussian information processing on the cluster state.

The methods disclosed herein (e.g., PhANTM) are compatible with the scalable nature of continuous-variable cluster states since only a finite overhead number of cluster state nodes are consumed to generate cat states or other non-Gaussian states. In some cases, the number of cluster sates consumed for generating non-Gaussian states within the cluster may depend on the properties of the initial cluster state (e.g., squeezing level of the initial quantum states). In some cases, a cat state generated and embedded into a cluster using PhANTM, can be probabilistically enlarged or bred into GKP states with further measurements and feed-forward operations on the cluster. In some examples, the cat states (e.g., cat states embedded in the cluster state) may be used for phase estimation (e.g., using homodyne measurements on cluster-embedded cat states). In some cases, dictionary protocols may be used to extend the PhANTM algorithm to cluster states comprising macronodes.

In some cases, PhANTM may be used to generate the cat states reliably and with a high probability of success. In some implementations, PhANTM and/or related methods that use PhANTM or some features of PhANTM for generation and manipulation of cat states within a cluster state may comprise deterministic and non-deterministic processes (e.g., high probability non-deterministic processes) or steps. In some such implementations, one or more quantum memories may be used to account for the gap between deterministic and high probability processes.

In some embodiments, systems and methods that use one or more features disclosed herein can advantageously be implemented using established quantum computing and quantum optics resources, tools, and techniques. Examples of such resources, tools, and techniques include large-scale Gaussian cluster states, homodyne detection on single qumodes, PNR detection, photon subtraction, and single-mode displacements (feed-forward).

It should be understood that, in contrast to Gaussian Boson Sampling (GBS) machines previously proposed for non-Gaussian state generation (where PNR detection acts terminally), some of the methods described below use Gaussian quantum information processing steps on the cluster state interspersed between PNR detection events.

Generation of an ideal (e.g., mathematically defined) grid state involves infinite squeezing of the initial state(s) that are transformed to the grid states. Since experimental generation of infinitely squeezed states may not be possible, physically realizable grid states may be approximate grid states. As such in various implementations described herein a state referred to as a grid state, a GKP state, a displaced grid state, a rotated grid state, an intermediate grid state, etc., includes an approximate grid state, approximate GKP state, an approximate rotated grid state, an approximate intermediate grid state, and the like.

In various implementations described herein, a state of a node or nodes of a cluster state may comprise the local quantum information (up to phase-space displacements or rotations), that would be obtained when all neighboring nodes are disconnected from the node or the nodes (e.g., using q-measurements).

In various embodiments, the non-Gaussian states (e.g., cat states, grid states, or compass states) generated in a cluster state using the methods described below, may be decoupled from the cluster state and used as a resource in other quantum systems for performing quantum computation, quantum sensing, and other operations that may use a non-Gaussian state.

### Photon-Counting-Assisted Node-Teleportation Method (PhANTM)

Measurement-based CVQC with cluster states is fundamentally based on CV teleportation, where Gaussian measurements in the form of homodyne detection teleport quantum information between neighboring nodes of a cluster state. The freedom to choose the measurement basis of the homodyne detection by controlling a classical local oscillator phase may allow performing Gaussian operations on a teleported state. For quadrature operators defined in terms of the creation and annihilation operators as:

$$\hat{Q} = \frac{1}{\sqrt{2}} ( \hat{a} + {\hat{a}}^{†} ) \qquad ( 1 )$$

$$\hat{P} = \frac{i}{\sqrt{2}} ( {\hat{a}}^{†} - \hat{a} ) , \qquad ( 2 )$$

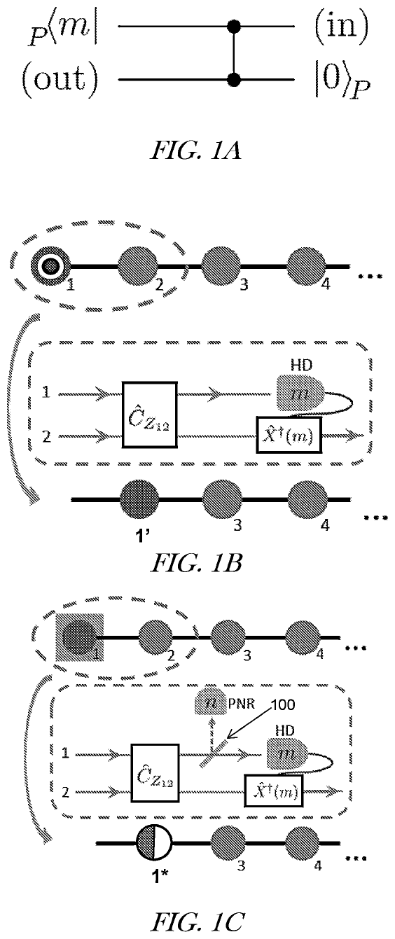

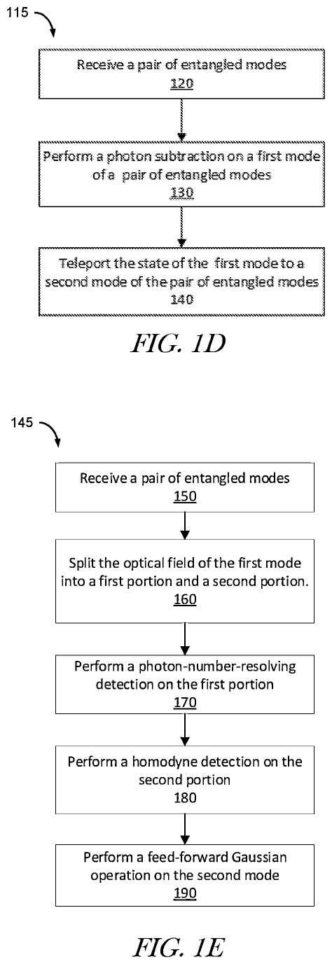

a conventional teleportation circuit in canonical form, read right to left, is shown in FIG. 1A, where P-subscripts indicate the quadrature basis. In this circuit, quantum information enters from the right and is coupled to a zero-momentum eigenstate, |0 [symbol] _{P}, with the controlled Z-gate defined as Ĉ_{Z}=e^{i\tilde{Q}}^{₁}^{\tilde{Q}}^{₂}. A homodyne measurement is then performed in the P basis on the top wire yielding result m. Here the convention that circuits proceed from right-to-left is adopted, so as to coincide with the order of operator action when writing out the mathematics. The result of this circuit is simply to teleport the input quantum information in the top wire to the bottom wire with an additional Fourier transform (rotation of π/2) and a displacement that depends on the measurement result; that is to say, the operator

$$\hat{X} ( m ) \hat{R} ( \frac{π}{2} )$$

is applied to the input. The rotation and quadrature shift operators are defined as:

$$\hat{Z} ( y ) = {e}^{i \hat{Q} y} \qquad ( 3 )$$

$$\hat{X} ( x ) = {e}^{- i \hat{P} x} \qquad ( 4 )$$

$$\hat{R} ( θ ) = {e}^{i θ {\hat{a}}^{†} \hat{a}} , \qquad ( 5 )$$

where a general displacement is expressed as

$$\begin{matrix}\hat{D} ( α ) = {e}^{α {\hat{a}}^{†} - {α}^{*} \hat{a}} \\ = \hat{Z} ( \sqrt{2} Im [ α ] ) \hat{X} ( \sqrt{2} Re [ α ] ) {e}^{- iRe [ α ] Im [ α ]} .\end{matrix} \qquad ( 6 )$$

By varying the measurement phase, Gaussian operations on cluster states can be realized with homodyne measurement alone up to a displacement. However, in order to achieve a quantum speed-up, non-Gaussianity is introduced; and furthermore, this non-Gaussianity is not efficiently simulable classically. In some cases, this can be done by introducing the ability to perform photon addition or subtraction, which introduces negativity into the multi-mode Wigner function.

In some implementations, Schrödinger cat state cat states (also referred to as cat states) can be generated using a modified version of the conventional teleportation process for teleporting quantum states between the nodes of a canonical cluster state. In some cases, a modified teleportation process may include a photon number resolving (PNR) detection (also referred to as PNR measurement). In some cases, such modified teleportation may be referred to as Photon-counting-assisted Node-Teleportation Method (PhANTM). PhANTM may be used to develop quantum algorithms and quantum circuits for generation and manipulation, of cat states, grid states, and/or compass states within a canonical cluster state. In various implementations, PhANTM and/or methods having one or more features of PhANTM may be used for teleporting macronodes, and/or generation and manipulation of cat states, grid states, and/or compass states within a macronode cluster state. In some implementations PhANTM may be used to transform one or more nodes (or modes) of a one-dimensional (1D) cluster state to cat states.

In some cases, where a cluster state (e.g., a canonical cluster state) may comprise entangled nodes having an infinite level of squeezing, each node on the cluster state can be represented by a momentum eigenstate, |0>ₚ, that has been coupled to its nearest neighbors with the two-mode entangling operation Ĉ_{Z}=e^{i\tilde{Q}}^{₁}^{\tilde{Q}}^{₂} where \hat{Q}ₖ=1/\sqrt{2}(aₖ^{†}+aₖ) is the position operator acting on the k^{th} mode with aₖ^{†} and aₖ being the respective creation and annihilation operators on the k mode. In some cases, a cluster state (e.g., a canonical cluster state) may comprise entangled nodes having a finite level of squeezing. For example, each node of a cluster state may have a squeezing level from 3 dB to 5 dB, 5 dB to 10 dB, 10 dB to 15 dB, 15 dB to 20 dB, 20 dB to 30 dB, or other values. In some cases, nodes of a canonical CV cluster state may, at least initially, have substantially identical quantum states (e.g., having the same form and squeezing level). In some examples, the initial quantum states of a CV cluster state can be different (e.g., have different squeezing levels). In various implementations, the initial states of at least a portion of the nodes in a CV cluster state can be vacuum states or finitely squeezed vacuum states (herein referred to as “squeezed states”). In some cases, a node may be decoupled from the CV cluster.

FIG. 1B shows another example of a conventional quantum teleportation process for teleporting nodes in a canonical one-dimensional cluster state. In some embodiments, the conventional teleportation shown in FIG. 1B, may comprised the conventional teleportation circuit shown in FIG. 1(A). As shown in FIG. 1B, quantum teleportation can be achieved with homodyne detection on one mode of a pair of entangled nodes. In some cases, after nodes (circles labeled as 1, 2, 3, and 4) are connected by entangling Ĉ_{z} operations (lines between circles) to form the cluster state, performing a homodyne measurement in the momentum-basis (represented by a white ring) teleports the quantum information in the measured node (circle 1) to its neighboring node (circle 2), up to a Gaussian rotation and momentum shift dependent on the measurement result. The Gaussian rotation and momentum shift can be undone with standard experimental techniques by applying the inverse of the shift and rotation, for example, \hat{Z}^{†}(m) (or \hat{X}^{†}(m)) and \hat{R}^{†}(θ), where \hat{Z}^{†}(m)=e^{imÂ} and \hat{R}^{†}(θ)=e^{iθa}^{^{†}}^{a}.

The example quantum circuit (inside the dashed rectangle) in FIG. 1B illustrates teleportation of the quantum state of a first node (1) to a second node (2) that initially is entangled to the first node via a controlled Z-gate (represented by Ĉ_{Z}_{₁₂}), generating a teleported node (or mode labeled as 1′). The teleportation process may include a homodyne measurement in momentum (P-basis represented by m in the figure) on the first node. In some cases, a feedforward Gaussian operation (represented by \hat{X}^{†}(m)) may be performed on the teleported state of the second node (e.g., to eliminate a displacement of the teleported state).

In some cases, the standard teleportation procedure described above with respect to FIG. 1B, may be modified to a Photon-counting Assisted Node Teleportation Method (PhANTM) that introduces non-Gaussianity in the resulting quantum state. PhANTM may comprise a Photon Number Resolving (PNR) detection process in addition to homodyne measurement in the momentum basis.

FIG. 1C shows an example of the Photon-counting-assisted Node-Teleportation Method (PhANTM). In some cases, PhANTM may be used to teleport a quantum state of a first node of a cluster state to a cat state of the second node that is initially entangled to the first node via a controlled Z-gate (represented by Ĉ_{Z}_{₁₂}). In some cases, the first and second nodes may be selected from a plurality of entangled nodes of a cluster state (e.g., a one-dimensional cluster state). As shown in the FIG. 1C (inside the dashed rectangle), according to PhANTM measurement, a number of photons may be subtracted from an optical field associated with the first note. For example, immediately before the homodyne measurement (represented by m), a Photon Number Resolving (PNR) detection is performed on a portion of the light (optical field) in the first mode (node 1) on the photon-number (n) basis. In the example shown, a portion of light is split off using a beam splitter 100 and sent to a Photon Number Resolving (PNR) detector where a number of photons in the split portion is measured. In some cases, the beam splitter 100 can may reflect (split off) a small portion of incident light (light associated with node 1) and transmit the remaining portion of light. In some examples, the beam splitter 100 can be a weak beam splitter and the split off portion of light can have an intensity significantly smaller than that of the transmitted portion of light. In some examples, the splitting ratio of the beam splitter can be from 0.001/99.999% to 0.01/99.99%, from 0.01/0.99% to 1/99%, 1/99% to 5/95%, 5/95% to 10/90%, 10/90% to 20/80% or any ranges formed with these ranges or other values. In some cases, if n≥1, the remaining portion of light (the portion transmitted through the beamsplitter 100), can be in a non-Gaussian state (e.g., a “cat-like state”). Next, a homodyne measurement (homodyne detection) in the momentum basis (represented by m)) is performed on the remaining portion of light (transmitted through the beam splitter 100) to teleport the non-Gaussian state of node 1 to node 2. In some cases, the state of node 2 (the teleported non-Gaussian state from node 1) can be a “displaced cat state”. In some cases, an additional non-Gaussian operation (e.g., a displacement operation represented by \hat{X}^{†}(m)) may be performed on the resulting displaced cat state, to generate a cat state (represented by the circle labeled as 1*). As such, performing PhANTM on node 1, may transform the state of node 2 to a cat state or a non-Gaussian state. In some examples, the cat state can be a small cat state (e.g., having a small amplitude). In some cases, node 1 may become decoupled from the cluster after teleportation. In some cases, after transforming the state of node 2 to the cat state, node 2 may be decoupled from the cluster state. In some such cases, the cat state of node 2 can be used in quantum systems separate from cluster state or from the source if the cluster state. For example, a cat state generated in a cluster state may be decoupled from the cluster and used in a quantum system configured for quantum sensing.

In some cases, a cat state (or a non-Gaussian state) of a node in a cluster, may be teleported to a neighboring node of the cluster (a node immediately adjacent to the node being in cat state or non-Gaussian state). In some cases, teleporting the cat state (or a non-Gaussian state) to the neighboring node may comprise a Gaussian rotation (e.g., a π/2 rotation) such that the initial state of the neighboring node is transformed to state rotated with respect to the state of the node. In some examples, the non-Gaussian state of the neighboring node can be a “rotated cat state”. In some such cases, performing a second PhANTM on the neighboring node being in a rotated cat state (or rotated non-Gaussian state), transforms the next node immediately adjacent to the neighboring node to a cat state (or a non-Gaussian state) that may have a larger amplitude than the original cat state of node 2. For example, the first cat state of node 1 after the first PhANTM (represented by black/white circle labeled as 1*), may be teleported to a rotated cat state of node 3 and performing the second PhANTM on node 3, may transform the state of node 4 to a second cat state having a larger amplitude than the first cat state. In some implementations, these steps may be repeated sequentially to transform a plurality of nodes in a 1D cluster state to one or more cat states. In some such cases, if the initial states of the cluster state have a squeezing level above a threshold level, a 1D cluster state can be reduced to a cat state with near unity probability, e.g., by sequential performing PhANTM.

In some cases, the portion of light used for PNR detection may be siphoned off by a method that controllably couples light to vacuum. In some cases, the process of detecting and counting a number of photons in an optical filed (e.g., optical field associated with a mode in a cluster state) may be generally referred to as photon subtraction. In some cases, photon subtraction may comprise splitting (e.g., weakly splitting) the optical field (light) associated with the first mode into a first portion and a second portion (e.g., using a beam splitter), and counting the photons in the second portion using PNR detection. In some cases, the first portion can be a transmitted portion and the second portion can be a split or reflected portion. The second portion may have a lower intensity than the first portion. For example, a number of photons in the second portion can be significantly smaller than a number of photons in the first portion. The PNR detection may comprise an application of an operator an to the input quantum state where n photons are detected in the limit of very weak coupling to the vacuum.

In some cases, transforming a 1D cluster state to a cat state using PhANTM may comprise performing a PNR detection followed by homodyne detection on every other mode (such as the odd modes) of the cluster state, and performing homodyne measurements on the other modes (correspondingly, the even modes). The PNR detection may comprise subtracting photons from the mode before the Homodyne measurement performs teleportation between the states of the neighboring modes of the cluster. Each measurement result may be used to perform a feed-forward displacement on subsequent modes. In some cases, feed forwarding may comprise displacing the state, or shifting the measurement basis of future detections. The final unmeasured mode is teleported into a cat state with high probability. In some cases, PhANTM may use quantum information processing to generate cat states with near unit probability.

While, some of the existing (conventional) quantum state reduction methods may use photon subtraction in the reduction process, the resulting Schrödinger cats may be generated with low probability of success and have small amplitudes. In some cases, if the photon subtraction fails or if larger cat states are needed, the produced state may be stored in a quantum memory until the subtraction can be reattempted or bred with other Schrödinger cat states for enlargement.

FIG. 1D is a flow diagram illustrating an example process 115 that may be used by a quantum computing system to generate a non-Gaussian state (e.g., a non-Gaussian state embedded in a CV-cluster state).

The process 115 begins at block 120 where the quantum computing system receives a pair of entangled modes. In some cases, the pair of entangled modes can be embedded in a CV cluster state (e.g., a one-dimensional cluster state). In some cases, the pair of entangled mode may have been generated by applying a controlled Z-gate on a pair of modes each having each having an initial state comprising a squeezed vacuum state. In some examples, a level of squeezing for the initial states can be identical or different.

At block 130, the quantum computing system performs a photon subtraction on a first mode of the pair of entangled pair. The photon subtraction may comprise a PNR detection on a portion of a mode of the pair of entangled modes. In some cases, a portion of the mode may comprise a portion of an optical field associated with the mode. In some cases, the portion of the optical filed on which PNR detection is performed may be separated from the mode and received by a photodetector capable of performing PNR (e.g., a single photon detector). The remaining portion of the first mode after photon subtraction (e.g., a transmitted optical field associated with the first mode), may comprise a non-Gaussian state. In some cases, the non-Gaussian state can be a cat-like state. In some examples, subtracting a larger number of photons may result in generation of a cat-like state that is closer to a cat state.

At block 140, the quantum computing system teleports the state (the non-Gaussian state) of the first mode, resulting from photon subtraction, to a second mode of the pair of entangled modes. In some cases, the quantum computing system may teleport the state of the first mode, by performing a homodyne measurement (homodyne detection) on the remaining portion of the first mode. The homodyne is performed in momentum basis. As a result of teleportation process, an initial state of the second mode may be transformed to a non-Gaussian state (e.g., a cat-like state). In some cases, the cat-like state can be rotated and/or displaced cat state.

In some cases, a PhANTM process may comprise the process 115. In some cases, the PhANTM process may further include preforming feed forwarding on the non-Gaussian state of the second mode to generate a cat state.

In some cases, the process 115 may or a PhANTM process may be used to generate a cluster state having at least one mode with a non-Gaussian state. In some examples, a process may start with two modes each having a squeezed vacuum state and proceed with entangling the two modes to generate a pair of entangled modes that is provided to the process 115. Once the second mode is transformed to a non-Gaussian state, a third mode may be entangled with the second mode to generate a first pair of entangled state (comprising a Gaussian and a non-Gaussian mode). This first pair may be entangled to another mode to expand the cluster state. By adding more entangled mode a cluster state (e.g., a one-dimensional cluster state) may be formed with at least one embedded non-Gaussian state.

FIG. 1E is a flow diagram illustrating another example process 145 that may be used by a quantum computing system to generate a non-Gaussian state (e.g., a non-Gaussian state embedded in a CV-cluster state).

The process 145 begins at block 150 where the quantum computing system receives a pair of entangled modes. In some cases, the pair of entangled modes can be embedded in a CV cluster state. In some cases, the pair of entangled mode may have been generated by applying a controlled Z-gate on a pair of modes each having each having an initial state comprising a squeezed vacuum state. In some examples, a level of squeezing for the initial states can be identical or different.

At block 160, the quantum computing system splits the optical field of the first mode into a first portion and a second portion.

At block 170, the quantum computing system performs a photon number resolving detection on the first portion.

At block 180, the quantum computing system performs a homodyne detection on the second portion.

At block 190, the quantum computing system performs a feed forward Gaussian operation of the second mode.

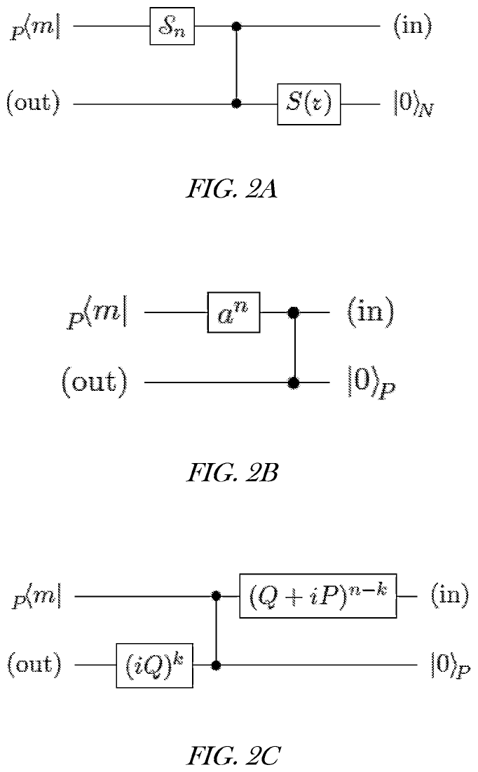

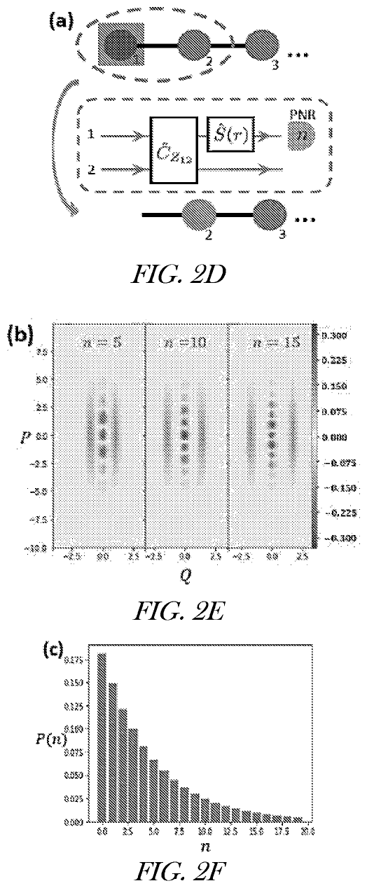

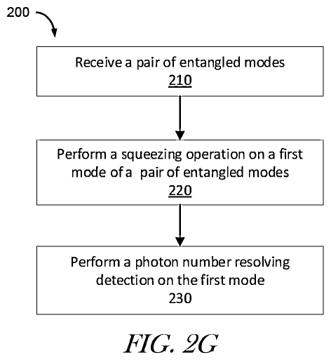

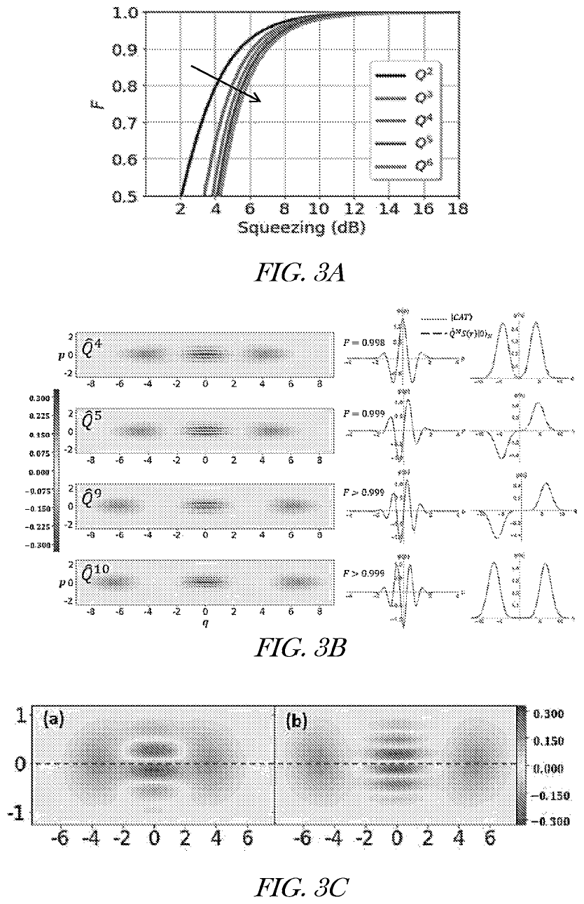

FIG. 2A shows another example of a quantum circuit for implementing the Photon-counting-assisted Node-Teleportation Method (PhANTM). Similar to the example shown in FIG. 1C, photon subtraction of n photons is performed immediately prior to the homodyne detection step of a teleportation circuit. FIG. 2A represents finite squeezing on an ancillary mode. Here the calligraphic r, “ [symbol] ”, is used for the squeezing parameter so as not to confuse with r used for beamsplitter reflectivity. In this circuit, a realistic photon subtraction of n photons is implemented by applying the Kraus operator:

$${\hat{𝒮}}_{n} = \frac{{( - 1 )}^{n} {e}^{n β / 2}}{\sqrt{n !}} {( 2 sinh β )}^{n / 2} {\hat{a}}^{n} \hat{N} ( β ) , \qquad ( 7 )$$

$$where$$

$$\hat{N} ( β ) := {e}^{- β {\hat{a}}^{†} \hat{a}} = {e}^{- \frac{β}{2} ( {\hat{Q}}^{2} + {\hat{P}}^{2} - 1 )} \qquad ( 8 )$$

is the damping operator with βϵ [symbol] . Here, a squeezed momentum state is achieved by applying the squeezing operator S( [symbol] )=exp[( [symbol] /2)(â^{†2}−â²)] to the vacuum state, denoted as a zero-valued ket with subscript N denoting the photon-number eigenbasis. Eq. 7 can be implemented by coupling the top wire to a vacuum mode with a beamsplitter of transmissivity t=e^{-β} and then performing PNR detection on the reflected mode as derived in sub-section 2 of the section titled Derivation of Example Equations (DEE-2) below. Additionally, further information about the non-unitary damping operator is presented in DEE-1.

The circuit shown in FIG. 2A can be simplified to a mathematically idealized case where its usefulness is more readily apparent. In the high squeezing limit, the squeezed vacuum can be approximated as a zero-momentum eigenstate, Ŝ( [symbol] )|0 [symbol] _{N}≈|0 [symbol] _{P}. Next, consider taking the limit β→0 in Eq. 7, which is physically equivalent to tuning the subtraction beamsplitter to have vanishing reflectivity. Measuring n photons in the weakly reflected mode may result in the application of [symbol] ₙ≈\hat{α}ⁿ, up to a normalization. In this limit, the probability to measure photon numbers with n>0 vanishes; however, when properly combined with the high squeezing limit such that the beamsplitter reflectivity becomes small as the energy in the input state becomes very large, the probability to subtract zero photons can also vanish. In the proposed embodiments, both constraints on the squeezing and beamsplitter reflectivity (value of β) may be relaxed such that the method performs successfully in a realistic scenario.

FIG. 2B shows an idealized non-Gaussian subtraction and teleportation circuit given by writing the annihilation operator as

$$\hat{a} = \frac{1}{\sqrt{2}} ( \hat{Q} + i \hat{P} )$$

and commuting this with the Ĉ_{Z} gate, results in the operator applied to the output state:

$${}_{1 P} {〈 m \vert \frac{{\hat{C}}_{Z}}{\sqrt{{2}^{n}}} {( {\hat{Q}}_{1} + i {\hat{P}}_{1} + i {\hat{Q}}_{2} )}^{n} \vert 0 〉}_{2 P} = {}_{1 P} {〈 m \vert \frac{{\hat{C}}_{Z}}{\sqrt{{2}^{n}}} {\sum }_{k = 0} ( \begin{matrix}n \\ k\end{matrix} ) {( i {\hat{Q}}_{2} )}^{k} {( {\hat{Q}}_{1} + i {\hat{P}}_{1} )}^{n - k} \vert 0 〉}_{2 P} . \qquad ( 9 )$$

Since the Ĉ_{Z} gate commutes with \hat{Q}, each term can be graphically represented in the sum as the circuit shown in FIG. 2C which is simply the teleportation circuit applied to a modified input followed by the application of \hat{Q} to a power. Representing the action of this circuit as a Kraus operator applied to the input, the resultant operator would be:

$${\hat{K}}_{m , n} = \frac{1}{\sqrt{{2}^{n}}} {\sum }_{k = 0}^{n} ( \begin{matrix}n \\ k\end{matrix} ) {( i \hat{Q} )}^{k} {\hat{R}}_{( \frac{π}{2} )} {\hat{Z}}^{†} ( m ) {( \hat{Q} + i \hat{P} )}^{n - k} = \hat{X} ( m ) {\hat{R}}_{( \frac{π}{2} )} \frac{1}{\sqrt{{2}^{n}}} {\sum }_{k = 0}^{n} ( \begin{matrix}n \\ k\end{matrix} ) {( - i \hat{P} + im )}^{k} {( \hat{Q} + i \hat{P} )}^{n - k} . \qquad ( 10 )$$

The position shift of \hat{X}(m) at the end can be effectively ignored, as its effect can be removed with feed-forward displacements or accounted for by shifting the result of subsequent homodyne detections[12]. Surprisingly, the \hat{P} contribution in the sum vanishes and the operator can be written as \hat{K}_{m,n}=\hat{X}\hat{R}ƒₙ(\hat{Q}), where ƒₙ(\hat{Q}) takes the form of a polynomial with generally complex coefficients. This polynomial has implicit m dependence and will be given in the next section. This can be seen by examining the commutator of \hat{K}ₙ with \hat{Q}. Furthermore, in the specific case where m=0, Eq. 10 can be written in terms of a Hermite polynomial in \hat{Q} as:

$${\hat{K}}_{0 , n} = {\hat{R}}_{( \frac{π}{2} )} {H}_{n} ( \frac{\hat{Q}}{\sqrt{2}} ) , \qquad ( 11 )$$

where Hₙ(x) is the n-th order physicist's Hermite polynomial. This is derived in section DEE-4. By iterating this procedure M times successively, actively undoing the displacements between steps, and applying a regular teleportation at each intervening step to enact a Fourier transform and keep the overall operator a function of Q only, powers of Q can be built up to form the overall operator:

$${\hat{K}}_{M} = \hat{R} ( M π ) {\prod }_{k} {f}_{k} ( {( - 1 )}^{k} \hat{Q} ) , \qquad ( 12 )$$

which is a polynomial in \hat{Q} followed by a rotation of magnitude Mπ. The degree of this polynomial is equal to the total number of photons subtracted over all the steps. While this analysis is presented based on the idealized circuit shown in FIG. 2B, including realistic effects may still result in the application of a polynomial in \hat{Q} of the same order, but with additional Gaussian noise. In some cases, developing polynomial gates can be used to approximately implement non-Gaussian unitaries and the cubic phase gate, but when specifically applied to squeezed vacuum, they can give rise to cat states.

In contrast to the previous reduction methods, in PhANTM and related methods and processes described herein the photon subtraction step is performed after entangling operation (e.g., using Ĉ_{Z} operator), but before the homodyne measurement. As such, the PhANTM teleportation protocol may effectively apply an operator comprising a polynomial in \hat{Q} with orders up to n, where n is the number of photons detected by the PNR measurement. This method may generate cat states with a higher probability of success compared to the conventional and existing methods. Moreover, this method may need a lower number of quantum memories or quantum storage steps during teleoperation of one or more modes of a cluster state (e.g., to cat states).

As described above, the process of teleportation may introduce a measurement-dependent displacement that can be undone with a feed-forward Gaussian operation, and a

$$\frac{π}{2}$$

phase-space rotation which can be compensated for by teleporting a resulting cat state to another mode without subtracting more photons from the corresponding optical field.

The overall process described above may be repeated on the teleported node, introducing more non-Gaussianity each time successful photon-counting events occur and teleporting the quantum state further along with the cluster. In some cases, the performance of the PhANTM algorithm may be evaluated by analyzing the outcomes of performing M steps of the PhANTM operation on nodes of a cluster state based on the amplitudes or average amplitudes of the resulting cat states. In some cases, a general two-component cat state, up to a rotation and displacement, may be expressed as |cat [symbol] ∝(\hat{D}(α)+e^{iϕ}\hat{D}(−α))Ŝ(r)|0 [symbol] , that is a superposition of oppositely displaced squeezed vacuum states where squeezing operator

$$\hat{S} ( r ) = {e}^{( r / 2 ) ( {α}^{† 2} - {α}^{2} )} ,$$

displacement

$$\hat{D} ( α ) = {e}^{( α {a}^{†2} - α * a )} ,$$

and ϕ is the phase between the displacements. In some cases, a may represent an amplitude of the cat state. In some such cases, the amplitude of the cat state can be equal or proportional to α.

In some examples, performing a small number of steps (e.g., less than 10 steps) of the PhANTM operation can produce a cat state similar to the cat state |cat [symbol] represented above with average fidelities above 0.99. In some cases, fidelity can be proportional or equal to a quantum state overlap between two quantum states ρ and α, for example, presented as:

$$F = T {r [ \sqrt{\sqrt{σ} ρ \sqrt{σ}} ]}^{2} \qquad ( 13 )$$

In some cases, σ and ρ can be two density matrices representing the two quantum states. In some cases, ρ can represent an ideal (or perfect) cat state having a particular value of amplitude and squeezing level, and σ can represent a state generated using PhANTM process. In some such cases, F may quantify a level of similarity between the state generated using PhANTM and an ideal cat state, e.g., represented by equation 1. For example, if F=0.99, the cat state generated using PhANTM can be 99% similar to a perfect cat state. In various embodiments, displacement of a state (e.g., a cat state) can be associated with the operator D and may be referred to as superposition displacement. In some cases, various states (e.g., non-Gaussian states) described below may have an overall displacement in addition to the superposition displacements and corresponding feed forward operations may compensate for this overall displacement (e.g., by moving the state to the origin of a coordinate system used to mathematically represent the state).

### Generating Cat States Using Squeezed PNR

In some implementations, the PhANTM may be modified by eliminating the photon subtraction (weak splitting) step and the homodyne measurement process. In some examples, instead of splitting the light associated with a selected mode of a cluster state, the modified PhANTM process may include squeezing the light and performing PNR detection on the resulting squeezed light. This method, which is referred to as squeezed PNR, may generate squeezed cat states. In some cases, the cluster state may include nodes initially having squeezed vacuum states and entangled to each other using controlled-Z gates (CZ gates).

In some embodiments, direct Photon Number Resolving (PNR) detections preceded by Gaussian operations creates squeezed Schrödinger cat states embedded within a cluster state. FIG. 2D shows a process of performing squeezed PNR detection on a mode (or node) of a cluster state (e.g., a 1D canonical cluster state). First, a pair of neighboring nodes (nodes 1 and 2) in the cluster state are selected. In some cases, the pair of nodes may have been generated by applying a Ĉ_{Z} gate (controlled-Z gate) to two squeezed vacuum states. Next one of the two nodes (e.g., node 1) is subjected to squeezing (Ŝ(r)), e.g., single mode squeezing, followed by Photon Number Resolving (PNR) detection where at least one photon is detected, transforming the state of the other mode (e.g., unmeasured node 2) may be transformed to a squeezed Schrödinger cat state. In FIG. 2D, the box around the first cluster node represents performing PNR detection (e.g., single mode PNR detection). In some cases, the PNR detection may be preceded by one or more Gaussian operations.

The squeezing operation before PNR detections may be achieved using various methods including but not being limited to: application of direct in-line squeezing, squeezing through Gaussian-information processing on the cluster state, applying a Ĉ_{Z} gate with different weight, or even effectively enacted by beginning with asymmetrically squeezed vacuum states, including the option of zero squeezing, when the cluster state is created. All of these methods may result in the creation of a squeezed Schrödinger cat state up to local Gaussian operations that may include squeezing, phase shifts, and displacements, which can subsequently be accounted for by standard processing on the cluster state.

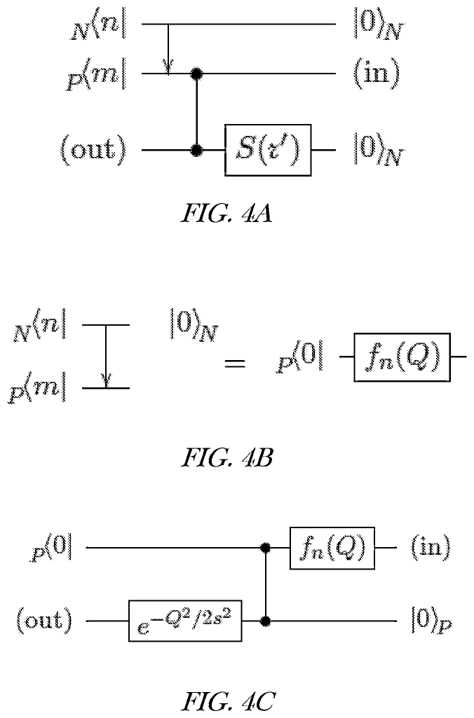

FIG. 2E shows Wigner function of the neighboring node (node 2 that is not measured) after measuring the squeezed state of the first node for different numbers (n) of photons detected during the PNR detection. Larger numbers of detected photons result in cat states having larger amplitudes. As shown in FIG. 4B, the size of the resulting Schrödinger cat state increases with increasing the number of photons detected during PNR detection. Similar to PhANTM, the protocol shown in FIG. 2D can be simultaneously performed on many nodes of the cluster to generate a squeezed cat state with desired size. The resulting squeezed cat states can be teleported throughout the cluster and may be used at a later time. FIG. 2F shows the probability distribution of the detection outcomes of the PNR detection (e.g., number of detected photons). Detection of zero photons is the only event where the resultant state remains Gaussian.

FIG. 2G is a flow diagram illustrating another example process 200 that may be used by a quantum computing system to generate a non-Gaussian state (e.g., a cat state or a squeezed cat state embedded in a CV-cluster state).

The process 200 begins at block 210 where the quantum computing system receives a pair of entangled modes. In some cases, the pair of entangled modes can be embedded in a CV cluster state. In some cases, the pair of entangled mode may have been generated by applying a controlled Z-gate on a pair of modes each having each having an initial state comprising a squeezed vacuum state. In some examples, a level of squeezing for the initial states can be identical or different.

At block 220, the quantum computing system performs a squeezing operation on a first mode of the pair of entangled mode, e.g., to increase a squeezing level of the first mode compared to a squeezing level of the second mode.

At block 230, the quantum computing system performs a photon number resolving detection on the first mode to transform the state of a second mode of the pair of the entangled modes to a non-Gaussian state. In some cases, the non-Gaussian state can be a squeezed cat state.

In some cases, the feed forwarding may include applying \hat{X}^{†} or \hat{Z}^{†} on the second mode. In some implementations, feed forwarding may comprise interfering a coherent optical field (e.g., a coherent beam of light) with the optical field (a beam of light) associated with the second mode (e.g., using a beam splitter).

In some cases, the processes 115, 145, and 200 may be performed by a hardware processor of a quantum computing system. The quantum computing system may include one or more quantum circuit (e.g., quantum circuits implemented on a photonic platform). In some cases, the quantum computing system may include a classical system (e.g., a controller or a classical computing system). In some cases, a portion of the process may be performed by or under the control of the classical system. In some cases, the classical system may include a memory (e.g., a non-transitory memory) and a processor that performs or controls a portion of the process 115 145, or 200 for generating non-Gaussian quantum state (e.g., a non-Gaussian quantum state embedded in a cluster state).

### Polynomial Quantum Gates

In some cases, PhANTM may be performed in a way to enact polynomial quantum gates. In these cases, each iteration of the PhANTM operation may comprise applying a polynomial in Q-operator (\hat{Q}). The polynomial can have the same degree as the number of photons subtracted, n. The polynomial can additionally be modified by a Gaussian envelope, depending on the level of squeezing in the cluster state and the reflectivity of the effective subtraction beam-splitting device. In the limit of large squeezing, this polynomial becomes an n^{th} degree Hermite polynomial shifted by the Homodyne measurement result.

In some cases, a beam splitter used to subtract a portion of light from a selected mode of the cluster may be adjusted such that the state transformation by PhANTM can be effectively represented by polynomial in \hat{Q}. For example, if the reflectivity of the subtraction beamsplitter is set to a value such that subtracting more than a single photon is rare (e.g., has very low probability), then each iteration in the PhANTM will apply no more than a single factor of \hat{Q}. Thus, one can perform the PhANTM repeatedly until a number n of total photons have been subtracted. One can controllably apply an n^{th} degree polynomial in \hat{Q} with polynomial coefficients dependent on the Homodyne measurement results. This method is applicable to a canonical cluster state as well as a macronode cluster state. In some cases, instead of building up polynomials described above, performing the squeezed PNR detection method (described above with respect to FIG. 2D), may be mathematically equivalent to applying an operator comprising a polynomial in \hat{Q} on the cluster state. In some such cases, the mathematical form may be a Hermite polynomial, and the degree of the polynomial may depend on the number of photons detected after the squeezing operation (S(r)). Applying PhANTM multiple times is mathematically equivalent to applying an operator comprising a polynomial in \hat{Q} that consists of products of Hermite polynomials, on the cluster state. The degree of the polynomial can be equal to the total number of photons measured when all PhANTM operations are performed. In either method (squeezed PNR detection or photon subtraction), the polynomial in \hat{Q} can instead be transformed into the same polynomial in (\hat{Q}cos θ−\hat{P}sin θ) by rotating the input state through an angle θ and then rotating the output state after the polynomial gate was applied through the angle −θ.

In some embodiments, the idealized overall \hat{K}_{M} operator represented by Eq. 12 may be applied to a cluster-state node with finite squeezing. In some such embodiments, where homodyne measurements are null-valued ƒₙ(\hat{Q}) is a Hermite polynomial. For moderate to large squeezing on the state to which the polynomial operator is applied, the leading power of \hat{Q} in each Hermite polynomial will dominate as the anti-squeezing gives support over a large range of position in phase-space, thus eliminating the contribution of lower order terms upon normalizing the state after the operator is applied. This is demonstrated in FIG. 3A, where the fidelity (F) of Hₙ(\hat{Q}/\sqrt{2})S( [symbol] )|0 [symbol] _{N} and QⁿS( [symbol] )|0 [symbol] _{N} are plotted as a function of squeezing for different values of n from 2 to 6 (the arrow indicates that n is increasing). The fidelity may be expressed as between corresponding density matrices ρ and σ using Eq. 13. For n=1, the cases are trivially the same, and for larger n, the fidelity approaches one as squeezing increases. Thus, for the immediate sake of illustration, we can examine the effects of applying only \hat{Q}^{M} to a squeezed state, where M is now the total number of photons subtracted over all iterations of the process. FIG. 3A illustrates Application of Hermite polynomials in \hat{Q} compared to leading order powers of \hat{Q}. Fidelity approaches unity as squeezing increases. The Wigner functions of the resulting states after applying \hat{Q}^{M} to squeezed vacuum for several values of M are plotted in FIG. 3B. FIG. 3B illustrates idealized PhANTM steps with null homodyne measurement results iteratively apply powers of \hat{Q} to an input state based on the total number of subtracted photons over all rounds of teleportation. Here, the input is a squeezed vacuum state with squeezing of 6 dB (r=0.7). The final state is a nearly perfect match to an even (odd) squeezed cat state when an even (odd) number of photons was subtracted.

The results shown in FIG. 3B resemble anti-squeezed Schrödinger cat states, where increasing the power of \hat{Q} applied to the squeezed state increases the amplitude of the approximated cat. The closeness to cat states is represented by the form of the wavefunctions (e.g., in FIG. 3B). In the Q-basis, the state wavefunction may be given by:

$${ψ}_{Q} ( υ ) = {( {}_{Q} 〈 υ \vert {Q}^{M} S ( ) \vert 0 〉 )}_{N} = {e}^{- ( \frac{{υ}^{2}}{2 {s}^{2}} )} {υ}^{M} , \qquad ( 14 )$$

where s= [symbol] ( [symbol] ≡ [symbol] ) and where the normalization is given by:

$$= {s}^{- M} \sqrt{\frac{1}{s ( M - \frac{1}{2} ) !}} . \qquad ( 15 )$$

transforming to the P-basis results in:

$${ψ}_{P} ( t ) = {′}^{} {e}^{( - \frac{{s}^{2} {t}^{2}}{2} )} {H}_{M ( \frac{st}{\sqrt{2}} )} , \qquad ( 16 )$$

where

$${n}^{′} = {( - 2 )}^{- \frac{M}{2}} {s}^{M + \frac{1}{2}} n$$

and H_{M}(x) are Hermite polynomials. This wavefunction resembles that of a squeezed M-photon Fock state, but with the subtle difference that the argument of the Hermite polynomial is scaled by a factor of 2^{-1/2}. No additional squeezing operation will transform it back to a Fock state as scaling the argument of the exponent will also scale the argument of the Hermite polynomial. Furthermore, this scaling is independent of the power of Q applied. Examining this wavefunction shows that the number of ripples is determined by the order of the Hermite polynomial, which is based on the total photon subtraction counts. As shown in FIG. 3B, a nearly identical anti-squeezed cat state can be found for each of these, where fidelities with cats having numerically optimized parameters are above 0.999. Additionally, it has previously been shown that the wavefunction in Eq. 14 asymptotically approaches a cat state as M becomes large.

In some cases, relaxing the restrictions imposed on homodyne measurement may allow for arbitrary quadrature detection results. This may lead to a slightly more general operator given by a product of Hermite polynomials in \hat{Q} with arguments shifted by the measurement result, which arises from a limiting case of the general derivation that will be discussed later (Eq. 128 in section DEE-3 below). However, random homodyne measurement results do not pose a significant obstacle for cat-state generation. This effect leads to producing at states with a general phase between the ‘classical’ displacement components of the form:

$${\vert cαt 〉 = {α}_{} ( D ( α ) + {e}^{i ϕ} D ( - α ) ) S ( {}_{} ) \vert 0 〉}_{N} \qquad ( 17 )$$

As shown in FIG. 3C, protocols with stochastic homodyne detection may generate cat states with a phase-space interference fringe that has been scanned in a direction perpendicular to the displacements. The Wigner functions plotted in FIG. 3C depict typical results of a multistage process where finite squeezing of 6 dB has been used for all ancillary inputs, and a single photon was subtracted in each teleportation iteration before a stochastic homodyne measurement.

### Realistic Teleportation

Some of the cases described above may be idealized in that teleportation proceeded with infinite squeezing and photon-number subtraction was modeled as a perfect application of the annihilation operator. In some cases, a true quantum circuit that represents realistic photon-subtraction during a cluster-state teleportation may instead appear as the quantum circuit shown in FIG. 4A where the application of the annihilation operator is replaced by an additional circuit component to couple the input state in the middle wire to vacuum in the top wire with a beamsplitter of the form:

$$\hat{B} = {e}^{θ ( {\hat{α}}_{1} {\hat{α}}_{2}^{†} - {\hat{α}}_{1}^{†} {\hat{α}}_{2} )} , \qquad ( 18 )$$

which is represented by the down arrow in the diagram. The beamsplitter may have a real reflectivity and transmissivity such that r=sin θ and t=cos θ. The momentum eigenstate in the third wire is a finitely squeezed vacuum state. In the limit of weak beamsplitter reflectivity, projecting the top wire into an n-photon Fock state after the beamsplitter may effectively act to apply \hat{α}ⁿ, although the probability to successfully measure n photons vanishes as the reflectivity drops to zero. Away from this limit, this portion of the circuit may act to apply nonunitary damping to the state in addition to a factor of \hat{α}ⁿ as discussed in section DEE-2 below.

The top portion of the circuit in FIG. 4A can be simplified to the circuit shown in FIG. 4B, where ƒ is a function in \hat{Q} only. On the bottom wire, the input momentum-squeezed state can be written as:

$$\begin{matrix}{{S ( {′}^{} ) \vert 0 〉}_{N} = {π}^{- 1 / 4} \int {dte}^{- {t}^{2} / 2 {s}^{2}} \vert t 〉}_{Q} \\ {= {π}^{- 1 / 4} {e}^{- {\hat{Q}}^{2} / 2 {s}^{2}} \int dt \vert t 〉}_{Q} \\ {= {π}^{- 1 / 4} \sqrt{\frac{2}{s}} {e}^{- {\hat{Q}}^{2} / 2 {s}^{2}} \vert 0 〉}_{P} ,\end{matrix} \qquad ( 19 )$$

where s= [symbol] ( [symbol] ≡ [symbol] ). This allows commuting all operations in \hat{Q} to either the back or front of the circuit to arrive at the circuit shown in FIG. 4C, which is recognizable as the same form as FIG. 1A with additional operators before and after the teleportation. As such, the Kraus operator representation of the action of the circuit on the input state can be written as:

$${\hat{K}}_{n} = {π}^{1 / 4} \sqrt{\frac{2}{s}} {e}^{- {\hat{Q}}^{2} / 2 {s}^{2}} {\hat{R}}_{( \frac{π}{2} )} {f}_{n} ( \hat{Q} ) . \qquad ( 20 )$$

The function ƒₙ(\hat{Q}) contains a displacement from the measurement result that may be useful to keep track of separately, so ƒ can be decomposed into a displacement term, a quadrature damping term, and a polynomial in \hat{Q}. Commuting the displacement term through the Fourier transform results in:

$${\hat{K}}_{n} = \frac{{π}^{1 / 4} \sqrt{2}}{\sqrt{s}} {e}^{\frac{{m}^{2}}{{s}^{2}} {σ}^{2}} \hat{X} ( m σ ) {\hat{R}}_{( \frac{π}{2} )} \times {e}^{- \frac{1}{2 {s}^{2}} {( \hat{P} - m σ )}^{2}} {e}^{- {\hat{Q}}^{2} \frac{σ t ( 1 - {t}^{2} )}{4}} {f}_{n}^{′} ( \hat{Q} ) , \qquad ( 21 )$$

where

$$σ = \frac{2 t}{1 + {t}^{2}} .$$

This is derived in detail in section DEE-3 below, where it has been shown:

$${f}_{n}^{′} ( x ) = \frac{\text{?}}{\sqrt{\text{?}}} {\sum }_{k = 0}^{n} {\sum }_{j = 0}^{⌊ \frac{\text{?}}{2} ⌋} ( \begin{matrix}n \\ k\end{matrix} ) ( \begin{matrix}n - k \\ 2 j\end{matrix} ) \frac{( 2 j ) ! {r}^{2 j}}{{2}^{j} j !} {( \frac{1 + {\text{?}}^{2}}{2} )}^{k / 2} {( - i )}^{k + 2 j} {H}_{k ( \frac{- x \sqrt{2} {rt}^{2}}{1 + {t}^{2}} )} {H}_{n - k - 2 j ( \frac{- \text{?}}{\text{?} \sqrt{\text{?}}} )} \qquad ( 22 )$$

$$\text{?} \text{indicates text missing or illegible when filed}$$

is a polynomial of degree n. In the limit of weak beamsplitter reflectivity and large squeezing so that r→0, t→1 and s→1, the Kraus operator reduces to:

$${{K}^{\text{?}}}_{n} ∝ {X}^{\text{?}} ( m ) \hat{R} ( \frac{\text{?}}{2} ) {H}_{n} ( \frac{i \hat{Q} - m}{\sqrt{2}} ) . \qquad ( 23 )$$

$$\text{?} \text{indicates text missing or illegible when filed}$$

Subtracting photons during the teleportation process is stochastic in nature, where the probability of any particular n-photon subtraction and m homodyne measurement occurring is given by:

$${P}_{n} = Tr [ {\hat{K}}_{n} {ρ}_{in} {\hat{K}}_{n}^{†} ] , \qquad ( 24 )$$

where ρᵢₙ is the general quantum state being sent through the PhANTM gadget, and the final state is evolved to

$${\begin{matrix}{ρ}_{out} = \frac{{\hat{K}}_{n} {ρ}_{in} {\hat{K}}_{n}^{†}}{{P}_{\text{?}}} . & ( 25 )\end{matrix}}_{}$$

$$\text{?} \text{indicates text missing or illegible when filed}$$

As in the idealized case, the accumulated displacement operations may be undone. The circuit in FIG. 4C modifies the input by a function of the Q operator and applies an exponentiated Q operator to a power. In some cases, e.g., when the input cluster state is highly squeezed, the function ƒₙ(\hat{Q}) is approximately a polynomial function of Q with additional displacement terms. When the input cluster state is weakly or moderately squeezed, ƒₙ(\hat{Q}) may include several non-polynomial terms. If the photon subtraction is successful, then any Gaussian input has been de-Gaussified. If, however, no photons were subtracted, the state will accrue additional Gaussian noise due to the finite squeezing in the cluster state and the non-vanishing beamsplitter reflectivity used to perform the subtraction. When squeezing is large and beamsplitter has low reflectivity, this additional Gaussian noise can be made small. Whether subtraction is successful or not, teleporting the resultant state through the next node of the quantum wire without attempting to subtract may enact another π/2 rotation and realign the squeezed axis of the state, at which point another PhANTM step can be performed. In some cases, provided there is sufficient squeezing in the cluster state, this process of subtracting photons through teleportation can build up non-Gaussianity faster than the Gaussian noise at each step can degrade the state and result in large, high-fidelity cat states.

### Results

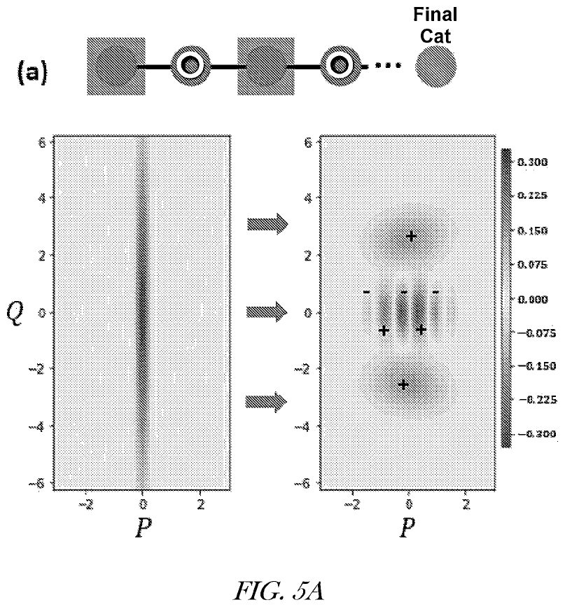

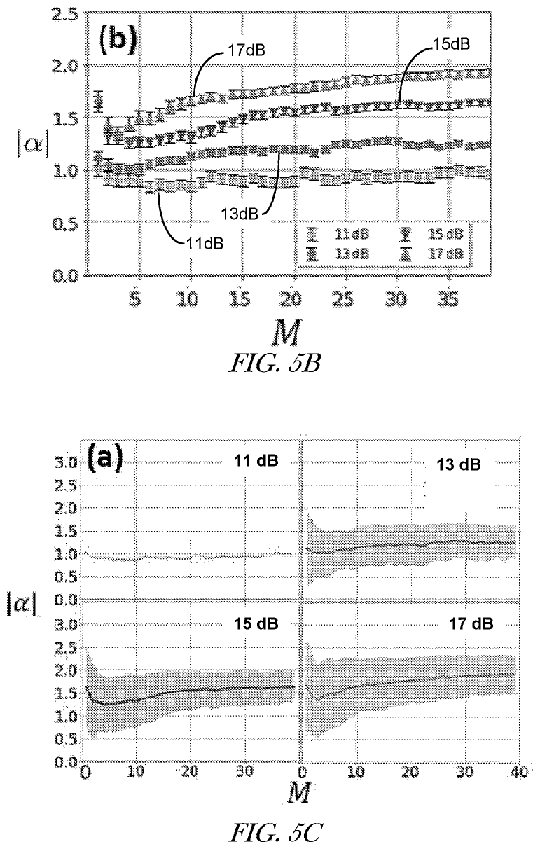

The top diagram in FIG. 5A schematically illustrates transformation of an all-Gaussian 1D cluster state (a canonical cluster state) that includes entangled squeezed vacuum modes (circles), into a non-Gaussian a final cat state after consecutively performing PhANTM (each represented by a square) on M nodes, where M is a positive integer. Each PhANTM operation may be followed by teleporting the resulting cat state by a homodyne detection (white rings) on the neighboring mode whose state is transformed to a cat state via PhANTM. The homodyne detection on the cat state may transform the state of the neighboring mode to a rotated cat state on which another PhANTM operation may be performed. The homodyne measurement results may be compensated for through feed-forward displacements applied to the teleported mode or before subsequent measurements.

The states of the modes of the cluster state before transformation, and the resulting cat state may be represented in terms of Wigner functions. Wigner function can be a quasiprobability distribution over the amplitude and phase quadratures, labeled Q and P respectively, which are analogs of position and momentum for an optical qumode. The Wigner functions shown in the bottom diagram are calculated for a mode (e.g., an encoded mode) of an initial cluster state (left diagram) and the cat state resulting from transforming the initial cluster state (right diagram), by simulating the procedure described above for a given number of times. The quantum state of each node (or mode) of the example initial cluster state shown in FIG. 5A is a Gaussian state (e.g., a squeezed state) with a positive Wigner function (represented by the shading in the left diagram), the resulting cat state is highly non-Gaussian with an interference pattern indicated by regions of negativity (shading labeled with “−” in the right diagram) and positivity regions (shading labeled with “+” in the right diagram). The Wigner functions (Q-P plot showing Q plotted versus P), before (left) and after (right) transformation are plotted for nodes each having an initial state having a squeezing level of 15 dB and after M=30 steps of PhANTM. The measurement results in FIG. 5A are allowed to be random.

The features of the resulting Wigner function (right Q-P plot) illustrate that PhANTM may be used to generate cat states with desired non-Gaussianity based on realistic assumptions that may be representative of a real quantum experiment, e.g., starting from initial states having finite squeezing levels and allowing measurement outcomes to be stochastic. In the example shown in FIG. 5A, initial cluster nodes each have a squeezing level of 15 dB, performing PhANTM 30 times in succession has transformed the state from squeezed vacuum to a Schrödinger cat state with an amplitude (|α|) of 1.5 with near unit probability. FIG. 5B shows averaged amplitudes of resulting cat states after 100 trials of performing PhANTM for M times on four different 1D cluster states comprising initial nodal states with four different squeezing levels (11 dB, 13 dB, 15 dB, and 17 dB). The error bars indicate corrections to standard error of the mean for the amplitude distributions resulting from finite sampling frequency in the simulation. When M>10, fidelities of the resulting cat states are above 99 percent for each state. As shown in FIG. 5B, the average amplitude of cat states resulting from performing PhANTM M times on a cluster state increases as the squeezing level of the initial cluster state is increased. Each data point represents the averaged |α| from the nearest Schrödinger cat state matched with the output of a simulation of 100 unique runs where all detection results are probabilistic.

Results of numerical calculations demonstrate that iteratively performing the PhANTM algorithm on cluster states can generate and stabilize large cat states. Even when considering finite squeezing effects and the probabilistic nature of the Kraus operator given by Eq. 21, repeatedly applying operators of this form gradually shapes the teleported quantum information into cat states and preserves cat states already present in the cluster. For these calculations, the python packages of QuTip and Strawberry Fields were used to perform simulations of quantum state evolution using the Rivanna high-performance computing system at the University of Virginia. A single step of the PhANTM along a 1D cluster state was first simulated by sampling the probability distribution for detection outcomes from the circuit shown in FIG. 4A, and then the input state was updated accordingly by applying the corresponding Kraus operator from Eq. 20. This protocol was applied in succession, with a regular teleportation to reapply a π/2 rotation occurring between PhANTM steps to simulate the algorithm along several nodes of a cluster state. Cluster states with different squeezing parameters were examined, and statistics were collected by simulating the entire procedure repeatedly. It should be noted that whenever a Wigner function is displayed, it is actually the single-mode Wigner function of a particular cluster state node as if it had not yet been connected by a Ĉ_{Z} gate. Most states are in reality embedded within the cluster and neighboring nodes would need to be measured out to physically disconnect the particular mode in question.

In each case, the value of beamsplitter reflectivity for the photon subtraction step was chosen so that the added Gaussian noise from subtraction effectively adds the same amount of noise as finite squeezing in the cluster. The condition is given by:

$${cos}^{2} θ = tanh \vert {\text{?}}^{′} \vert \qquad ( 26 )$$

$$\text{?} \text{indicates text missing or illegible when filed}$$

where [symbol] is the squeezing parameter for the cluster-state nodes. This condition arises by realizing that applying the damping operator, \hat{N} (β), to a zero-momentum eigenstate is equivalent to finitely squeezing the vacuum state further discussed in section DEE-1 below. Because squeezing can instead be thought of as applying the damping operator to a momentum eigenstate and the damping operator is also what separates the realistic photon subtraction operator [symbol] ₙ from ideally applying annihilation operators, implementing the above condition essentially makes the real circuit in FIG. 2A different from the idealized circuit shown in FIG. 2B only by the inclusion of damping operators applied both to the ancilla and before homodyne detection.

For each trial, a fresh 1-D cluster state was used and many steps of the PhANTM were applied along the cluster while allowing stochastic measurement results. After each step in the simulation, the evolved state was fitted to the nearest cat state of the form of Eq. 17 by optimizing the fidelity. Fidelity and fit values for all trials with a given set of initial cluster-state squeezing parameters were averaged at each step, M, and compared to trials with different squeezing parameters.

The results are depicted in FIG. 5C for cluster states with 11-17 dB of squeezing at each node. FIG. 5C illustrates the average amplitude, |α|, of the cat states plotted against the number of times PhANTM is performed to generate the cat states, when the initial cluster state had squeezing level of 17 dB. Each step corresponds to consuming two physical nodes of the cluster due to the necessary intervening teleportation step between PhANTMs to apply a Fourier transform. In FIG. 5C, solid lines show the average cat amplitude obtained from numerical simulations of performing M iterations of the subtraction protocol on a 1D cluster state where the homodyne and PNRD measurements were randomly sampled from the state distribution at each step. The shaded region of the plot indicates the two standard deviations (2σ) spread of the sampled data values from 100 trials, and squeezing values indicate the squeezing level of each node in the initially prepared cluster state. The average fidelity with the nearest cat is above 0.98 for M≥10 in all plots. As shown in FIG. 5C, after 30 steps, 95% of the produced Schrödinger cat states (by different unique runs), have an amplitude greater than one. This means that the method described herein can generate cat states with high probability. In some cases, increasing M beyond 10 steps has little impact on the fidelity other than to increase cat amplitude, which is correlated with fidelity. Some embodiments can generate a Schrödinger cat state with high probability and with an average amplitude that depends on the initial cluster state squeezing and the number of PhANTM steps performed. As such, the average amplitude of the resulting cat states may be primarily limited by the size and squeezing levels of the cluster modes. In some cases, even for lower squeezing levels (e.g., lower than 10 dB), the protocol may still be used to generate cat states having large amplitudes. In some cases, the probability of generating a cat state after a fixed number of PhANTM steps may be less than 100% because teleportation of states having finite-squeezing levels reduces the non-Gaussianity of the resulting states.

In some cases, after just a few steps, it is possible to generate a strongly anti-squeezed cat state of weak amplitude, but this is highly probabilistic and dependent on the precise subtraction measurements. However, if there is sufficient squeezing in the cluster state, each PhANTM on average succeeds in adding more non-Gaussianity than is washed away by Gaussian noise, and thus there is a high probability of obtaining a cat state with reasonable amplitude after several measurement steps. For 17 dB of cluster-state squeezing, 30 steps of PhANTM are sufficient to succeed in generating a high-fidelity cat state with amplitude |α|>1.5 with a 68% success rate and |α|>1 with a 95% success rate. It should be noted that although anti-squeezed cats are obtained in the idealized case of FIG. 3B, the effects of finite squeezing in the cluster and overall stochastic nature of the photon subtraction result in cat states with very low antisqueezing (<3 dB) beyond the first few steps, which is the region of interest. The Wigner functions and recorded PNR subtractions for a typical example are shown in section DEE-5 below.

### Cat State Preservation Through a Cluster State (Cat State Stabilization)

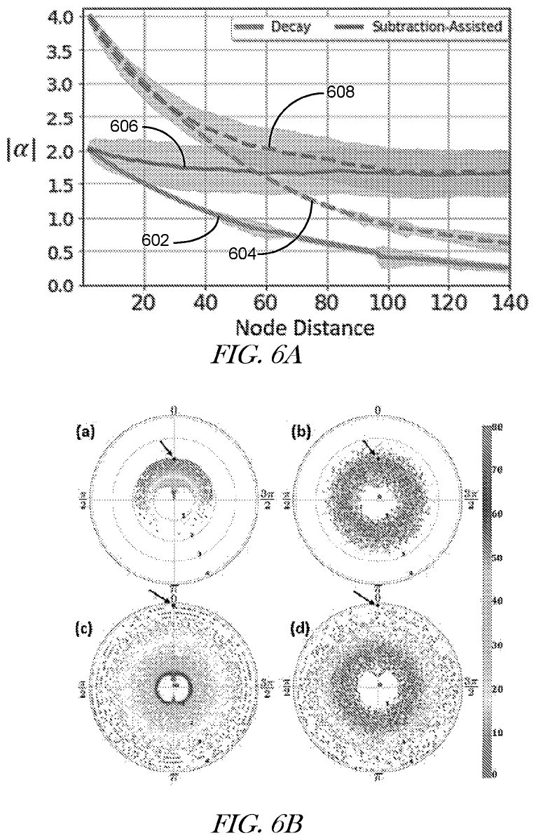

In addition to generating non-Gaussian states (e.g., cat states) from a Gaussian resource using local measurements, in some cases, the PhANTM protocol can be used to preserve the amplitude of a non-Gaussian state (e.g., a cat state) embedded in a cluster state. For example, a cat state may be embedded in the cluster state, either generated through the PhANTM as detailed above or offline through some other means, and is then entangled to the cluster using a Ĉ_{Z} interaction for later use. If this state needs to be moved through the cluster to a suitable location (e.g., a nodal location), it may suffer amplitude decay from Gaussian noise at each teleportation step, as shown by the curves 602 and 604 (bottom solid and dashed curves) in FIG. 6A. FIG. 6A illustrates an example of a Schrödinger cat state amplitude preservation after performing PhANTM. Schrödinger cat states of initial amplitude |α|=2 (solid curve 602) and |α|=4 (dashed curve 604) decay as they are teleported through the cluster state due to finite-squeezing noise. Performing PhANTM while moving the cat states throughout the cluster acts to preserve the amplitude of the cat states (curves 606 and 608). In this example, cluster squeezing is 15 dB, and the shadings shows ±σ on state amplitude. As shown in FIG. 6A, cat states with respective amplitudes of |α|=2 and |α|=4 introduced to a cluster state can be preserved as they are teleported through the cluster if photon subtraction is attempted in every other teleportation step to prevent the decay of the cat state amplitude. If one applies the PhANTM algorithm in place of regular teleportation at every-other node, then the cat state can be preserved (top solid curve 606 and top dashed curve 608) to a level dependent on the squeezing present in the cluster. Under this paradigm, including the PhANTM with a Gaussian cluster state can be seen as a machine that perpetuates non-Gaussianity even in the presence of Gaussian noise. There exists a stable equilibrium at which some amount of non-Gaussianity will remain, which was previously only formulated for CV cluster states with fault tolerant GKP error correction. PhANTM can be implemented as a pseudo quantum memory for cat states when paired with a time-domain cluster state, as an input cat state can be teleported through many time-separated cluster-state nodes and retrieved later. The retrieved state will have randomized but known parameters dependent on specific measurement results at each step, and the retrieved state will remain within the cat-state manifold. This is demonstrated more clearly in FIG. 6B, which depicts the same data as shown in FIG. 6A. FIG. 6B represents the data in FIG. 6A for 80 trajectories at each initial condition, where the radial direction indicates cat-state amplitude, |α|, the polar coordinate gives cat state phase, ϕ, and the shading shows the number of node-teleportations from the initial conditions (black dots denoted by arrows). (a) and (c) depict regular teleportation through a cluster state where cat states have initial amplitude α=2 and α=4, respectively. (b) and (d) have the same initial conditions as at left, but now PhANTM is performed as opposed to regular teleportation. A random (but known) phase kick is applied at each step by homodyne measurement in all cases, but one can see that PhANTM preserves cat-state amplitude up to a level dependent on cluster-state squeezing (here 15 dB). FIG. 6B shows the evolution of the phase, ϕ, as the polar coordinate and amplitude, |α|, as the radial value according to the fit with a cat state of the form of Eq. 17 for cat states as they are teleported across a cluster state. In each plot, the large black dot shows the parameters of the initial cat state introduced to the cluster which was taken to be an even cat (ϕ=0) with no squeezing and amplitude of α=2 (a and b) or α=4 (c and d). In FIG. 6B parts (a) and (c), the cat states were simply teleported normally using P-basis homodyne measurements. FIG. 6B parts (b) and (d) begin with the same initial cat state but depict the effects of including PhANTM during teleportation across the cluster. As the states were teleported further along the cluster state, as indicated by different shadings to represent node-distance, the amplitude of the cat states decayed as seen by the final magenta dots being clustered about the origin in FIG. 6B parts (a) and (c). When the PhANTM was included, the cat-state amplitudes at no point spiraled to the center, but instead became clustered about an orbit at radius |α|≈1.5, thus preserving the cat state and the associated non-Gaussianity.

At each teleportation, finite-squeezing effects introduce Gaussian noise that dampens the amplitude of the cat state and introduces measurement-dependent randomization to the phase, which is also dependent on the amplitude of the cat state. This effect can be understood by realizing that as the cat-state amplitude increases, the interference fringes between the classical coherent state portions that determine the phase, #, oscillate at a higher frequency. Due to finite squeezing, the teleportation step applies a Gaussian envelope not centered about the origin in phase space, but instead centered about the measurement outcome. Shifts to this Gaussian envelope cause a slight ‘scanning’ effect of the interference fringe, which changes the phase at each step more drastically for larger cat states. Because this phase-randomization is known from previous homodyne measurement results, a feedforward displacement can be applied to shift the cat and realign the fringes to reset the phase.

Parts (a) and (c) in FIG. 6B show that the amplitude decays to zero through the poles of the plot when ϕ=0 or ϕ=7. This can be understood by realizing that as the cat shrinks, the interference fringes become dampened and very wide, so that a phase cannot be easily determined when the oscillations begin to vanish. These are the two extremes of shrinking cat states: either the even (ϕ=0) cat, which must tend toward the vacuum state as |α|<<1, or the odd (ϕ=π) cat, which tends toward a squeezed single photon.

Additionally, it is important to note that finite squeezing dictates a threshold at which the cat-state amplitude saturates. If one wishes to achieve non-Gaussianity beyond this threshold in a given cluster, e.g., larger amplitude cats, it will be necessary to make use of distillation-type protocols.

In some cases, when Photon Number Resolving (PNR) detection is used in conjunction with Homodyne detection on the every-other step described in FIG. 1C, the Schrödinger cat state amplitude can be preserved to a level dependent on the cluster state squeezing. For initial Schrödinger cat states with amplitude larger than supported by the cluster state squeezing, employing PhANTM can still hinder the decay and prevent the Schrödinger cat state from losing amplitude as quickly as it would without PhANTM as seen in FIG. 6A.

### Embedding Cat States in Higher-Dimensional Clusters

As described above, the PhANTM can be used to transform a 1-D quantum wire of sufficient length into a cat state. In some implementations, PhANTM may be used to generate Schrödinger cat states embedded in cluster states having higher dimensions. For example, the PhANTM algorithm maybe applied on any 1-D topological wire connected to a higher dimensional cluster state to produce a cat state embedded within the remainder of the cluster. With this method, the algorithm can be performed simultaneously on many quantum wires to engineer a non-Gaussian cluster state with cat states embedded at strategic locations. Each of these cat states will have an average amplitude dependent on the initial cluster-state squeezing and the number of nodes in each 1-D wire consumed by the PhANTM algorithm. Gaussian operations can then be performed as per the usual cluster state formalism with homodyne measurements to manipulate the exotic quantum states as desired, such as perhaps breeding the cat states as we will discuss further in the next section.

In some cases, a high-dimensional cluster state may be formed by entangling several one-dimensional (1D) cluster states to form an orthotope, or N-dimensional hyperrectangle. Regardless of the dimensionality of a cluster state, 1D cluster (1D chains) in the cluster states can be separated along their lengths from the rest of the cluster state using local homodyne measurements, leaving only one end of each 1D cluster attached to the original cluster state. After separating a 1D cluster, the PhANTM algorithm may be used to reduce the 1D cluster into a Schrödinger cat state entangled to the remainder of the larger cluster state.

In some implementations, a process of embedding cat states in a high dimensional cluster state (e.g., having a dimension larger than 1) may begin with performing homodyne detection in the position basis on every other row to decouple the corresponding nodes. Next, PhANTM may be performed along each of the remaining chains to transform them to cat states, until the end of the cluster is reached. Further homodyne measurements in the momentum basis are made on intervening nodes to stitch the resulting cat states together and form a 1D chain (or 1D quantum wire) of cat states. Provided the initial cluster is long enough, each state in the final chain is likely a Schrödinger cat state. This process may be extended to higher-dimensional cluster states and graph states with a more general structure. Furthermore, the geometry along which the chains are separated is arbitrary, as any 1D path within the N-dimensional cluster state will work.

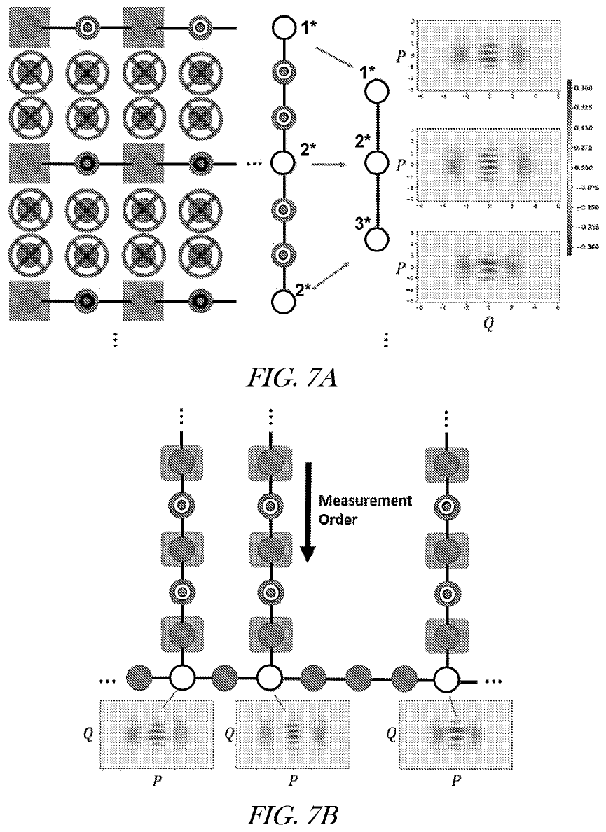

FIG. 7A illustrates an example method of transforming a two-dimensional (2D) Gaussian cluster state to a 1D cluster state having cat state nodes (e.g., a chain of entangles cat states). The original nodes of the 2D Gaussian cluster states in the form of momentum-squeezed states are represented by dark gray circles, and the lines indicate entanglement between neighboring nodes. Homodyne measurements in the position-basis are characterized by ⊗, which decouples measured nodes from the cluster and displaces neighboring nodes by the measurement result, which can be readily compensated for by feed-forward displacements. The squares indicate that a PhANTM operation is performed on at node. After several iterations, the remaining nodes evolve into desired Schrödinger cat states, as indicated by the white circles (labeled as 1*, 2*, and 3*). Finally, the remaining middle nodes from the original cluster state are measured on the momentum basis (indicated by white rings) to join the Schrödinger cat states. The result is now a 1D cluster state composed of Schrödinger cat states at each node entangled to their neighbors. The process shown in FIG. 7A may be used to transform cluster states having dimensions larger than two into a 1D chain of entangled cat states. In some cases, a portion of the 2D cluster state may be transformed to a 1D cluster state of entangled cat state that is entangled to the rest of the 2D cluster state.

FIG. 7B illustrates another example process of embedding cat states in a higher-dimensional cluster, where a 2D cluster state is reduced to a 1-D cluster peppered with cat states. The PhANTM can be applied to all chains simultaneously, but measurements within each chain must proceed in the correct order—top down in this example. In FIG. 7B rectangles indicate a step of the PhANTM algorithm (attempted photon subtraction, homodyne detection, and feed-forward displacement) and white rings indicate P-basis homodyne measurements. The white circle nodes represent fully de-Gaussified cat states.

In some examples, the local embedded state at each step in the cluster state may be a state in the circuit before the application of Ĉ_{Z} gates. Because all Ĉ_{Z} gates commute, the order may not matter as in other measurement-based QC systems. Thus in FIG. 7B, even though all Ĉ_{Z} gates are applied at the beginning, the localized structure of the entanglement in the graph means that the Ĉ_{Z} gates in the horizontal wire can be commuted to the end so that the Ĉ_{Z} gates and measurements in the vertical wires proceed and affect the local quantum states of the nodes embedded in the horizontal wire as if the horizontal Ĉ_{Z} gates had not yet been applied.

### State Enlargement and Breeding

In some cases, cat states embedded in a cluster state may be enlarged or used to generate grid state using various breeding processes. In some cases, the methods and algorithms described below may be used to enlarge cat states and generate grid states by Gaussian information processing performed on the cluster state. In some cases, enlargement of a cat state can be a probabilistic process. In some cases, generation of grid state can be a deterministic process. Some of the breeding and enlarging processes described below may be applied to any boson. Some of the existing breeding process used to enlarge Schrödinger cat states or generate grid states use states and operations that are decoupled from the eventual application or platform. In contrast, the method described herein may enable state enlargement and generation directly within the cluster state. In some examples, a local state resulting from any single breeding step may be embedded within the cluster state as a resource that can be further modified or used directly within the cluster state. In some cases, a state enlargement or generation process may comprise performing a homodyne measurement on one node of a pair of neighboring nodes within the cluster that are in cat states. The cat states may have been prepared using one or more of the processes described above (e.g., using PhANTM), or any other processes. In some cases, the orientation (e.g., along p-quadrature or q-quadrature) of the superposition displacements (e.g., displacement D in equation 1), forming a cat state of a node of the pair-neighboring node of the cat state, may determine whether the unmeasured mode will be an enlarged cat state or a grid state.

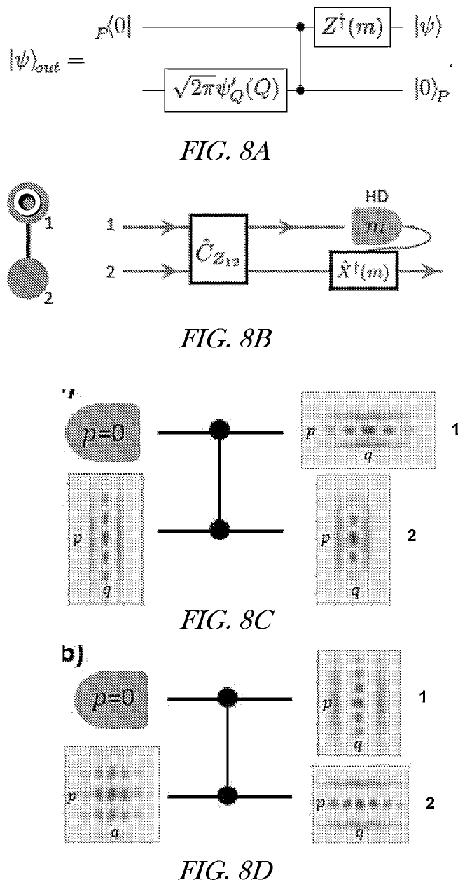

The cat states can be probabilistically bred into larger amplitude cat states. In some embodiments, a supply of squeezed cat states can be deterministically bred into a class of grid states. These procedures can be formulated in terms of beamsplitter interactions, but each method can proceed analogously by performing homodyne measurements on cat states embedded in a cluster state. Instead of teleporting through a momentum eigenstate, each cat state can be teleported through another cat state to produce the desired effect. Just as teleporting through a finite squeezed state leads to filtering of the teleported state with a Gaussian envelope, teleporting through an ancillary squeezed cat state may filter the P-basis wavefunction of the input with the Q-basis wavefunction of ancilla shifted by the homodyne result. This may be presented generically by replacing the momentum eigenstate from the teleportation circuit shown in FIG. 1A with an arbitrary quantum state, |ψ′ [symbol] . This can be rewritten as an operator in \hat{Q} applied to a zero-momentum eigenstate and commuted through the Ĉ_{Z} gate to have the general circuit shown in FIG. 8A. The quantum circuit shown in FIG. 8A teleports an input state the through an arbitrary ancillary state and teleportation may be performed independent of the form of the ancillary state. In some cases, the ancillary sate can be a squeezed cat state. Pulling the circuit taut and commuting the resultant Fourier transform to the end, we have that:

$${\vert ψ 〉}_{out} = \sqrt{2 π} \hat{R} ( \frac{π}{2} ) {ψ}_{Q}^{′} ( - \hat{P} ) {\hat{Z}}^{†} ( m ) \vert ψ 〉 , \qquad ( 27 )$$

where the subscript on |ψ′_{Q}(−\hat{P}) indicates that it is the Q-basis wavefunction of the starting ancillary state, even though it is a function of the \hat{P} operator. Finally, commuting the displacement through to the left reveals the result of:

$${\vert ψ 〉}_{out} = \sqrt{2 π} \hat{X} ( m ) \hat{R} ( \frac{π}{2} ) {ψ}_{Q}^{′} ( - \hat{P} + m ) \vert ψ 〉 . \qquad ( 28 )$$

This shows that up to an overall displacement and rotation, the initial P-basis wavefunction for |ψ′ [symbol] transforms as ψ_{P}(x)→ψ_{P}(x)ψ′_{Q}(m−x). Thus, in the P-basis, |ψ′ [symbol] is filtered by the Q-wave function of |ψ′ [symbol] . For the sake of illustration, supposed we input two equivalent squeezed cat states into the circuit but with one Fourier transformed with respect to the other, so that their wavefunctions are each proportional to the sum of two Gaussian peaks,

$${ψ}_{P} ( x ) = {ψ}_{Q}^{′} ( x ) = n ( {e}^{- \frac{1}{2 \text{?}} {( x - α )}^{2}} + {e}^{- \frac{1}{2 \text{?}} {( x + α )}^{2}} ) , \qquad ( 29 )$$

$$where$$

$$n = \frac{{π}^{- 1 / 4} \sqrt{\text{?}}}{\sqrt{2 + 2 {e}^{- 2 {\vert α \vert}^{2}}}} . \qquad ( 30 )$$

$$\text{?} \text{indicates text missing or illegible when filed}$$

when the measurement result is m=0, up to an overall rotation, the new wave-function, ϕ, is:

$${ϕ}_{P} ( x ) = {ψ}_{P} ( x ) {ψ}_{Q}^{′} ( x ) ∝ {e}^{- \frac{1}{\text{?}} {( x - α )}^{2}} + {e}^{- \frac{1}{\text{?}} {( x + α )}^{2}} + 2 {e}^{- \frac{1}{\text{?}} ( {x}^{2} + {α}^{2} )} . \qquad ( 31 )$$

$$\text{?} \text{indicates text missing or illegible when filed}$$

For peak separations of α≅1, the third term becomes negligible, and the wavefunction is the same as the initial wavefunction ψ, but with narrower peaks. In some cases, when a squeezing operation is applied to bring the peak widths back to the starting width, the peak separation would increase resulting in a cat state larger that the initial cat state. The above process is an example of breeding to enlarge cat states. In some embodiments, the inputs can be the same cat states as above, but first each mode may be Fourier transformed so that

$${ψ}_{P} ( x ) = {ψ}_{Q}^{′} ( x ) = {ne}^{- \frac{1}{2} {s}^{2} {x}^{2}} ( 2 cos α x ) . \qquad ( 32 )$$

Again taking a measurement outcome of m=0 for illustration, the output wavefunction, ϕ, from this process before the rotation would be:

$${ϕ}_{P} ( x ) ∝ {{e}^{- {s}^{2} {x}^{2}} ( cos α x )}^{2} , \qquad ( 33 )$$

which in the Q-basis can be expressed as:

$${ϕ}_{Q} ( x ) ∝ ( {e}^{- \frac{1}{\text{?}} {( x - α )}^{2}} + {e}^{- \frac{1}{\text{?}} {( x + α )}^{2}} + 2 {e}^{- \frac{1}{\text{?}} {x}^{2}} ) . \qquad ( 34 )$$

$$\text{?} \text{indicates text missing or illegible when filed}$$

Eq. 34 shows that with this case, the final state is now a superposition of three peaks with a binomial distribution as opposed to the two-peak superposition of the starting cat states. One can see how repeating this process can eventually give rise to a state with many peaks in the superposition which can approximate a grid state. These two cases are depicted in FIGS. 8C and 8D, where the process at left breeds to enlarge cats and the process at right breeds to create grids.

FIG. 8B illustrates another representation of the breeding process in a cluster using homodyne measurements. As shown in FIG. 8B, if two entangled neighboring nodes in a cluster state that are in cat states (e.g., node 1 and node 2), performing a p-quadrature homodyne (HD) measurement on one node (e.g., node 1) may transform the state of the second node (node 2) to a displaced enlarged cat state or a displaced approximate grid state, depending on the orientation of initial states of node 1 and node 2. The overall displacement can be eliminated or accounted for by a feedforwarding displacement process (e.g., \hat{X}^{†}(m)) to transform the displaced enlarged cat state to an enlarged cat state or the transform the displaced approximate grid state to an approximate grid state. In some cases, the orientation of a cat state may be controlled by performing one or more Fourier transforms (rotations of π/2) using standard Gaussian information processing techniques.

FIGS. 8C and 8D show the Wigner functions of the initial cat states of node 1 and node 2 and the resulting grid state (FIG. 8D) and bred state (FIG. 8C) for different orientations of the initial cat states. In the example shown in FIG. 8C, the cat state of the first node has displacement along the p-quadrature, the cat state of the second node is an identical cat state rotated by π/2, and the resulting cat state (after performing homodyne measurement in p-basis and feedforwarding displacement process) is an enlarged cat state. In the example shown in FIG. 8D, the cat state of the first node has displacement along the q-quadrature, the cat state of the second node is an identical cat state rotated by π/2, and the resulting cat state (after performing homodyne measurement in p-basis and feedforwarding displacement process) is a grid state.

In some cases, the output state generated by a breeding process, may depend on the phase of the input cat states, which is known from the iterated preparation method and can be controlled by performing regular teleportations to enact \hat{R}(π/2) gates. The advantage of the method described above is that it can be done within a cluster state using Gaussian measurements once all initial cats have been embedded within the cluster. Previous methods have examined breeding with beamsplitters and homodyne measurements, and in section DEE-7 below direct mapping of the beamsplitter breeding to breeding with Ĉ_{Z} gates, is described where the difference is that one input must be first Fourier transformed and the output has an additional Gaussian operation. The additional Gaussian operation can be undone with feed-forward displacement and Gaussian information processing on the cluster state. This mapping may imply that all previous results based on breeding cat states with beamsplitters holds within the canonical cluster state. In some examples, the mean amplitude of cat state produced by the PhANTM protocol is limited in part by the squeezing present in the cluster state. Breeding, however, may allow for having a chance at sacrificing pairs of smaller cat states to enlarge them. In some implementations, performing PhANTM in parallel on several 1-D chains may generate several weak cats and it would be advantageous to attempt breeding them into larger resource states.

### Enlarging Cat States Embedded in Cluster States

As described above, cat states embedded within a cluster state may be enlarged. In some cases, a teleportation circuit may effectively act as a quantum-mechanical filter circuit, where an input state is rotated and filtered by the wavefunction of the state being teleported through. In some cases, this property may be used to enlarge cat states embedded in a cluster state.

In some implementations, if a quantum state of a first cat state in the cluster has displacements along the p-quadrature (thus having interference fringes running along the q-quadrature), and the state of a second cat state is identical to the state of the first cat state rotated by π/2, then performing a homodyne measurement on the first cat state may result in the second cat state becoming a larger, more squeezed cat state, up to an overall displacement. This process can be dependent on the outcome of the homodyne measurement. In various implementations, close to half of all measurement (e.g., homodyne measurements) may produce enlarged cat states having high fidelity. In some cases, the cat states state enlargement process may use a portion of a large supply of cat states embedded within the cluster and reduced to generate a smaller supply of enlarged cat states. In various implementations, an enlarged cat state may be teleported within cluster (e.g., to a position of node where it is needed for an operation or process).

### Gottesman-Kitaev-Preskill (GKP) States

In some cases, breeding procedures may be used to generate of grid states. For example, the process at right in FIGS. 8C-8D, when repeated, can succeed without post-selection. The Kraus operator and resultant state after an arbitrary breed step in provided in section DEE-6 below.

The process of performing alternating PhANTM steps as detailed in the previous sections acts to produce cat states on the cluster state but breeding useful grid states may rely on squeezed cats. This is no obstacle, however, as any single-mode Gaussian operation can be implemented with a series of four homodyne measurements on the cluster state. For the specific case of squeezing, it suffices to apply three successive shear gates of

$$e \frac{{}^{i} {γ}_{k}}{2} {\hat{Q}}^{2}$$

with properly selected γₖ to effectively apply the gate Ŝ( [symbol] ). For squeezing s= [symbol] , the values of γₖ are γ₁=γ₃=s and γ₂=s⁻¹ Note that the maximum squeezing operation that can be applied in this way is limited by the squeezing level of the cluster.

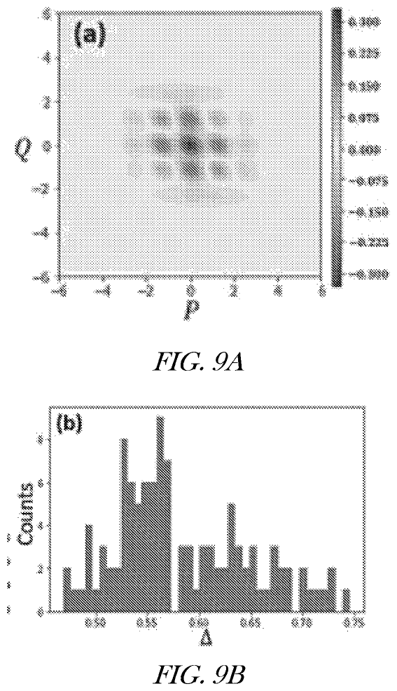

In some cases, the initial state can be a cluster state consisting of several quantum wires and performing many steps of the PhANTM protocol on each quantum wire generate a cat state entangled to the remaining portion of the cluster state. Each of these can be squeezed through a series of three homodyne measurements, and then pairs can be bred to make grid states without post-selection. An example of the resultant grid state is shown in FIG. 9A, where we have used states generated from average results after M=35 steps of the PhANTM protocol in a cluster of 17 dB squeezing, squeezed each one with three shear operations, and bred the result. Gaussian noise due to finite squeezing is included in all parts of the calculation to simulate realistic application of information processing on the cluster state.

To have a benchmark with some consistency, the target state was chosen to be the GKP qunaught, which is the GKP state with equal grid spacing in both quadratures. The initial cats are chosen so that the final spacing of the grid will be symmetric. This is achieved by tuning the shearing parameters used for the applied squeeze operation.

The asymmetries in the Wigner function shown arise from the stochastic homodyne measurements used when applying the squeezing with cluster-state processing. The final homodyne measurement for the breed step was post-selected on zero to achieve consistent states within the approximate GKP family to be used for direct comparison of the quality of the state. Varying the measurement result will not change final grid spacing or width in the Q-quadrature, but the introduced phase will alter the symmetry between the quadratures. Nevertheless, a grid state will be created under asymptotic breeding regardless of measurement results [47]. We repeated this procedure for each cat state created with the PhANTM algorithm using the same data as shown in FIG. 5C. Each cat state was squeezed with quantum information processing on the cluster state, and then bred with a copy to produce a similar grid state to the one shown. The resultant state was then fitted to a GKP qunaught with varying peak widths, where Δ² is the variance of each peak with the squeezing of the GKP state in dB given by s_{GKP}=−10 log₁₀ (2Δ²). The resulting histogram is shown in FIG. 9B, where the fidelity with the matched grid state averaged above 0.95 but was above 0.98 for all states with Δ<0.6. The values of Δ shown in the histogram are well above what is needed for fault-tolerance. Efficient cat-state breeding schemes can lead to GKP states that are more strongly squeezed than the cat states used to create them.

With sufficiently large cat states and high squeezing in the cluster state, breeding within the cluster allows for the generation of a supply of GKP states that are embedded within the computational resource. These can then be teleported throughout the cluster where they can then be used for fault-tolerant error correction and universal QC, or alternatively, states can be teleported through the embedded GKP state to enact error correction directly. Thus, while GKP states may be essential for error correction on cluster states, cluster states may also be valuable ingredients for the synthesis of GKP states.

### Breeding Grid States: Sequential Breeding and Tree Breeding

In some cases, one of or more features of the method described above with respect to enlarging a cat state maybe used to generate grid states. For example, a grid state may be generated by performing a homodyne measurement on one of a pair of neighboring cat states.

In some cases, a grid state with equal spacing may be mathematically represented as:

$$\vert {Ψ}_{β , φ , τ} 〉 ∝ \hat{D} ( β , φ ) \hat{S} ( r ) \vert 0 〉 \qquad ( 35 )$$

$$where$$

$$\hat{D} ( β , φ ) := {\prod }_{k}^{N} ( \hat{Z} ( β ) + {e}^{i {φ}_{k}} {\hat{Z}}^{†} ( β ) ) \qquad ( 36 )$$

The operator Z, which may be expressed as

$$\hat{Z} ( β ) = \hat{D} ( i \frac{β}{\sqrt{2}} )$$

with ϵ∈ [symbol] , is a momentum shift operator. In some cases, the spacing (e.g., the spacing in a phase space) of the grid state defined by equation 2 is equal to 2×β. In some cases, the spacing of a cat state made from a single operator of the form of Eq. 36 is given by 2×β. In some cases, β can be related to the amplitude (α) of a state (e.g., a cat state) via the equation β=2×√2×α. In some cases, the grid state defined by equation 2 and 3, can be a poor grid state as it includes two momentum shifts in the superposition. In some implementations, two cat states can be bred into a larger grid state (e.g., a grid state comprising three momentum shifts in the superposition). More generally, a pair of states having the form of a general grid state with equal spacing (e.g., represented by equation 2 and 3) may be bred deterministically into a new state that also has a form similar to a general grid state with equal spacing but with a larger number of superposition terms. In some cases, when two neighboring nodes in a cluster state are cat states, or more generally, grid states having the form of a general grid state having equal spacing (e.g., represented by equation 2 and 3), with potentially different values of squeezing, r, phases ϕₖ, and number of terms N, performing a Gaussian rotation of π/2 on mode one and then performing a p-quadrature homodyne measurement on the same mode will project mode two into a new grid state also of the form of equation 2 with modified parameters (e.g., squeezing, r, phases ϕₖ, and number of terms N), up to an overall Gaussian transformation. In some cases, the overall Gaussian transformation may depend on the measurement result and can be eliminated or accounted for by feed-forward quantum information processing on the cluster state. Unlike cat state enlargement, the grid state breeding can be deterministic. The measurement results only act to give an overall displacement to the state and modify the phases ϕₖ.

In some cases, where the breeding procedure described above relies on the grid states having similar spacing (P) before the measurement. In some examples, the spacing (e.g., the spacing in a phase space) of a grid state of a node can be adjusted to become substantially equal to the spacing of a gird state of a neighboring mode. In some cases, a squeeze operation may be applied to the grid state (e.g., by applying homodyne measurements to three unaltered cluster state nodes to apply successive shearing operations), and commute the squeeze operation through the momentum shifts, to alter both the r and β parameters of the grid state. In some cases, this approach may be used to adjust β parameter of neighboring cat states (e.g., by slightly changing the squeezing level of each cat state). Once a pair of states (e.g., a pair of cat states) have the same values of the β parameter, they can be bred deterministically into grid states. Because the application of squeezing and the breeding process are both deterministic, a large number of cat states can be continually bred into grid states within the cluster in a deterministic manner, up to overall Gaussian transformations. Grid states (e.g., GKP state) are potentially useful for several applications in quantum information, including the potential for error correction. Although this has been recently demonstrated in superconducting microwave cavities, an all-optical implementation would be highly desirable due to the massive scalability available with optical CV cluster states. Beginning with only cat states embedded within the cluster, we outline below two separate algorithms that can be used to breed grid states. The initial step in either algorithm is the same: once cat states are present in the cluster state, squeezing is applied to the states to be bred ensure that the value of β is approximately the same for each state after commuting the applied squeeze operator all the way to the right. This squeezing may be accomplished through three homodyne measurement steps with quantum information processing on the cluster state, or it may be applied through other means. These modified cat states can now be teleported into close proximity and bred into grids. Additionally, before each breeding step, the state to be bred may be subjected to feed-forward displacement operations based on previous measurement results. It should be noted that the spacing of the resultant grid state is predetermined by the spacing of the initial cat states.

In some implementations, a grid state may be generated (or bred) and enlarged by sequentially performing a series of homodyne measurements on nodes of a cluster state comprising cat states with similar or different amplitudes. In some cases, if the amplitudes of cat states of different nodes are different, the resulting grid state will be slightly asymmetric. Small differences in amplitude will slightly reduce the fidelity of the bred grid state with the target grid state. In some cases, the reduction in fidelity caused by differences between the amplitude of the original cat states can be robust to small changes of original amplitudes. In some cases, a pair of cat states with similar amplitudes (a) are in close proximity. The pair of cat states can be bred into a small grid state by performing a homodyne detection.

In various implementations, the amplitudes of cat states in a cluster state may be adjusted using Gaussian operations on the nodes to reduce the difference between the amplitudes of cat states of different nodes.

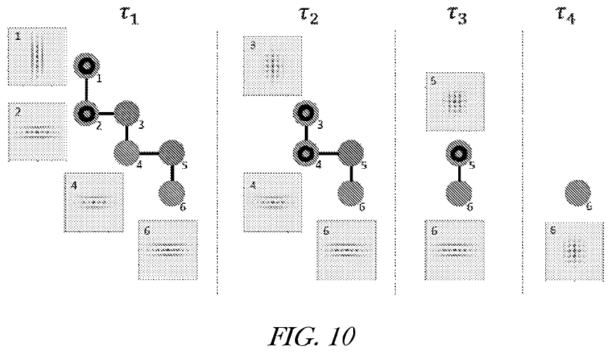

FIG. 10 shows an example of a sequential grid state breeding process in a cluster state. In FIG. 10, a black ring indicates p-quadrature homodyne measurement on the corresponding node. Time steps τ₁ indicate the evolution of the state after each series of measurements. In some cases, mode 1 and mode 2 can be in a first and a second cat states respectively (represented by red circles). In some examples, the second cat state can have a superposition-displacement that is rotated by π/2 with respect to the superposition-displacement of the first cat state. In the example shown, the first cat state has a superposition-displacement along the q-quadrature and the second cat has a superposition-displacement along the p-quadrature. In some cases, the first and second cat states may have been prepared by performing a Gaussian π/2 rotation on one or both cat states. The first cat state and second cat state can be entangled with each other and embedded in the cluster state.

In some implementations, the process may begin by performing a homodyne detection on mode 1 to transform the state of mode 2 (second cat state) to an intermediate non-Gaussian state (e.g., an intermediate or a displaced grid state). Next, a feed forward Gaussian operation is performed on mode 2 to transform the intermediate non-Gaussian state to a grid state. The grid state may be teleported to a rotated grid state of a neighboring mode (e.g., mode 3), e.g., by performing a homodyne detection (e.g., π/2 Gaussian rotation or a Fourier transform) on mode 2. In some cases, before teleportation mode 3 can be in an unaltered state (e.g., a state similar to the state of the original states of the modes upon generation of the corresponding cluster state). In some cases, the grid state of mode 3 may be rotated by π/2 with respect to the grid state of mode (before teleportation). If the node comprising the newly rotated grid state (mode 3) has a neighbor that is another cat state (e.g., mode 4), performing a homodyne measurement on mode 3 followed by a Gaussian feed forward operation on mode 4 transforms the state of mode 4 to an enlarged grid state. If mode 5 that is a mode adjacent to mode 4, is an unaltered mode of the cluster state, performing another homodyne measurement on mode 4, will teleport the state of mode 4 (e.g., an enlarged grid state), applies another Fourier transform (a π/2 Gaussian rotation) and prepares mode 5 for breeding with a neighboring cat state at mode 6. A final homodyne measurement of mode 5 projects mode 6 into a larger grid state. This procedure can proceed continuously, with each cat being sequentially bred into the next to eventually create the desired size grid state.

In some implementations, the Gaussian feed forwarding operations performed on the resulting intermediate grid state (or displaced grid state) of mode 2 may be skipped. As a result, the states of mode 4 and mode 6 may be intermediate enlarged grid states (enlarged grid states up to an overall Gaussian transformation). In these implementations, once the procedure is completed (the last cat state has been transformed to an intermediate enlarged grid state), a feed forward Gaussian operation may be used to transform the final intermediate (or displaced) enlarged grid state to an enlarged grid state.

A final homodyne measurement of mode 5 projects mode 6 into the largest grid yet. This procedure can proceed continuously, with each cat being sequentially bred into the next one to generate a grid state having the desired size, up to an overall Gaussian transformation. The Wigner functions in FIG. 7A represent the non-Gaussian state of each node prior to performing local p-quadrature homodyne measurement. The dark gray circles represent unaltered states. White rings indicate a p-quadrature measurement on the associated node.

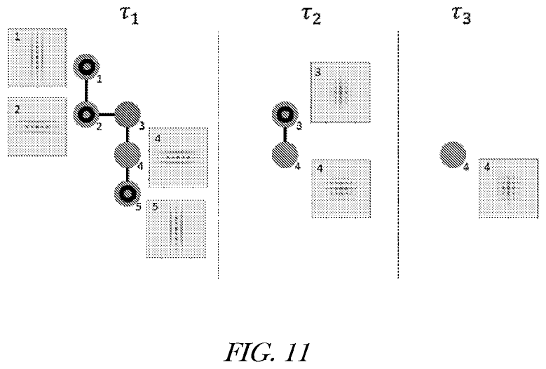

Breeding grid states can also proceed as a tree-like process, as depicted in FIG. 11. Here, two pairs of cat states in the cluster state are selected. The two pairs may be entangled to a mode of the cluster state. For example, a first pair may include modes (nodes) 1 and 2, a second pair may include modes 4 and 5, where modes 2 and 4 are entangled to mode 3. In some cases, mode 3 may not be a cat state. In some cases, the cat states of each pair or all cat state may have similar or substantially equal amplitudes. In some cases, the initial rotations of the cat states in each pair may be prepared such a grid state can be bred from each pair by performing a homodyne measurement (e.g., P-quadrature homodyne measurements) as described above with respect to FIG. 8D. With reference to FIG. 11, the first pair may include modes 1 and 2 and the second pair may include mode 4 and 5. Modes 1 and 5 may have a superposition displacement along q-quadrature and modes 2 and 4 may have a superposition displacement along p-quadrature. An example tree-like process of breeding grid states may include: 1) Performing homodyne measurements (e.g., p-quadrature homodyne measurements) on modes 1 and 5 to make small grid state in modes 2 and 4. 2) Performing another homodyne measurement on mode 2 to teleport mode 2 to mode 3 (e.g., an originally in an unaltered state). The homodyne measurement may result in a π/2 Gaussian rotation (Fourier transform) of the teleported state. 3) A final measurement on mode 3 may project mode 4 into a larger grid state. In this way, pairs of similar cat states are bred into grids, and pairs of those grids are bred, and so on until the desired state is reached. The Wigner functions in FIG. 11 show non-Gaussian states at each red node prior to performing local p-quadrature homodyne measurement. Black rings indicate a p-quadrature measurement on the associated mode (node). Time steps τ₁ indicate the evolution of the state after each series of measurements. In some cases, active displacements may be performed during the process as necessary.

In various implementations the processes described above with respect to FIGS. 10 and 11, may be used to enlarge cat states or breed approximate grid states in higher dimensional (e.g., 2, 3, 4 or larger) clusters.

In some embodiments, before performing the breeding processes described above with respect to FIG. 10 or 11, squeezing may be applied to the initial cat states embedded in the cluster to make the amplitude of the cat states approximately the same. In some examples, squeezing may be accomplished through three homodyne measurement steps with quantum information processing on the cluster state, or it may be applied through other means.

Phase Estimation with Squeezed Cat States

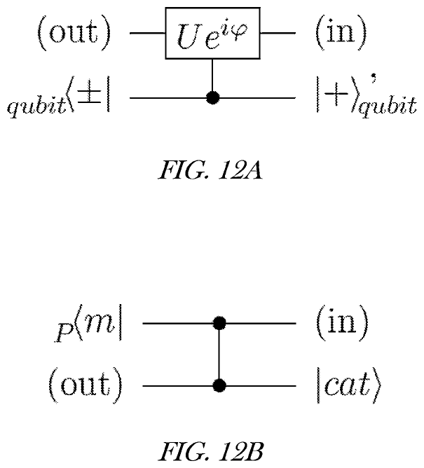

Phase estimation for unitary operator Û is a procedure to measure the eigenvalue of the operator, e^{iθ}, where the eigenvalue of the operator is used as an input state of a corresponding eigenstate, Û|ψ_{θ}>=e^{iθ}|ψ_{θ}>. In some cases, for example when Û is a displacement operator operating on discrete states comprising qubits, phase estimations may be performed using an ancilla qubit and a discrete Pauli-basis measurement. FIG. 12A illustrates an example of such phase estimation process where an ancilla qubit is used to estimate the phase of a displacement operator Û=Ue^{iφ}=e^{iθ\hat{Q}}. The ancilla qubit is linked to the quantum information (|ψ>) by a controlled-displacement operation, and then is measured in the in a Pauli basis (e.g., |±>). If the displacement is complex and of the form \hat{Z}=e^{iθ\hat{Q}}, then the effect of the circuit in FIG. 12A is to apply either the operator cos (θ\hat{Q}) or sin (θ\hat{Q}) depending on the measurement result, up to a global phase. Thus, this operator is a sinusoid with a phase shift of either 0 or π/2 dependent on the measurement result.

In some cases, a phase estimation method for estimating a phase of an operator configured to operate on a cluster state may use a Schrödinger cat state instead of the ancilla qubit, and a homodyne measurement (e.g., in momentum basis). FIG. 12B illustrates a method of phase estimation that is similar to the method described above with reference to FIG. 12A but based on a Schrödinger cat state (|cat>). In some cases, the cat state may be embedded in a cluster state on which the operator may be applied. A first node of the circuit shown in FIG. 12B may be in a state |ψ> that contains quantum information. In some cases, the first node may be a mode of a cluster state. The first node may be connected to a second node that is in a squeezed cat state (|cat>). In some cases, the first node and the second node can be entangled neighboring nodes. In such cases, the application of the controlled-Z gate may not be needed because, the neighboring nodes can be connected during the preparation of the initial state. In some cases, where the first and the second nodes are not neighboring nodes, one of the nodes may be teleported multiple times until it becomes adjacent to the other. In some cases, all nodes between the first mode (|ψ>) and the second mode (the cat state) may be measured along the p-quadrature to place the two corresponding states at neighboring nodes (e.g., neighboring nodes of cluster state). In some cases, the first node and/or the second node may not be part of the cluster state. In such case, these nodes can be connected by applying a controlled-Z gate (a CZ gate) or another local-unitary equivalent entangling gate.

In some examples, the squeezed cat state may have been generated by Gaussian information processing on the cluster state. When a homodyne measurement is performed on the second node, that is originally in a squeezed cat state, the effective operator applied to the state |ψ> of the first node (the quantum information), is a cosine function of the operator \hat{Q} shifted by the measurement result with an overall Gaussian envelope in phase space dependent on the squeezing. After performing a feed-forward displacement to compensate for the measurement result, this operation thus becomes identical to the qubit-based phase estimation in the large squeezing limit, where the applied sinusoid operation now has a continuous phase shift based on the measurement result. By performing Fourier transforms before and after this circuit (through teleportation on the cluster state), the operator can instead be transformed to a sinusoid in \hat{P}. With this translation, phase estimation protocols developed for cavity-QED with ancilla qubits can be

In some cases, a phase-estimation scheme developed to create GKP states without qubits may be modified for breeding cat states. Some embodiments disclosed herein relate to phase-estimation on a cluster state for unitary operators that are phase-space displacements. For a general unitary operation Û= [symbol] where [symbol] is a time-independent Hermitian operator (which can be proportional to P), a single round of phase estimation can be implemented using an ancillary qubit described by the circuit shown in FIG. 12A where e^{iϕ} is a phase factor. Here, a controlled-Ûe^{iφ} is applied to the input state state in mode one where a qubit initialized to the |+ [symbol] state is used as a control. This controlled unitary can be applied by implementing the operator:

$${C}_{{U}_{12}} = {e}^{\frac{\text{?}}{2} ( + φ )} {e}^{- \frac{\text{?}}{2} ( ( + φ ) ⊗ {{σ}^{\text{?}}}_{{\text{?}}_{2}} )} = {e}^{\frac{\text{?}}{2} ( + φ )} ( cos ( \frac{+ φ}{2} ) ⊗ - i sin ( \frac{+ φ}{2} ) ⊗ {{σ}^{\text{?}}}_{{\text{?}}_{2}} ) ) . \qquad ( 37 )$$

$$\text{?} \text{indicates text missing or illegible when filed}$$

The ancilla qubit is then measured in the ±-basis. When the applied unitary is a displacement, without losing the generality of arbitrary displacements, Û can be written as:

$$\hat{U} = {e}^{ia \hat{P}} , \qquad ( 38 )$$

here, rotating the input state before and after applying Û will give the desired freedom for arbitrary displacements. In this case, the effective measurement-based operator applied to the input state to the circuit shown in FIG. 12A is given by:

$${\hat{m}}_{+} = {e}^{\frac{1}{2} ( a {\hat{P}}_{1} + φ )} cos ( \frac{a \hat{P} + φ}{2} ) \qquad ( 39 )$$

$${\hat{m}}_{-} = {ie}^{\frac{1}{2} ( a {\hat{P}}_{1} + φ )} sin ( \frac{a \hat{P} + φ}{2} ) . \qquad ( 40 )$$

Thus, up to a global phase and a displacement, a single round of phase estimation applies a sinusoid in \hat{P} with an additional measurement-dependent phase shift of either 0 or

$$\frac{π}{2} .$$

Next, the result of the circuit shown in FIG. 12A may be compared to teleporting an input through a squeezed cat state on a cluster state using the circuit shown in FIG. 12B. If the cat state is oriented such that the fringes are along the P-quadrature, that is if:

$${\vert cat 〉 ∝ \int {dxe}^{- {x}^{2} / 2 {s}^{2}} cos ( αx ) \vert x 〉}_{Q} \qquad ( 41 )$$

where s= [symbol] is the squeezing, then using the results of the general teleportation circuit given by Eq. 28, shows that this circuit applies the operator:

$${\hat{m}}_{m} = \sqrt{2 π} \hat{X} ( m ) \hat{R} ( \frac{π}{2} ) {e}^{- {P}^{2} / 2 {s}^{2}} cos ( aP - m ) . \qquad ( 42 )$$

After undoing the measurement-induced displacement and rotation with further cluster-state processing, and for large enough squeezing, this operator reduces to:

$${m}_{m} \approx \sqrt{2 π} cos ( a \hat{P} - m ) , \qquad ( 43 )$$

which is identical to the qubit-based phase estimation up to an overall displacement, where the applied sinusoid operation now has a phase shift that is continuous based on the measurement result.

By performing Fourier transforms before and after this circuit (through teleportation on the cluster state), the operator can instead be transformed to a sinusoid in \hat{Q}. Inserting another cat state for the input state in circuit shown in FIG. 12B is similar to the method of GKP synthesis as described in the previous section where repeated phase-estimation is used to make grid states. More generally, methods from other bosonic phase-estimation schemes may be enacted using cluster states and PhANTM generated cat states.

### Photon-Counting-Assisted Node-Teleportation in Macronode Cluster States

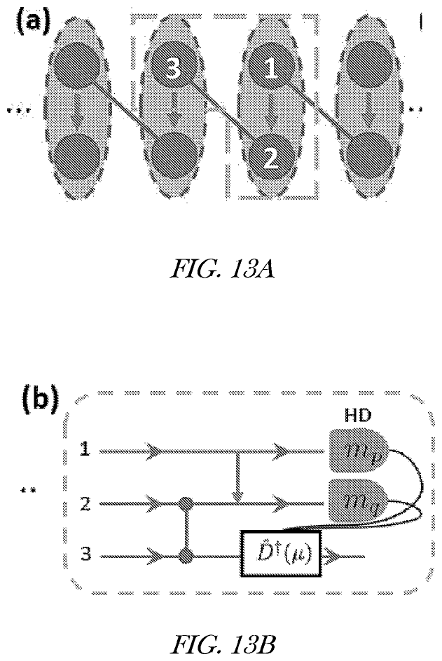

In various implementations, a continuous variable quantum computing platform may comprise macronode clusters instead of canonical clusters. For example, when a cluster state has to be generated using linear optical processes, all mode squeezing operations may be performed up-front to avoid inline squeezing required for generating a canonical cluster based on CZ entangling gates. In some cases, the cluster states that are generated without inline squeezing, may be formed from macronodes, which are a collection of two or more physical modes containing non-locally distributed information encoding a single logical state. In some cases, a macronode cluster is generated using entangled resources in the form of two-mode squeezed states, which can be generated either directly or by coupling two single-mode squeezed states on a beam splitter, which are both equivalent to a two-mode canonical cluster state, up to a phase. These entangled pairs are then linked up to form a macronode cluster state (e.g., through more beam splitting operations). FIG. 13A illustrates an example of one-dimensional (1D) macronode cluster state comprising a plurality of entangled two-mode squeezed states. The dark gray circles connected by lines depict the initial entangled resource, e.g., a two-mode squeezed state, and the arrows depict balanced beam splitting operations used to form the macronode cluster state by linking (e.g., entangling) the two-mode squeezed states. Each shaded oval represents a “macronode,” which may contain the logical information. In various implementations, a macronode cluster states may be used to perform quantum information processing similar to a canonical cluster state.

FIG. 13B illustrates an example teleportation process or circuit (a quantum circuit) for teleporting macronodes of a macronode cluster state where quantum information is teleported without applying additional Gaussian operators, up to a displacement dependent on the measurement result. In the example teleportation circuit shown in FIG. 13B, the circuit is used to teleport two modes of a two-mode macronode (e.g., a two-mode squeezed state) and a mode of a neighboring macronode (the three modes depicted by the orange box in FIG. 13B). The entangling gate between modes two and three can be experimentally implemented by yet another beam splitter between single-mode squeezed states, or modes two and three can be entangled initially as a two-mode squeezed state. In some cases, performing homodyne measurements in the p-basis (mₚ) on the first mode and in the q-basis (m_{q}) on the second mode teleports the corresponding quantum information up to an overall displacement with argument depending on both measurement results. In some cases, the overall displacement may be removed using feed-forward operations. In general, performing several teleportation operations using different homodyne measurement basis, is sufficient for the application of arbitrary Gaussian gates, up to single-mode displacements.

In various implementations, one or more features of the Photon-counting-assisted Node-Teleportation Method (PhANTM) described above with respect to one-dimensional canonical clusters states may be used for macronode teleportation based on photon counting measurements.

In some cases, several one-dimensional macronode cluster states may be linked together to form a higher-dimensional macronode cluster state. The teleportation methods described below with respect to one dimensional macronode cluster states can extended to higher dimensional macronode cluster states.

In some implementations, the teleportation process shown in FIG. 13B may be modified by adding a beam splitter and a PNR detector immediately prior to one of the homodyne detections, to perform photon subtraction and PNR detection prior to one of the homodyne detections. In various implementations, adding the PNR detection to the teleportation process shown in FIG. 1C may be used to generate non-Gaussian states embedded in a macronode cluster (similar to the effect of using PhANTM to generate non-Gaussian states embedded in a cluster state). In some cases, the modified teleportation process may comprise one or more features of described above with respect to PhANTM process.

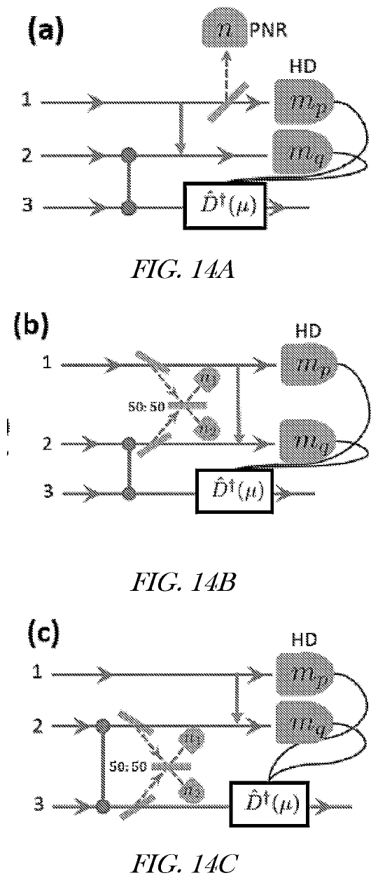

FIG. 14A illustrates an example of a modified teleportation process for teleporting the states of the modes (that are in an initial two-mode squeezed state) in a first macronode of a macronode cluster state to a non-Gaussian state (e.g., a cat state or a weighted cat state) of a mode in a second macronode of the macronode cluster state, next to the first macronode. In some cases, the optical field associated with mode 1 of the first macronode, may be split into two portions, a first portion and a second portion, using a beam splitter. The first portion may be redirected to a detector to perform PNR detection, and the second portion may be transmitted through the beam splitter. In some cases, a homodyne measurements in p-basis (labeled as mₚ in FIG. 14A) may be performed on the second portion and a homodyne measurement in q-basis (labeled as m_{q} in FIG. 14A), may be performed on mode 2 of the first macronode to transform the state of a third mode (mode 3) of the second macronode to a non-Gaussian state. In some cases, the state of the non-Gaussian mode may be a weighted cat state of the form:

$$\vert cat 〉 ∝ ( A \hat{D} ( α ) + {Be}^{i ϕ} \hat{D} ( - α ) ) \hat{S} ( r ) \vert 0 〉 , \qquad ( 44 )$$

where the weighting coefficients, A, B may depend on the measurement outcomes. In some cases, the coefficients A and B may depend on one or more subsequent measurement outcomes. The output non-Gaussian state (e.g., represented by equation 4) may be displaced, and any displacement incurred may be accounted for by feed-forward displacements on the third mode or subsequent changes to future measurement bases.

In some examples, when mode two and mode three are highly squeezed, such that Gaussian noise can be temporarily ignored, repeating the teleportation process shown in FIG. 14A, may apply a polynomial in \hat{Q}, where the polynomial may depend on the overall number of photons subtracted after several rounds, up to measurement-dependent displacements performed between the receptions. These measurement-dependent displacements may be canceled or removed using through feed-forward operations. In some cases, the teleportation process shown in FIG. 14A may comprise one or more features of the photon-subtraction in teleportation processes described above with respect to one-dimensional canonical clusters. However, in this case displacements can be more complex.

If the location of the beam splitter and PNR detector is changed from mode one to mode two (before the q-basis homodyne measurement instead of before the p-basis homodyne measurement), then the process shown in FIG. 14A will instead apply polynomials in P. However, this is identical to the process in FIG. 14A up to a Fourier transform on the quantum information before and after the process. Failing to subtract any photons will act as described above with respect to PhANTM applied to one-dimensional canonical clusters, where only more Gaussian noise is added due to finite squeezing of the cluster state.

In some implementations, macronodes of a macronode cluster state may be teleported using coherent photon subtraction from two modes (e.g., two modes of a macronode) in the macronode cluster. In some cases, coherent photon subtraction may comprise subtracting a portion of photons associated with each of the two modes, generating two photon streams each comprising a fraction of photons in each subtracted portion, and performing PNR detection on each photon stream.

FIG. 14B illustrates an example macronode teleportation process that uses coherent photon subtraction for teleporting a macronode of a macronode cluster state. In the example shown, two beam splitters (e.g., two weakly reflective beam splitters), or other components that can couple a portion of incident light to vacuum, may be placed in the paths of the two modes of a macronode, respectively. The reflected modes (reflected light associated with the mode) are then interfered using a third beamsplitter to remove path information about the original light modes, and the corresponding outputs are sent to two PNR detectors. When n1=0(1) and n2=1(0), e.g., when each detector receives one photon associated with a different mode, then a single photon has been subtraction in a superposition between the two original modes. In some cases, the coherent subtraction process adds Gaussian noise to the system and the level Gaussian noise may depend on the reflectivities of the first two beam splitters (used to subtract photons). Varying the reflectivities of the three beam splitters may alter the weighting of the annihilation operators in the effective operator superposition, and the phase of these effective operators can be controlled by the beamsplitter phases. When a single photon is detected overall, the processes illustrated in FIG. 14B and FIG. 14A are mathematically equivalent up to a squeezing operator and a Fourier transform.

FIG. 14C illustrates an alternative implementation of macronode teleportation process, where the coherent photon subtraction is applied two nodes of two different macronodes (e.g., two neighboring macronodes). In the example shown, coherent photon subtraction is applied to node two and node three, where node two is a node in the macronode formed by node one and node two, and node three is a node in a neighboring macronode. The process shown in FIG. 14C also applies a first-degree polynomial in \hat{Q} when only one photon is coherently subtracted. In some cases, this polynomial can be a real polynomial. Furthermore, if the homodyne measurements performed on modes two and three are no longer restricted to p and q bases, respectively, this coherent subtraction still may apply a first-degree polynomial in Q after the application of a measurement-basis dependent Gaussian gate, up to an overall displacement.

In some cases, such as the examples shown in FIGS. 14B and 14C, the coherent photon subtractions are performed before the entangling the node one and node two (indicated by the arrow). In some other cases, the coherent photon subtraction may be performed after entangling nodes one and two. In some cases, coherent photon subtractions may be performed either after the entire macronode cluster state is generated, or after generating the macronodes (e.g., the initial two-mode entanglement), but before the final entangling operation.

In some cases, if the reflectivity of the first and second beam splitters are chosen such that the probability of subtracting more than one photon is negligible, then the processes shown in FIG. 14A-14C may be used repeatedly to build up a polynomial in Q.

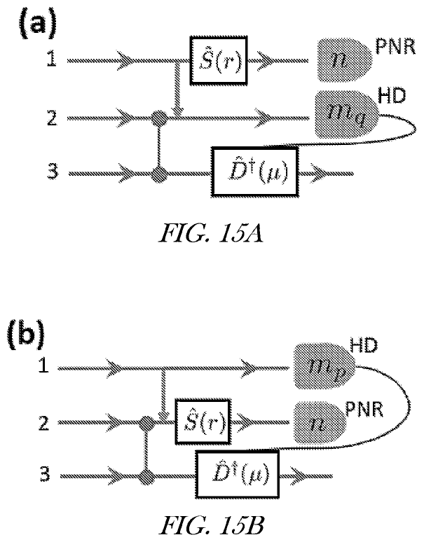

As described above, in some cases, the node teleportation process in a canonical cluster state may comprise a squeezing process followed by a PNR detection. In some cases, a similar approach may be used for teleporting macronodes in a macronode cluster state. In some cases, one of the homodyne detections in the teleportation process described above may be replaced by a squeezing process followed by a PNR detection. In some cases, the squeezing process may be performed after the macronode cluster state is generated. In some other cases, the squeezing process may be performed to modify (unbalance) an initial squeezing process resulting in an effective squeezing later, or through the application of Gaussian information processing on the cluster. FIGS. 15A and 15B illustrate example teleportation processes (circuits) comprising a squeezing process that may be performed on three modes of a macronode cluster. In various implementations, the PNR detection may replace a homodyne measurement in the conventional teleportation process shown in FIG. 13B. In FIG. 15A, the squeezing, and the PNR detection are performed on the first node of the macronode, replacing the homodyne detection in p-basis. In FIG. 15B, the squeezing, and the PNR detection are performed on the second node of the macronode, replacing the homodyne detection in q-basis. In some cases, the circuits shown in FIGS. 15A and 15B can mathematically related. For example, application of a Fourier transform to the quantum information both before and after the circuit shown in FIG. 12A may transform it to the circuit shown in FIG. 15B and vice versa.

In some cases, the squeezing can be performed by an in-line squeezer, applied effectively through asymmetric squeezing before generating the cluster state, or through Gaussian quantum information processing on the cluster.

In some cases, the outcomes of the teleportation processes shown in FIGS. 15A and 12B may be equivalent to applying an identical Kraus operator to the outcome of the process shown in FIG. 1D up to an overall single-mode Gaussian operation.

In various embodiments, the methods described above with respect to macronode cluster states comprising two-mode macronodes, may be used to generate and control non-Gaussian states in macronodes comprising larger macronodes (e.g., macronodes comprising three or more entangled states).

In some cases, certain experimental implementations of cluster states may not generate a canonical cluster based on Ĉ_{Z} entangling gates, which would require inline squeezing, but instead rely on linear optics with all squeezing generated up-front. These types of cluster states are formed from macronodes, which, as described above, are a collection of two or more physical modes containing non-locally distributed information encoding a single logical state. Certain embodiments disclosed here, may provide a connection from the canonical case considered above to the macronode implementation that has been experimentally realized. The dictionary protocol presented below shows with more detail that PhANTM can be used to embed cat states into macronode cluster states as well.

The macronode cluster states are created by beginning with many entangled resources in the form of two-mode squeezed states, which can be generated either directly or by interfering two single-mode squeezed states on a beamsplitter, and then entangled pairs are linked up through more beamsplitter interactions. Quantum information processing can proceed analogously to the canonical case, where now all physical modes within each macronode are subject to homodyne measurements.

The simplest macronode cluster state, the quantum wire, contains two physical modes per macronode and may be used to experimentally implement Gaussian operations. Weaving together quantum wires can produce higher-dimensional cluster states; the 2D case of this may be used to implement a set of universal Gaussian gates. The PhANTM algorithms discussed previously in the context of canonical cluster states can be translated to macronode clusters.

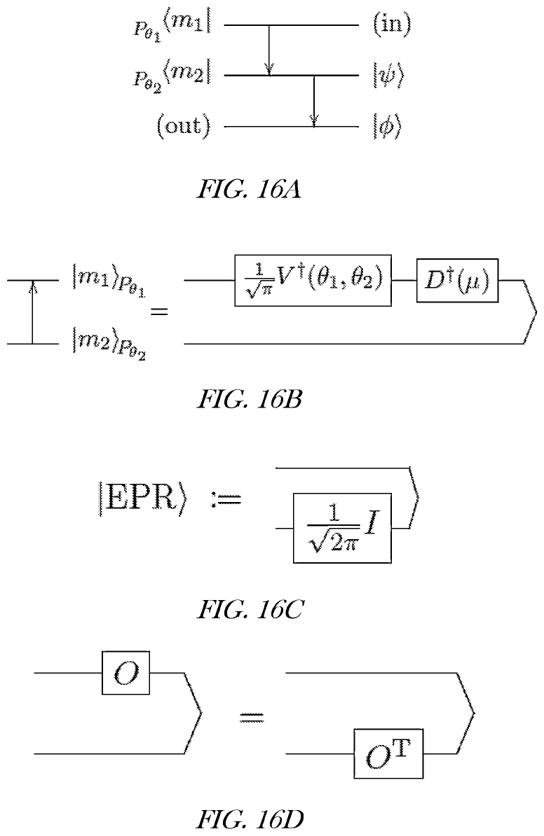

Before giving the result, we first review a formalism that may be used to treat general teleportation on a macronode wire, where arbitrary and potentially non-Gaussian ancillary inputs can be used to impart non-Gaussianity on the cluster (e.g., a macronode cluster) through teleportation. This operation can be described by a local teleportation ‘gadget’ for teleporting a macronode cluster state, which has the circuit shown in FIG. 16A. Note that here input states propagate from right to left. Here the convention that an arrow represents a balanced beamsplitter interaction between two qumodes, has been adopted,

$$= {B}_{jk} ( \frac{π}{4} ) := {e}^{\frac{π}{4} ( {α}_{j} {α}_{k}^{†} - {α}_{j}^{†} {α}_{k} )} \qquad ( 45 )$$

The overall effect of this teleportation circuit is given by

$$( out ) – \frac{1}{π} A ( ψ , ϕ ) – D ( μ ) – V ( {θ}_{1} , {θ}_{2} ) – ( in ) \qquad ( 46 )$$

which is the same as applying the Kraus operator,

$${K}_{m 1 , m 2} = \frac{1}{π} A ( ψ , ϕ ) D ( μ ) V ( {θ}_{1} , {θ}_{2} ) , \qquad ( 47 )$$

to the input state. Here, \hat{D}(μ) is a displacement based on the homodyne measurement with

$$μ = \frac{{m}_{1} {e}^{i {θ}_{2}} + {m}_{2} {e}^{i {θ}_{1}}}{sin ( {θ}_{2} - {θ}_{1} )} . \qquad ( 48 )$$

and \hat{V} is a Gaussian operation that depends only on the measurement basis given by

$$\hat{V} ( {θ}_{1} - {θ}_{2} ) = \hat{R} ( {θ}_{+} - \frac{π}{2} ) \hat{S} ( ln ( tan {θ}_{-} ) ) \hat{R} ( {θ}_{+} ) . \qquad ( 49 )$$

Here θ_{±} are defined as:

$${θ}_{\pm } = \frac{1}{2} ( {θ}_{1} \pm {θ}_{2} ) . \qquad ( 50 )$$

The potentially non-Gaussian operation, Â(ψ, ϕ), comes from non-Gaussianity within the input states |ψ [symbol] and |ϕ [symbol] , and can be determined by:

$$\hat{A} ( ψ , ϕ ) = \int \int {d}^{2} α \tilde{ψ} ( {α}_{1} ) ϕ ( {α}_{R} ) \hat{D} ( α ) \qquad ( 51 )$$

with complex parameter α−α_{R}+iα_{I}. The respective position and momentum wavefunctions of the ancillary states are given by \hat{ψ}(t)=_{P} [symbol] t|ψ [symbol] and ϕ(s)=_{Q} [symbol] s|ϕ [symbol] . In the case where the input states are Gaussian only, then Â(ψ,ϕ) is also Gaussian. In the specific case where the inputs are position and momentum eigenstates, |ψ [symbol] =|0 [symbol] _{P} and |ϕ [symbol] =|0 [symbol] _{Q}, then the operator Â(ψ,ϕ) reduces to the identity, and we have the ability to apply a complete Gaussian gate set as in the canonical case. FIG. 16B shows an identity between the state transition and a quantum circuit. In FIG. 16B ended circuit represents an EPR pair as shown in FIG. 16C and the EPR pair is defined in the q-basis as:

$${{{\vert EPR 〉}_{12} = \frac{1}{\sqrt{2 π}} \int dt \vert t 〉}_{1 Q} \vert t 〉}_{2 Q} \qquad ( 52 )$$

One particular use of a diagrammatic approach is that operators can be easily transferred, or ‘bounced’, from one mode to the other across an EPR pair. This bouncing can be represented as the equivalence of the two circuits show in FIG. 16D where the operator Ô acting on one mode of the EPR pair is the same as Ô^{T} acting on the other, where the transpose of the operator is taken in the Q-basis, so that Q^{T}=\hat{Q} while \hat{P}^{T}=\hat{P}. This formalism is useful whenever two homodyne measurements are performed on neighboring entangled nodes. The method we have described to generate cat states on a Gaussian cluster is predicated on finding a means to apply polynomial operators comprised solely of the \hat{Q} operator (or solely of \hat{P}, up to a Fourier transform) to the initial squeezed vacuum nodes of the cluster. In the canonical case, this was achieved by adding a photon subtraction step directly before the measurement.

### Dictionary Protocol

Some of the methods disclosed here may of a dictionary protocol. Consider a macronode teleportation circuit where we have applied some operator Ô before the first homodyne measurement, and the measurement angles are chosen such that we perform respective P and Q-basis measurements

$$( {θ}_{1} = 0 , {θ}_{2} = \frac{π}{2} ) .$$

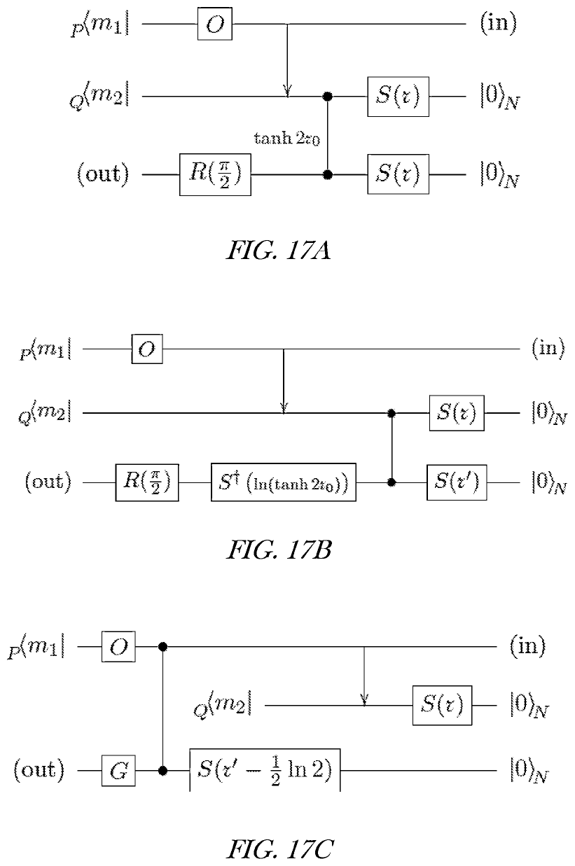

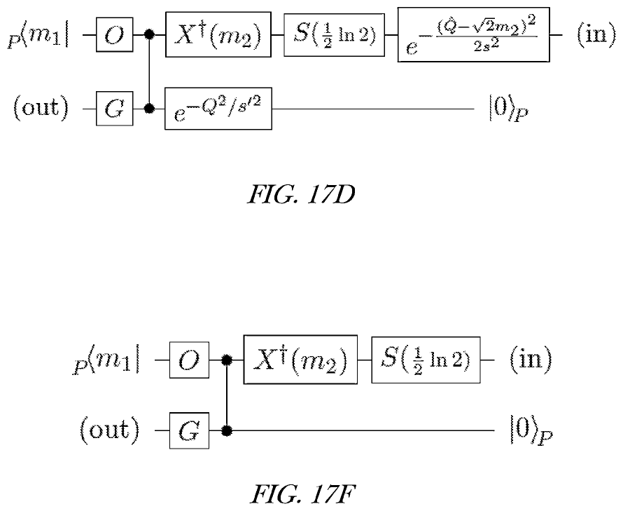

With the inclusion of finite squeezing, this circuit will appear as the circuit shown in FIG. 17A. Note that for the formation of the finite-energy EPR pair in the bottom two modes a weighted Ĉ_{Z} gate e^{i tan 2} [symbol] ^{₀}^{\hat{Q}}^{₂}^{\hat{Q}}^{₃} has been used, which is the same as the finite-squeezing version of the beamsplitter case in the circuit shown in FIG. 16A, up to a rotation on the output and the second input squeezed state, and a re-scaling of the initial squeezing. If the single mode squeezed states before the entangling beamsplitter have squeezing [symbol] , then the effective squeezing before the weighted Ĉ_{Z} gate can be [symbol] =ln p\sqrt{sech2 [symbol] ₀}. The weighting on the Ĉ_{Z} gate can be returned to one by noting that:

$${e}^{itanh 2 {τ}_{0} {\hat{Q}}_{2} {\hat{Q}}_{3}} = {\hat{S}}_{3}^{†} ( ln [ tanh 2 {τ}_{0} ] ) {e}^{i {\hat{Q}}_{2} {\hat{Q}}_{3}} {\hat{S}}_{3} ( ln [ tanh 2 {τ}_{0} ] ) . \qquad ( 53 )$$

based on Eq. 53, the circuit becomes the circuit shown in FIG. 17A may be changed to the circuit shown in FIG. 17B where [symbol] =ln (tan h 2 [symbol] ₀\sqrt{sech2 [symbol] ₀}). In some cases, a specific dictionary protocol may determine the effect of applying Ô as if it were applied to a canonical cluster. Such specific dictionary protocol may be derived starting from commuting the beamsplitter with the Ĉ_{Z} gate using the identity

$${\hat{B}}_{12} ( \frac{π}{4} ) {\hat{C}}_{{Z}_{23}} {\hat{B}}_{12}^{†} ( \frac{π}{4} ) = {e}^{\frac{i}{\sqrt{2}} ( {\hat{Q}}_{2} - {\hat{Q}}_{1} ) {\hat{Q}}_{3}} \qquad ( 54 )$$

which is just two weighted Ĉ_{Z} gates. This operator can act to the left on the measurement on mode two and the weight of the remaining Ĉ_{Z} can be fixed by rotating the operator in the Heisenberg picture with squeezing operators. This can be written as:

$${}_{2 Q} 〈 {m}_{2} \vert {e}^{\frac{i}{\sqrt{2}} ( {\hat{Q}}_{2} - {\hat{Q}}_{1} ) {\hat{Q}}_{3}} = {}_{2 Q} 〈 {m}_{2} \vert {\hat{Z}}_{3} ( \frac{{m}_{2}}{\sqrt{2}} ) {e}^{- \frac{i}{\sqrt{2}} {\hat{Q}}_{1} {\hat{Q}}_{3}} = {}_{2 Q} 〈 {m}_{2} \vert {\hat{Z}}_{3} ( \frac{{m}_{2}}{\sqrt{2}} ) {\hat{R}}_{3} ( π ) {\hat{S}}_{2} ( \frac{1}{2} ln 2 ) {\hat{C}}_{{Z}_{13}} {\hat{S}}_{3}^{†} ( \frac{1}{2} ln 2 ) {\hat{R}}_{3}^{†} ( π ) . \qquad ( 55 )$$

The rotations can both be pushed to the outer edges of the circuit, where a rotation of \hat{R}₃^{†}(i) to the right has no effect, and the rotation of \hat{R}₃^{†}(π) on the left changes the sign of the P-quadrature displacement and combines with the end rotation. This results in the circuit shown in FIG. 17C where the Gaussian operation Ĝ is:

$$\hat{G} = {\hat{R}}^{†} ( \frac{π}{2} ) {\hat{Z}}^{†} ( \frac{{m}_{2}}{\sqrt{2}} tanh 2 {τ}_{0} ) {\hat{S}}^{†} ( ln ( \frac{1}{\sqrt{2}} tanh 2 {τ}_{0} ) ) . \qquad ( 56 )$$

From the above circuit, it is easy to see that if we can reduce the beamsplitter and measurement on the second wire to a single Kraus operator acting on the top wire, then we have a macronode teleportation circuit with some additional operator acting on the input and a Gaussian operator G on the output. To do this, we need to find the operator for:

$${( {}_{2 Q} 〈 {m}_{2} \vert {\hat{B}}_{12} ( \frac{π}{4} ) {\hat{S}}_{2} ( τ ) \vert 0 〉 )}_{2 N} . \qquad ( 57 )$$

using Eq. 19, the fact that \hat{B}₁₂(θ)=\hat{B}₁₂^{†}(−θ)=\hat{B}₂₁, and the beamsplitter decomposition given in Ref. [58] of:

$${\hat{B}}_{j , k} ( \frac{π}{4} ) = {e}^{i {\hat{P}}_{j} {\hat{Q}}_{k}} {\hat{S}}_{j} ( \frac{1}{2} ln 2 ) {\hat{S}}_{k}^{†} ( \frac{1}{2} ln 2 ) {e}^{- i {\hat{Q}}_{j} {\hat{P}}_{k}} , \qquad ( 58 )$$

Eq. 57 can be rewritten as:

$${{π}^{1 / 4} \sqrt{\frac{2}{ε}} {\hat{X}}_{1}^{†} ( {m}_{2} ) {\hat{S}}_{1} ( \frac{1}{2} ln 2 ) \times ( {}_{2 Q} 〈 {m}_{2} \vert {\hat{S}}_{2}^{†} ( \frac{1}{2} ln 2 ) {e}^{- i {\hat{Q}}_{1} {\hat{P}}_{2}} {e}^{- {\hat{Q}}_{2}^{2} / 2 {s}^{2}} \vert 0 〉 )}_{2 P} , \qquad ( 59 )$$

where again s= [symbol] . The operators between the bra and ket in Eq. 59 can be commuted to have all operators in \hat{Q}₂ to the left and all operators in \hat{P}₂ to the right, which gives:

$${e}^{- {\hat{Q}}_{2}^{2} / {s}^{2}} {e}^{\sqrt{2} {\hat{Q}}_{1} {\hat{Q}}_{2} / {s}^{2}} {\hat{S}}_{2}^{†} ( \frac{1}{2} ln 2 ) {e}^{- {\hat{Q}}_{1}^{2} / {s}^{2}} {e}^{- i {\hat{Q}}_{1} {\hat{P}}_{2}} . \qquad ( 60 )$$

when acted on by the Q-basis bra and P-basis ket, along with noting that squeezing a quadrature eigenstate of zero has no effect, this reduces to an operator acting on wire one only; Eq. 57 becomes

$${π}^{1 / 4} \sqrt{\frac{2}{3}} {\hat{X}}_{1}^{†} ( {m}_{2} ) {\hat{S}}_{1} ( \frac{1}{2} ln 2 ) {e}^{- \frac{{( {\hat{Q}}_{1} - \sqrt{2} {m}_{2} )}^{2}}{2 {s}^{2}}} . \qquad ( 61 )$$

where the wavefunction of the input state used here from mode two is that of a squeezed vacuum state.

Taking Eq. 61 and using Eq. 19 on the third wire in the circuit to commute the effect of finite squeezing with the Ĉ_{Z} gate, we have that our circuit becomes the circuit shown in FIG. 17D. with s′= [symbol] . For high initial squeezing, this circuit reduces to the circuit shown in FIG. 17F. Thus, up to a Gaussian operation on the output, we can see that the result of applying any operator Ô before the first homodyne measurement in the macronode teleportation circuit is equivalent to applying Ô before the homodyne measurement in the canonical cluster-state teleportation, but first squeezing and displacing the input state. For finite squeezing, the input state also undergoes Q-quadrature damping. Suppose Ô is the operator for photon subtraction of n photons, Ŝₙ, given previously by Eq. 7. This is the process described earlier in terms of the canonical cluster, and when followed by homodyne detection, can be written as an operator in \hat{Q}. Using the equivalent circuit shown in FIG. 4B photon subtraction and homodyne detection becomes:

$${}_{P} 〈 m \vert {\hat{𝒮}}_{n} = {}_{P} 〈 0 \vert {f}_{n} ( \hat{Q} ) . \qquad ( 62 )$$

where ƒₙ(x) is the same function derived previously and is given by Eq. 117 in the DEE section. It is now clear that the macronode equivalent of the canonical case Kraus operator is just a slight modification of Eq. 21, and is given by:

$${\hat{K}}_{n}^{mac} = \sqrt{\frac{2 {π}^{1 / 2}}{s}} \hat{G} \hat{R} ( \frac{π}{2} ) {\hat{K}}_{n} {\hat{X}}_{1}^{†} ( {m}_{2} ) \hat{S} ( \frac{1}{2} ln 2 ) {e}^{- \frac{{( {\hat{Q}}_{1} - \sqrt{2} {m}_{2} )}^{2}}{2 {s}^{2}}} . \qquad ( 63 )$$

For large squeezing and weak subtraction beamsplitter reflectivity, we can use Eq. 23, and this becomes

$${\hat{K}}_{n}^{mac} ∝ \hat{R} ( \frac{π}{2} ) {\hat{S}}^{†} ( ln ( \frac{1}{\sqrt{2}} tanh 2 {τ}_{0} ) ) {\hat{Z}}^{†} ( \frac{{m}_{1}}{\sqrt{2}} ) {H}_{n} ( i \hat{Q} - \frac{{m}_{1} + {im}_{2}}{\sqrt{2}} ) . \qquad ( 64 )$$

Just as before, subtracting photons before the homodyne measurement will apply a polynomial in \hat{Q} to the teleported quantum information. Here, however, the measurement dependent shift has both real and imaginary components. Additionally, there is a residual squeezing term due to the use of beamsplitters as the entangling gates in the macronode implementation from circuit shown in FIG. 16A. Failing to subtract any photons will only act to damp the state slightly and teleport it further along the cluster state, just as in the canonical case.

An important point to note is that the subtraction must only be attempted on one wire of the macronode for the above derivation to hold. We have derived the results for applying the subtraction to the top wire before detection, but the derivation remains the same if the subtraction was instead performed on the middle wire, up to a rotation on the input. Because of this, there is no need to waste an intermediate step in applying an ‘empty’ teleportation to enact a Fourier transform and reorient the state, as simply alternating which wire the subtraction is performed on will effectively apply the necessary rotation and allow for operators of the same quadrature to build up through several repetitions of the modified teleportation gadget.

### Effects of m₂

We have shown how the PhANTM protocol can be translated from the canonical cluster state to a macronode implementation using the dictionary protocol, but we will leave an in-depth analysis on cat-state breeding and generation to future work. However, here we motivate the main differences created by the measurement-induced Q-quadrature shift by m₂. In the section titled “PhANTM” it was demonstrated that the overall effect of m₁ is to shift the phase between the components of the resulting cat state. Here, consider the case where m₁=0, so that the measurement results of m₂ can be dealt with separately. Instead of making a cat state that is a balanced superposition of coherent states as per Eq. 17,

$${H}_{n} ( i \hat{Q} - \frac{i {m}_{2}}{\sqrt{2}} )$$

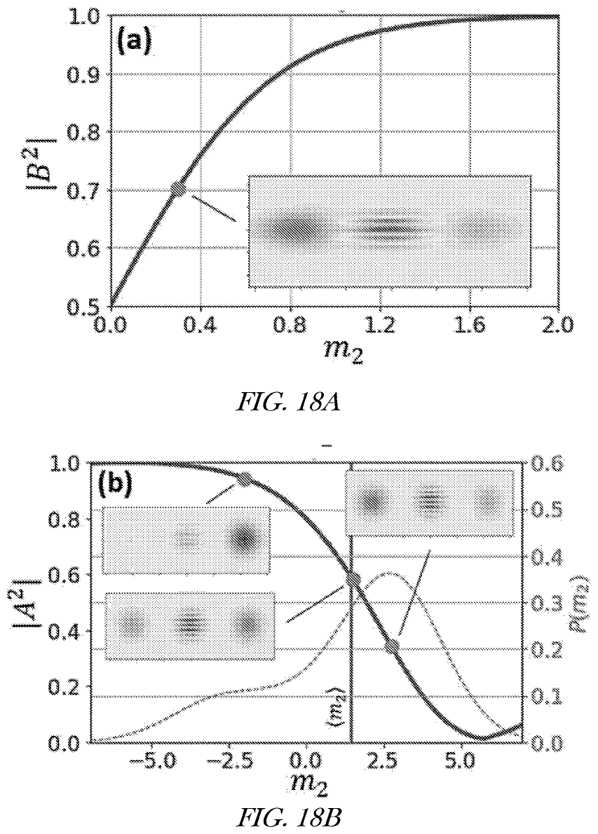

applied to squeezed vacuum will result in the weighted superposition:

$${{\vert cat 〉}_{A , B} ∝ ( A \hat{X} ( α ) \pm B {\hat{X}}^{†} ( α ) ) S ( τ ) \vert 0 〉}_{N} , \qquad ( 65 )$$

where A²+B²=1 are the coefficients weighting the different components in the superposition. When m2=0, we have the case illustrated previously in FIGS. 1A-1E and 2A-2E, which corresponds to weighting coefficients of A2=B2½. For nonzero m₂, the coefficients become unbalanced. This is shown in FIG. 18A for the case of applying H₄(i\sqrt{2}\hat{Q}−im₂) to vacuum squeezed by 6 dB. The fourth-order Hermite polynomial was chosen since Q⁴ and higher polynomials applied to squeezed vacuum become nearly indistinguishable from cat states in the idealized case, as illustrated by FIG. 3B. For each value of m₂, a weighted cat state of the form of Eq. 65 was selected and numerically optimized to fit the resultant state, and we plot the fitted value of B² against m₂. Each optimized weighted cat had fidelity greater than 0.99 with the resultant state, and it can be seen from the figure that the value of B monotonically increases as m₂ increases.

Once the state becomes unbalanced, one can ask what happens when it is sent into future rounds of the PhANTM algorithm. To explore this, we consider input states to the circuit in FIG. 17A that are small-weighted cat states of the form of Eq. 65 with coefficients A and B and calculate the probability P(m2) of performing a homodyne measurement in mode two and obtaining outcome m2. This is derived in section DEE-8 below and given by:

$$p ( {m}_{2} ) = C ( {A}^{2} {e}^{- \frac{{( α - \sqrt{2} {m}_{2} )}^{2}}{{s}_{1}^{2} + {s}_{2}^{2}}} + {B}^{2} {e}^{- \frac{{( α + \sqrt{2} {m}_{2} )}^{2}}{{s}_{1}^{2} + {s}_{2}^{2}}} + 2 {ABe}^{- \frac{{α}^{2}}{{s}_{1}^{2}} - \frac{2 {m}_{2}^{2}}{{s}_{1}^{2} + {s}_{2}^{2}}} ) , \qquad ( 66 )$$

where s₁=e^{r1} is the squeezing in the input weighted cat state, s₂=e^{r2} is the squeezing in each physical mode of the macronode cluster state, and the coefficient is:

$$C = {( \sqrt{\frac{π}{2}} \sqrt{{s}_{1}^{2} + {s}_{2}^{2}} ( 1 + {ABe}^{- \frac{{α}^{2}}{{s}_{1}^{2}}} ) )}^{- 1} . \qquad ( 67 )$$

This distribution is just two Gaussians originating from the input weighted cat state with broadening dependent on both the squeezing of the input state and the squeezing in the macronode cluster. The expectation value for a Q-basis homodyne measurement of mode two is given by:

$$\begin{matrix}〈 {\hat{Q}}_{2} 〉 = {\int }_{- ∞}^{∞} d {m}_{2} P ( {m}_{2} ) {m}_{2} \\ = \frac{α ( 2 {A}^{2} - 1 )}{\sqrt{2} ( 1 + {Abe}^{- {α}^{2} / {s}_{1}^{2}} )}\end{matrix} , \qquad ( 68 )$$

which for α>0, is positive when A²>½. This indicates that for an input cat state weighted more strongly toward the positive displacement (α>0, A>0), the measurement result m₂ is likely to be positive, and thus the current round of the PhANTM algorithm will tend to increase the value of B′, the coefficient of the future cat state, and re-balance the weighting in the coherent state superposition.

The re-balancing can be thought of as a ‘restoring force’ tending to prevent either coherent state term from dominating the other and is shown for a particular example in FIG. 18B, where an unbalanced cat state with amplitude α=4 and initial weighting coefficient A²=⅘ is sent through a macronode teleportation circuit with a single photon subtraction occurring. The measurement result m₂ is varied while m₁ is fixed to be zero to highlight the effects of changing m₂, and the output state is then numerically optimized to a fidelity above 0.99 with a weighted cat of the form of Eq. 65. The curve plots the new value of the weighting coefficient, A′², against the measurement result where the probability distribution is shown as a red-dashed curve with the expectation value given by the solid vertical line. The figure insets display the Wigner functions for the output state and demonstrate that as m₂ increases, the weighting shifts from favoring the positive displacement (A′>B′) to favoring the negative displacement (A′<B′). As shown by the figure, the value of A′ is likely to decrease from the initial value of A. If the weighting remains unbalanced after the teleportation, then the process can be repeated until the output state has displacement components with weightings that are within a predetermined acceptable range.

As shown by Eq. 68, the measurement result m₂ will be such that unbalancing is, on average, not exacerbated in the same direction; as such runaway effects may not occur in this process. In some cases, overshooting may occur, but a strongly weighted coefficient may not progressively become larger until one displacement remains in the superposition.

### Experimental Imperfections

In some of the embodiments discussed above, experimental imperfections other than Gaussian noise due to finite squeezing have been neglected. Examples of such imperfections may include, photon loss, detector inefficiency, excess antisqueezing, and displacement errors. The effect of loss on state preparation can be intolerable when leading to squeezing below the fault-tolerance threshold. In the next two sections (i.e., Effect of Detector Loss and Excess Noise Displacement Errors), it will be assumed that squeezing level is large enough to reach the fault-tolerance threshold so that the effects of excess noise and displacement errors on the disclosed protocols.

### Effect of Detector Loss and Excess Noise

Detectors with quantum efficiency η<1 can be modeled by placing a loss channel immediately prior to a detector with unit efficiency. Similarly, since loss to a squeezed state degrades the antisqueezing less than squeezing, one can model a cluster state with excess antisqueezing as subjecting each single mode squeezed vacuum to a loss channel before applying the entangling Ĉ_{Z} gates. Excess antisqueezing in cluster states has been previously shown not to impact the fault-tolerance threshold for a GKP encoding, but effects may be different for photon subtraction where photon-number resolving measurements are performed.

Because both antisqueezing and detector imperfections can be modeled as losses, we use a simplified noise model for this work where we examine the effects of a photon-loss channel placed at different locations in the PhANTM circuit. This accounts for many of the expected real-world limitations, but in some case more general imperfect measurements on bosonic encodings may be considered where loss and dephasing are both considered prior to detection.

A loss channel can be modeled as placing a beamsplitter in the path of the quantum signal and tracing over the reflected mode such that the beamsplitter transmission coefficient is related to the channel efficiency, η, by t²=η. Subjecting an initial quantum state ρ to loss leads to a mixture given by:

$${ρ}^{′} = {\sum }_{i = 0}^{∞} {\hat{L}}_{l} ρ {\hat{L}}_{l}^{†} , \qquad ( 69 )$$

where each \hat{L}ₗ is the Kraus operator for mode a traveling through a loss channel given by

$${\hat{L}}_{l} = \sqrt{\frac{{( 1 - η )}^{l}}{l ! {η}^{l}}} {\hat{a}}^{l} {e}^{\frac{1}{2} {\hat{a}}^{†} \hat{a} l n η} . \qquad ( 70 )$$

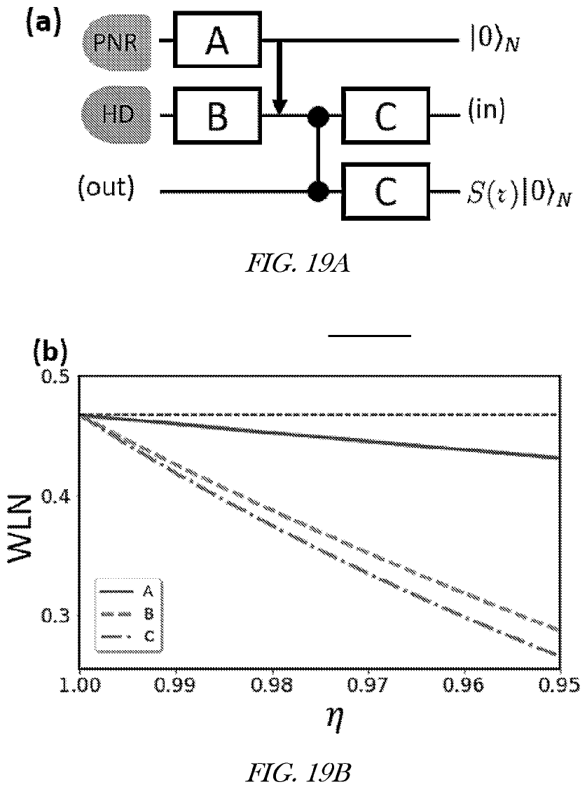

Here the imperfections are modeled by placing a loss channel at three locations of the PhANTM circuit as shown in FIG. 19A. FIG. 19A shows PhANTM step measurement where a loss channel of efficiency η is included before PNR detection (A), before homodyne detection (B), or immediately after squeezing before the Ĉ_{Z} gate is applied (C). Loss channels with efficiency η at locations A and B model the respective imperfect PNR and homodyne detections, while losses at C account for excess antisqueezing. Because one would experimentally measure a value for squeezing after losses, the simulations here considered a more strongly squeezed initial state such that the measured squeezing would be held constant as the losses are increased. For example, simulations in this section were performed with squeezed states with 11 dB noise reduction compared to vacuum in the squeezed quadrature whereas the stretched quadrature was antisqueezed by more than 11 dB depending on the given value of loss.

To measure the effects of loss, we employ the Wigner logarithmic negativity (WLN) to quantify the remaining quantum non-Gaussianity. This is defined as:

$$W L N ( ρ ) = log ( \int \int \vert {W}_{ρ} ( q , p ) \vert dq dp ) , \qquad ( 71 )$$

where the integral runs over all of phase-space. The WLN is useful as a metric to compare the relative quality of a class of states prepared with and without losses. Since we are not concerned with the particular state parameters within the family of cat states, such as the cat-state phase, for instance, WLN is more informative than fidelity for this particular application. Additionally, the WLN will decay to zero when nonclassical features vanish.

The WLN for a single round of PhANTM post-selected on a two-photon subtraction event and a homodyne detection of m=0 with loss at different locations is shown in FIG. 19B. FIG. 19B shows Wigner logarithmic negativity (WLN) for a single PhANTM step post-selected on an n=2 photon subtraction and an m=0 homodyne detection with 11 dB of squeezing in the cluster state where losses occur at either A, B, or C locations. The black dashed line indicates the WLN for the ideal (lossless) case.

As one would expect, the WLN decreases as losses increase. However, an interesting point to note is that the losses before PNR here are less detrimental, which can be attributed to the nature of photon subtraction. The reason for this becomes more evident on recalling the intuitive notion that for [symbol] \hat{N} [symbol] average photons in a quantum state, the losses must be no more than ˜ [symbol] \hat{N} [symbol] for quantum effects to persist and be useful, as has been proven for quantum estimation. The relatively weak beamsplitter used for photon subtraction substantially reduces the mean photon number measured by the PNR detector; thus, the threshold for tolerable losses will be higher.

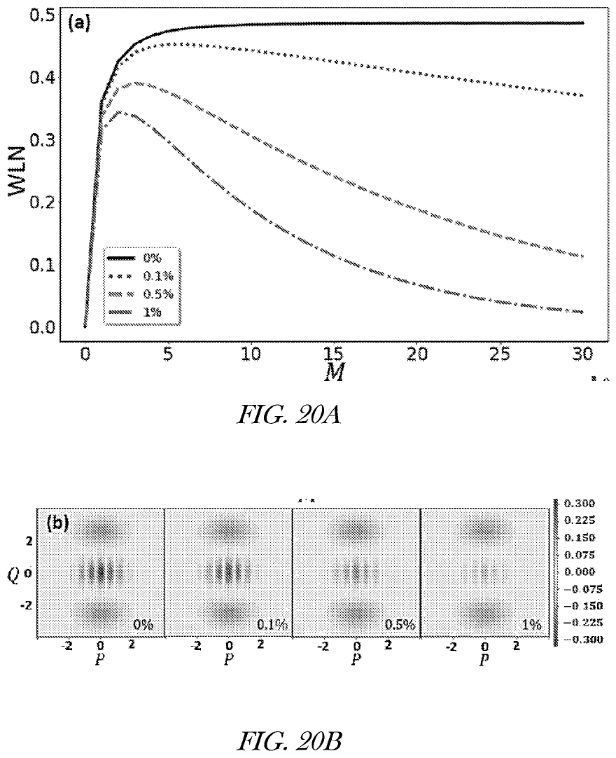

The utility of the PhANTM method is in its ability to be repeated on the cluster state to generate embedded cat states. Because of this, it is important to examine how losses compound and impact cat-state generation from one PhANTM step to another. This is shown in FIGS. 20A and 20B where the WLN of the resultant states are shown after M rounds of a PhANTM protocol that consists of photon-subtraction and teleportation followed by a single round of teleportation without subtraction as done previously in the section titled “Results” above. Here, however, equivalent losses ranging from 0.1% to 1% are included at all of the locations (A, B, and C) shown in FIG. 19A. This simulation assumes 11 dB of cluster state squeezing and post-selection of a single photon subtraction at each PhANTM step. Although the true photon subtractions would be stochastic, the mean number of photons subtracted at each step is [symbol] n [symbol] ˜1 (0.9 before the first subtraction, then 1< [symbol] n [symbol] <1.15 for remaining rounds), so assuming the mean is subtracted each time gives consistent results that are more comparable between different values of loss. Additionally, as stochastic homodyne measurements were shown previously to shift the cat state fringes, we also post-select on homodyne measurements of m=0 here to isolate the effects of loss.

FIG. 20A illustrates WLN of the embedded state after M PhANTM steps where losses occur after squeezed state preparation, before homodyne detection, and before PNR detection. Curves are shown for no loss and losses of 0.1%, 0.5%, and 1%, and the indicated loss occurs at all locations (A, B, and C in FIG. 10) at each PhANTM step, and at the same locations for the normal teleportation step to reorient the state before the next round of PhANTM. FIG. 20A shows that the WLN begins at zero for an initial squeezed vacuum cluster state node and then begins to increase as photon subtractions de-Gaussify the embedded state. However, the WLN peaks and then begins to slowly decay as losses in the system degrade the state over repeated teleportations. This indicates that while cat states can be preserved against pure Gaussian noise (as discussed above), the preservation does not extend to losses. Note that the zero-loss case is also shown for comparison, and the WLN stabilizes at the point where Gaussian noise from finite squeezing balances the added non-Gaussianity introduced from photon subtraction at each step.

While the losses reduce negativity, the location of the cat state interference fringes can still be discerned. This is shown in FIG. 20B, where the Wigner function for each output state after M=10 steps is plotted for the various loss levels. Provided that the losses are sufficiently low, a handful of PhANTM steps can still be performed to build up cat states embedded within the cluster state. When performed in parallel on several parts of the cluster state, this may still be sufficient to breed embedded GKP states, but an in-depth analysis of this type will be left to future work.

One may have noticed that the levels of loss considered in this section are quite low, but this is not beyond the reach of expected experimental progress. Current transition-edge sensors have achieved photon-number-resolving capabilities with quantum efficiencies of 98%, and efficiencies above 99% are possible. Additionally, linear photodiodes as used in homodyne detection have reached measured quantum efficiencies nearing 100% at telecommunications wavelengths.

### Displacement Errors

In addition to losses, one must undo accrued displacements which can lead to experimental errors. As with the measurement based CVQC model, in some cases, the shifts due to stochastic homodyne measurements may not need to be undone and may instead simply add an offset to future measurements results. However, a physical displacement here will be required before each PNR measurement as one cannot directly project on a displaced Fock-basis eigenstate. This feedforward displacement can be easily calculated by commuting previous homodyne results through the Ĉ_{Z} gate and subtraction beamsplitter, and then applied with an offline coherent state and beamsplitter with reflectivity r<<1.

Assume that the displacement operation has been imperfectly applied such that the results of the previous homodyne detections were undone up to some small residual Δα. In this case, instead of the PNR detection of n photons enacting a projection onto the Fock state |n [symbol] _{N}, it will instead project the state onto the displaced Fock state:

$${{{{\hat{D} ( Δα ) \vert n 〉}_{N} \approx \vert n 〉}_{N} + Δα \sqrt{n + 1} \vert n + 1 〉}_{N} - {Δα}^{*} \sqrt{n} \vert n - 1 〉}_{N} . \qquad ( 72 )$$

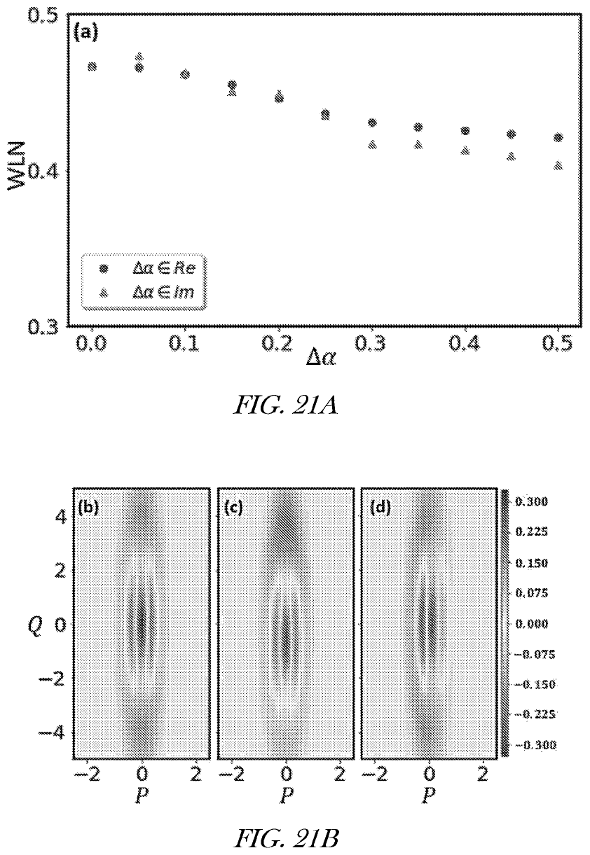

The results of the imperfect displacements are shown in FIG. 21A, where simulation results for Wigner logarithmic negativity (WLN) of the embedded state are separately plotted against the real and imaginary values of Δα. The simulation results for WLN are calculated after a single PhANTM step post-selected on a 2-photon subtraction (n=2) where there was a residual displacement error of Δα before PNR detection. The results are shown for, a homodyne detection result of m=0, and 11 dB squeezing in the cluster. In both the real and imaginary cases, the WLN only slightly decreases as |Δα| grows.

FIG. 21B shows the Wigner function of the embedded state with no error (panel b), for displacement error of Δα=0.2 (panel c) and for displacement error of Δα=0.2i. (panel d). The effects on the state can be more easily seen by examining the Wigner functions as shown in panels (b)-(d), where panel (b) shows the state with Δα=0. For nonzero Δα, the Wigner function becomes unbalanced depending on the phase of the displacement error. For purely real Δα as in panel (c), we see that the two coherent state like lobes of the cat become unbalanced giving us a weighted cat state as was the case in the section titled “Macronode extension” above. For purely imaginary Δα in panel (d), the interference fringes shift, which is the same as the effects of varying homodyne measurement outcomes. For both panels (c) and (d), we chose |Δα|=0.2.

It should be noted that the values for displacement error shown are considerably higher than what may be achieved with current experimental techniques. When undoing the homodyne detection result, the displacement will be aimed along the imaginary axis, so the errors of fringe shifts shown in FIG. 21B panel (d) will come about due to imprecise amplitude control of a displacing field. However, state-of-the-art on-chip Mach-Zehnder interferometers allow for precise manipulation of amplitude control with up to −60 dB extinction. Real displacement errors leading to the weighting of the cat such as shown in FIG. 21B panel (c) will thus originate from instabilities in the phase of the displacing field. As far as this is concerned, current experiments have achieved phase noise below 2 mrad leading to the conclusion that these errors can be virtually neglected.

### Generation and Amplification of Compass States in Cluster States

In some implementations, the PhANTM procedure may be used to generate compass states in a canonical cluster state. In some such embodiments, the compass state can be embedded in the canonical cluster state. In some cases, performing PhANTM on a node of the cluster state that is initially in a cat state, may teleport the cat state and transform the state of a neighboring node to compass states. In some cases, the symmetry of the resulting compass state may be determined by the state from which the initial cat state is been generated. For examples, if a second node comprises a cat state generated by performing a first PhANTM on a first node being in a vacuum state, performing a second PhANTM on the second, may transform the state of a third node (e.g., adjacent to the second node) to a compass state having a 90-degree rotational symmetry. As another example, if a second node comprises a cat state generated by performing a first PhANTM on a first node being in a squeezed state, performing a second PhANTM on the second node, may transform the state of a third node (e.g., adjacent to the second node) to a compass state having a rectangular symmetry. In some cases, the initial cat state from a compass state is generated using PhANTM, may have been generated by a process different than PhANTM.

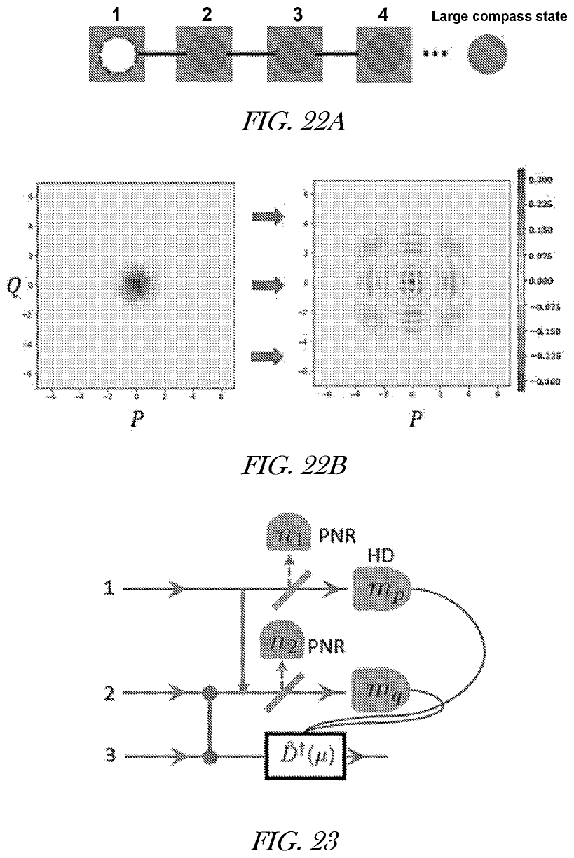

FIG. 22A schematically illustrates the process of transforming a portion of a one-dimensional (1D) cluster state to a compass state by consecutively performing PhANTM on the nodes of the one-dimensional (1D) cluster state.

In some cases, the process may begin by teleporting the state of a first node (the starting node) that is initially in vacuum state, to cat state of a second node (the node adjacent to the starting node) using a first PhANTM. In some cases, the initial state of the first node can be a squeezed state or a compass state. Next a second PhANTM may be performed on the second node to teleport the cat state of the second node to a compass state of the third node. In some cases, the second PhANTM may comprise performing a photon subtraction, e.g., by splitting the optical field associated with the cat state of the second node into a first portion and a second portion, performing a photon-number-resolving detection on the first portion, and performing a homodyne detection on the second portion to teleport the cat state to the third node and transform an initial state of the third node to a first displaced compass state. Finally, a feed-forward Gaussian operation may be performed on the third node to transform the first displaced compass state to a first compass state of the third node. In some cases, a third PhANTM may be performed on the third node to teleport the first compass state of the third node to a second compass state of the fourth node. In some cases, the amplitude of the second compass state can be larger than the amplitude of the first compass state. The process may be continued by performing a fourth PhANTM on the fourth node. In some examples, performing M consecutive PhANTM operation on M nodes starting from a first node may transform the state of the M+1 node to a large compass state.

FIG. 22B shows the Wigner function of the quantum state of the starting node and the Wigner function of the quantum state of the last node into which the result of a last PhANTM operations is teleported. In the example shown, the state of the starting node is a vacuum state, and the state of the last node is a compass state with 90-degree symmetry. In some cases, the compass state having the Wigner function shown in FIG. 22B can be generated after performing 10 PhANTM steps by subtracting a single photon from a measured state during each PhANTM. In some cases, the PhANTM step performed to generate the compass state, can be substantially identical steps.

In some implementations, the procedures described above for generating cat states in macronode cluster states may be modified to generate compass states in a macronode cluster state. In some cases, the modified teleportation process shown in FIG. 11A may be further modified to teleport the states of the modes in a first macronode of a macronode cluster state to a compass state, or a weighted compass state of a mode in a second macronode next to the first macronode. FIG. 23 shows an example process for teleporting the states of two nodes of a macronode in a macronode cluster state to a compass state of a third node of a neighboring macronode. The process shown in FIG. 23 may be similar to the process shown in FIG. 11A except that the photon substation and photon-number-resolving detection are also performed on the optical field associated with the second mode. The process may begin by performing a first photon subtraction by splitting light associated with the first mode of the macronode into a first portion and a second portion and splitting light associated with a second mode of the macronode into a third portion and a fourth portion, performing a photon-number-resolving detection on the first portion and third portion and performing a p-basis homodyne detection on the second portion and a q-basis homodyne detection on the fourth portion to teleport the states of the first macronode to the third mode of a neighboring macronode and transforming the state of the third mode to a displaced compass state or a displaced weighed compass state. Finally, a feed forward Gaussian operation may be performed on the third node to transform the displaced compass state or the displaced weighted compass state to a compass state of a weighted compass state.

In some cases, an initial state of the second mode can be in a squeezed state. In some cases, an initial state of the first mode can be a vacuum state, a squeezed state, a cat state, or an initial compass state. In some examples, when the initial state of the second mode is squeezed state and the initial state of the first mode is a vacuum state, the resulting displaced weighed compass state (or the displaced compass state) may have a 90-degree symmetry. In some examples, when the initial state of the second mode is squeezed state and the initial state of the first mode is a cat or a squeezed state, the resulting displaced weighed compass state (or the displaced compass state) may have rectangular symmetry.

In some implementations, the process shown in FIG. 23 may be used to enlarge an initial compass state. In some cases, when the initial state of the second mode is a squeezed state and the initial state of the first mode is an initial compass state, the resulting state of the third mode, can be an enlarged displaced weighted compass state. In some cases, a feed forward operation may be performed on the enlarged displaced weighted compass state to generate an enlarged weighted compass state.

In various examples, a weighted compass state may comprise a compass state having different amplitude along different axes of the symmetries of the compass state.

In some cases, an intermediate non-Gaussian state generated by or during any of the processes above may be a displaced state.

In various implementations, a feed-forward Gaussian operation may be performed on a mode by directing an optical field associated with the mode to a first port of an optical beam splitter, providing a coherent laser beam to a second port of the optical beam splitter; and controlling the amplitude and/or the phase of the coherent laser beam to displace the state of the second mode. In some cases, an electronic processor may control the amplitude and/or phase on the coherent laser beam using electro-optical, acousto-optical, and/or optomechanical modulators and controllers. In some cases, the beam splitter can be a highly transmissive beam splitter having negligible impact on the optical field that passes through the beam splitter via the first port. In some examples, a reflectivity of the beam splitter can be from 0.001 to 0.0001 or smaller.

In some cases, a feed-forward Gaussian operation on a first mode may comprise rotating a measurement basis of a subsequent homodyne measurement that may be performed on the first mode or a second mode of a node to which the first mode is teleported. In some cases, feed-forward Gaussian operation may comprise an identity gate.

In some cases, a value of a parameter of a feed-forward operation (e.g., amount of displacement, angle of a future homodyne measurement, or “by hand” classical shift/scaling of measurement result), can be an arbitrary function of previous measurement results.

In various implementations, the methods and processes described above may be performed by a quantum system comprising a cluster generation system configured to generate quantum cluster states (e.g., canonical CV cluster states), and a measurement system configure to perform measurements (e.g., Gaussian quantum operations) on the modes of the quantum cluster state.

In some cases, the cluster generation system may comprise various components for generation and control of optical fields and a first controller configured to control the operation of the cluster generation system by controlling the components of the cluster generation system. In some cases, the first controller may comprise a first non-transitory memory configured to store specific computer-executable instructions for generating, controlling and measuring optical fields and a first electronic processor in communication with the first non-transitory memory and configured to execute the specific computer-executable instructions.

In some cases, the measurement system may comprise various components for measuring and controlling the optical fields generated by the cluster generation system and a second controller configured to control the operation of the measurement system by controlling the components of the measurement system. In some cases, the second controller may comprise a second non-transitory memory configured to store specific computer-executable instructions for controlling and measuring optical fields and a second electronic processor in communication with the second non-transitory memory and configured to execute the specific computer-executable instructions.

In some examples, the cluster generation system may generate a plurality of modes forming a CV 1D canonical cluster state. In some case, the plurality of modes may comprise at least one pair of entangled modes comprising a first mode having a first initial state and a second mode having a second initial state. The first and the second initial states may be similar or different and may comprise squeezed states (e.g., finitely squeezed vacuum states), vacuum states, or other states. In some examples, the individual modes of the plurality of modes may comprise an optical field.

In some cases, the measurement system configured to control and perform measurement on optical fields of the individual modes of the plurality of modes of the cluster state generated by the cluster generation system. The second controller may be configured to select one or more modes of the cluster state and perform measurements (e.g., Gaussian quantum operations) on the selected mode according to instructions (e.g., algorithms) stored in the second non-transitory memory.

In some examples, the components of the measurement system may include but not being limited to beam splitters configured to split the optical fields, homodyne measurement devices configured to perform Gaussian operation (e.g., rotations), photon counters configured to measure optical field and determine a number of photons in the optical field.

In some implementation the quantum system may comprise a control system configured to the control at least the cluster generation system and the measurement system. In some cases, the first and second controllers of the cluster generation system and the measurement system may be included in the control system. In some cases, the control system may comprise a non-transitory memory configured to store specific computer-executable instructions and an electronic processor in communication with the non-transitory memory and configured to execute the specific computer-executable instructions.

### Review of Selected Disclosed Methods

PhANTM, a method for using PNR detection and feed-forward Gaussian operations to locally de-Gaussify a cluster state to systematically generate Schrödinger cat states, has been presented. Although each individual photon-subtraction event is probabilistic, teleporting quantum information along the cluster state and repeatedly applying steps of PhANTM leads to the production of cat states with high probability and mean amplitude dependent on the squeezing present in the cluster state. This process can be thought of as an adiabatic ‘cooling’ toward a cat-state basis, as additionally seen by the ability for PhANTM to preserve embedded cat states as they are teleported throughout the cluster, preventing the build-up of excess Gaussian noise. The phase of the teleported cat will be randomized by homodyne measurement, but this randomization can be tracked by recording the measurement results at each step and fixed by performing a feed-forward displacement to align the cat fringe. This therefore allows a cluster state with PNR measurement capabilities to be used as a way to perpetuate a particular class of non-Gaussianity (cat states), without the need for GKP error-correction.

Portions of 1-D quantum wires can each be converted into a cat state by repeatedly applying PhANTM to embed multiple cat states within a large cluster state, making this process compatible with state-of-the-art massively scalable 2D cluster states. Additionally, the photon-subtraction style measurement only requires low photon-number resolution, which is well within the current experimental capabilities of both TES systems and number-resolving silicon nanowire detectors. Note that semiconductor detector technology, e.g., avalanche photodiodes, can be used in multiplexed detection schemes to achieve PNR, though this requires large numbers of multiplexed detectors since the individual detectors aren't PNR.

When one considers additional experimental imperfections, such as loss and imperfect displacements, the non-Gaussianity as measured by the WLN will begin to decay after too many PhANTM steps as losses compound. However, we find that PNR detection efficiency is less important than homodyne detection efficiency and that for sufficiently low loss, the WLN decays slowly. Fortunately, progress is being made in low loss integrated photonic circuit platforms and in high quantum efficiency photodiodes. Furthermore, photon subtraction has been experimentally demonstrated on existing cluster states.

While error-correction and universal QC with cat states alone is possible, we show how breeding protocols are compatible with cat states embedded within the cluster state solely by performing Gaussian measurements and feedforward displacements locally on the cluster. This eliminates the need for offline resource-state generation as in current CV one-way error-corrected QC proposals and allows for cat-state enlargement and GKP state synthesis. Taken together with the PhANTM cat-state generation protocol, we have provided a means to take Gaussian cluster states and transform them into universal quantum-computational resources by performing local homodyne detections, PNR measurements, and feed-forward displacements.

### Derivation of Example Equations (DEE)

### DEE-1) The Damping Operator

The damping operator is a non-unitary operator that acts to symmetrically de-amplify quantum states and can be defined as:

$$\hat{N} ( β ) := {e}^{- β {\hat{a}}^{†} \hat{a}} = {e}^{- \frac{β}{2} ( {\hat{Q}}^{2} + {\hat{P}}^{2} - 1 )} . \qquad ( 73 )$$

When applied to a zero-quadrature eigenstate, the damping operator brings the unphysical state to a finitely squeezed vacuum state. This can be seen by applying \hat{N} to the state |0 [symbol] ₚ. Writing |0 [symbol] ₚ in the Fock-basis in the infinite squeezing limit, we have:

$${{\vert 0 〉}_{P} = {lim}_{r \to ∞} \frac{1}{\sqrt{cosh r}} {\sum }_{n = 0}^{∞} {( tanh r )}^{n} \frac{\sqrt{( 2 n ) !}}{{2}^{n} n !} \vert 2 n 〉}_{N} . \qquad ( 74 )$$

Applying the damping operator to the above state yields:

$${{\hat{N} ( β ) \vert 0 〉}_{P} = {lim}_{r \to ∞} \frac{1}{\sqrt{cosh r}} {\sum }_{n = 0}^{∞} {( {e}^{- 2 β} tanh r )}^{n} \frac{\sqrt{( 2 n ) !}}{{2}^{n} n !} \vert 2 n 〉}_{N} . \qquad ( 75 )$$

By replacing e^{-2β} tan h r with tan h r′, we have that:

$${{\hat{N} ( β ) \vert 0 〉}_{P} = {η}_{r} {\sum }_{n = 0}^{∞} {( {e}^{- 2 β} tanh {r}^{′} )}^{n} \frac{\sqrt{( 2 n ) !}}{{2}^{n} n !} \vert 2 n 〉}_{N} , \qquad ( 76 )$$

which is just a finitely squeezed state of squeezing parameter r′=tan h⁻¹[e^{-2β}] in the limit r→∞
with normalization given by:

$${η}_{r} = \sqrt{\frac{cosh r}{cosh {r}^{′}}} . \qquad ( 77 )$$

Using these results, we can also examine the effects of applying the damping operator to a nonzero quadrature eigenstate, in which case we have:

$$\hat{N} ( β ) \hat{a} \hat{N} ( - β ) = \hat{a} {e}^{β} \qquad ( 78 )$$

$$\hat{N} ( β ) {\hat{a}}^{†} \hat{N} ( - β ) = {\hat{a}}^{†} {e}^{- β}$$

since the inverse of \hat{N}(β) is \hat{N}(−β). Using commutation relations, we can derive that:

$${{\hat{N} ( β ) \vert m 〉}_{P} = \hat{N} ( β ) \hat{Z} ( m ) \hat{N} ( - β ) \hat{N} ( β ) \vert 0 〉}_{P} \qquad ( 79 )$$

$${= \hat{N} ( β ) \hat{Z} ( m ) \hat{N} ( - β ) \hat{S} ( {r}^{′} ) \vert 0 〉}_{N} , \qquad ( 80 )$$

which leads to:

$$\hat{N} ( β ) \hat{Q} \hat{N} ( - β ) = \hat{Q} cosh β + i \hat{P} sinh β . \qquad ( 81 )$$

The above equation is useful to determine the transformation of the momentum-shift operator to be:

$$\hat{N} ( β ) \hat{Z} ( m ) \hat{N} ( - β ) = {e}^{im ( \hat{Q} cosh β + i \hat{P} sinh β )} \qquad ( 82 )$$

$$= {e}^{\frac{{m}^{2}}{2} sinh β cosh β} {e}^{- ( \hat{P} sinh β )} \hat{Z} ( m cosh β ) . \qquad ( 83 )$$

Putting everything together, we now have that:

$${{\hat{N} ( β ) \vert m 〉}_{P} = {β}_{} {e}^{- m ( \hat{P} sinh β )} \hat{Z} ( m cosh β ) \hat{S} ( {r}^{′} ) \vert 0 〉}_{N} \qquad ( 84 )$$

$$where$$

$${β}_{} = {e}^{\frac{{m}^{2}}{2} sinh β cosh β} {η}_{r}^{- 1} . \qquad ( 85 )$$

### DEE-2) Photon Subtraction

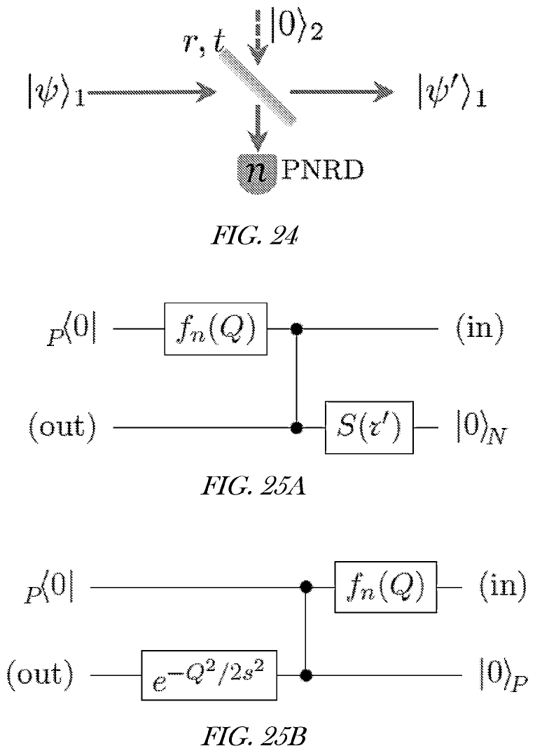

Direct application of the annihilation operator in the optical domain remains a challenge, but \hat{α}ⁿ can be applied probabilistically followed by damping of both quadratures. This is implemented by a beamsplitter and PNRD as shown in FIG. 24, where a small amount of one mode is coupled to vacuum and sent to the PNRD. Detecting n photons leads to the approximate application of \hat{α}ⁿ when beamsplitter reflectivity is low, but we will derive the Kraus operator representation of this system in general. For a beamsplitter operator given by:

$$\hat{B} = {e}^{θ ( {\hat{a}}_{1}^{†} {\hat{a}}_{2} - {\hat{a}}_{1} {\hat{a}}_{2}^{†} )} , \qquad ( 86 )$$

the annihilation and creation operators are transformed to:

$${\hat{B}}^{†} ( \begin{matrix}{\hat{a}}_{1} \\ {\hat{a}}_{2}\end{matrix} ) \hat{B} = ( \begin{matrix}t {\hat{a}}_{1} + r {\hat{a}}_{2} \\ t {\hat{a}}_{2} - r {\hat{a}}_{1}\end{matrix} ) , \qquad ( 87 )$$

where r=sin θ and t=cos θ. If we write |ψ [symbol] =Σₘψₘ|m [symbol] , then coupling |ψ [symbol] to vacuum with \hat{B} and detecting n photons in one output leads to the final state:

$$\begin{matrix}{{\vert {ψ}^{′} 〉 = {}_{2} 〈 n \vert {\sum }_{m = 0} \frac{{ψ}_{m}}{\sqrt{m !}} \hat{B} {\hat{a}}_{1}^{† m} \vert 0 〉}_{1} \vert 0 〉}_{2} \\ {{= {}_{2} 〈 n \vert {\sum }_{m = 0} \frac{{ψ}_{m}}{\sqrt{m !}} {\sum }_{k = 0}^{m} ( \begin{matrix}m \\ k\end{matrix} ) {( t {\hat{a}}_{1}^{†} )}^{m - k} {( - r {\hat{a}}_{2}^{†} )}^{k} \vert 0 〉}_{1} \vert 0 〉}_{2} \\ {= \frac{1}{\sqrt{n !}} {( \frac{- r}{t} )}^{n} {\sum }_{m = 0} {t}^{m} {ψ}_{m} {\hat{a}}_{1}^{n} \vert m 〉}_{1}\end{matrix} \qquad ( 88 )$$

Recognizing that t^{m}|m [symbol] can be rewritten as an exponentiated number operator acting on a Fock state, we can replace t^{m} with a damping operator having argument (−ln t) and arrive at:

$$\vert {ψ}^{′} 〉 = \frac{1}{\sqrt{n !}} {( \frac{- r}{t} )}^{n} {\hat{a}}^{n} \hat{N} ( β ) \vert ψ 〉 , \qquad ( 89 )$$

where β=−ln t. Using the commutation relation from Eq. 79 allows us to write the Kraus operator representing photon-subtraction for any beamsplitter reflectivity as:

$${\hat{𝒮}}_{n} = \frac{{( - 1 )}^{n} {e}^{- n β / 2}}{\sqrt{n !}} {( 2 sinh β )}^{n / 2} \hat{N} ( β ) {\hat{a}}^{n} . \qquad ( 90 )$$

The probability of successfully subtracting n photons from an input density matrix, ρ, is given by:

$$P ( n ) = Tr [ {\hat{𝒮}}_{n}^{†} {\hat{𝒮}}_{n} ρ ] , \qquad ( 91 )$$

and the new subtracted density matrix becomes:

$${ρ}^{′} = \frac{{\hat{𝒮}}_{n} ρ {\hat{𝒮}}_{n}^{†}}{P ( n )} . \qquad ( 92 )$$

### DEE-3) PhANTM Derivation

We fully derive the effects of photon subtraction proceeded by teleportation in the presence of finite squeezing. First, we derive the circuit identity given by the following Lemma 1:

$${}_{{}_{P} 〈 m \vert}^{{}_{N} 〈 n \vert} {{\vert 0 〉}_{N}}^{} = {}_{P} 〈 0 \vert , \qquad ( 93 )$$

where the arrow in the diagram represents a beamsplitter, \hat{B}_{θ}, with reflectivity r=sin θ and transmissivity t=cos θ. The lefthand side can be written as:

$${{}_{{N}_{1}} 〈 n \vert {}_{{P}_{2}} 〈 m \vert {\hat{B}}_{θ} \vert 0 〉}_{N} ⊗ \hat{𝟙} , \qquad ( 94 )$$

and in the Q-basis, the bras can be expressed as:

$${}_{N} 〈 n \vert = \int {du}_{Q} 〈 u \vert {ψ}_{n} ( u ) \qquad ( 95 )$$

$${}_{P} 〈 m \vert = \frac{1}{\sqrt{2 π}} \int {dv}_{Q} 〈 v \vert {e}^{- imv} , \qquad ( 96 )$$

where ψₙ(x) is the wavefunction of the harmonic oscillator:

$${ψ}_{n} ( x ) = \frac{1}{{π}^{1 / 4} \sqrt{{2}^{n} n !}} {e}^{- {x}^{2} / 2} {H}_{n} ( x ) \qquad ( 97 )$$

Using the above expressions, and temporarily neglecting the (2π)−½ factor, Eq. 78 becomes:

$${\int dudv {}_{{Q}_{1}} 〈 n \vert {}_{{Q}_{2}} 〈 v \vert {ψ}_{n} ( u ) {e}^{- imv} {\hat{B}}_{θ} \vert 0 〉}_{{N}_{1}} \qquad ( 98 )$$

$${= \int dudv {}_{{Q}_{1}} 〈 0 \vert {}_{{Q}_{2}} 〈 0 \vert {\hat{B}}_{θ} {\hat{B}}_{θ}^{†} {e}^{iu {\hat{P}}_{1} + iv {\hat{P}}_{2}} {ψ}_{n} ( u ) {e}^{- imv} {\hat{B}}_{θ} \vert 0 〉}_{{N}_{1}} \qquad ( 99 )$$

$${= \int {dudv}_{{Q}_{1}} 〈 0 \vert {}_{{Q}_{2}} 〈 0 \vert {e}^{iu ( t {\hat{P}}_{1} - r {\hat{P}}_{2} ) + iv ( t {\hat{P}}_{2} + r {\hat{P}}_{1} )} {ψ}_{n} ( u ) {e}^{- imv} \vert 0 〉}_{{N}_{1}} \qquad ( 100 )$$

where in the last line we have used the tact that a beamsplitter applied to a pair of q=0 states has no effect. Expressing the vacuum state in the Q-basis as well yields:

$${\int dudvdz {}_{{Q}_{1}} 〈 tu + rv \vert z 〉}_{{Q}_{1}} {}_{{Q}_{2}} 〈 tv - ru \vert {ψ}_{n} ( u ) {ψ}_{0} ( z ) {e}^{- imv} \qquad ( 101 )$$

$$= \int dudv {}_{{Q}_{2}} 〈 tv - ru \vert {ψ}_{n} ( u ) {ψ}_{0} ( tu + rv ) {e}^{- imv} \qquad ( 102 )$$

$$= \frac{1}{\sqrt{2 π}} \int dx {}_{Q} 〈 x \vert {f}_{n} ( x ) \qquad ( 103 )$$

$$= {}_{P} 〈 0 \vert {f}_{n} ( \hat{Q} ) \qquad ( 104 )$$

where we reintroduced the missing prefactor in the final two lines. With a change of the integration variables to x=tv−ru, y=tu+rv, one can see that:

$${f}_{n} ( x ) = \int dy {ψ}_{n} ( ty - rx ) {ψ}_{0} ( y ) {e}^{- im ( tx + ry )} . \qquad ( 105 )$$

Changing variables again, this can be rewritten as:

$$\begin{matrix}{f}_{n} ( x ) = \frac{1}{t} \int dy {ψ}_{n} ( y ) {ψ}_{0} ( \frac{y + rx}{t} ) {e}^{- \frac{im}{t} ( ry + x )} \\ = \frac{{e}^{- i / 2}}{t} {e}^{- i ζ x} \int dy {}_{N} {〈 n \vert y 〉}_{Q} {}_{Q} {〈 y \vert \hat{D} ( α ) \hat{S} ( z ) \vert 0 〉}_{N} \\ = \frac{{e}^{- i / 2}}{t} {e}^{- i ζ x} 〈 n \vert \hat{D} ( α ) \hat{S} ( z ) \vert 0 〉\end{matrix} \qquad ( 106 )$$

where here,

$$α = - {2}^{- 1 / 2} ( rx + i \frac{r}{t} m ) ,$$

r=ln t, and

$$ζ = \frac{m}{t} ( 1 + \frac{1}{2} {t}^{2} ) .$$

At this point, it becomes necessary to derive an identity for the overlap coefficients of the Fock states with displaced, squeezed vacuum. This overlap can be written as

$$〈 n \vert \hat{D} ( α ) \hat{S} ( z ) \vert 0 〉 = {e}^{- \frac{i}{2} γβ} 〈 n \vert \hat{Z} ( γ ) \hat{X} ( β ) \hat{S} ( z ) \vert 0 〉 , \qquad ( 107 )$$

where γ=\sqrt{2}IM[α] and β=\sqrt{2}Re[a]. Transforming to the Q-basis, we have

$$\begin{matrix}{e}^{- \frac{i}{2} γβ} \int dsdt {ψ}_{n} ( s ) {{ψ}_{0} ( t )}_{Q} {〈 s \vert \hat{Z} ( γ ) \hat{X} ( β ) \hat{S} ( z ) \vert t 〉}_{Q} = {e}^{\frac{t}{2} - \frac{i}{2} γβ} \int dsdt {ψ}_{n} ( s ) \\ {ψ}_{0} ( t ) {e}^{is γ} δ ( s - β - {te}^{- t} ) \\ = \frac{{e}^{\frac{t}{2} - \frac{i}{2} γβ}}{\sqrt{{2}^{n} n ! π}} \int {dse}^{- {s}^{2} / 2} \\ {H}_{n} ( s ) {e}^{- {( s - β )}^{2} {e}^{2 x} / 2} {e}^{is γ} \\ = \frac{{e}^{\frac{t}{2} - i γ ( β / 2 - B ) + C}}{A \sqrt{{2}^{n} n ! π}} \\ \int {dse}^{- {s}^{2} / 2} {H}_{n} ( \frac{s}{A} + B ) \\ {e}^{i \frac{s}{A} γ}\end{matrix} , \qquad ( 108 )$$

where we have defined:

$$A = \sqrt{1 + {e}^{2 x}} \qquad ( 109 )$$

$$B = \frac{β {e}^{2 t}}{1 + {e}^{2 x}} \qquad ( 110 )$$

$$C = \frac{{β}^{2} {e}^{4 x}}{2 ( 1 + {e}^{2 x} )} - \frac{1}{2} {β}^{2} {e}^{2 x} . \qquad ( 111 )$$

We can now make use of the pair of Hermite polynomial identities

$${H}_{n} ( x + y ) = {2}^{- \frac{n}{2}} {\sum }_{k = 0}^{n} ( \begin{matrix}n \\ k\end{matrix} ) {H}_{n - k} ( x \sqrt{2} ) {H}_{k} ( y \sqrt{2} ) \qquad ( 112 )$$

$${H}_{n} ( γ x ) = {\sum }_{i = 0}^{⌊ \frac{n}{2} ⌋} {{γ}^{n - 2 i} ( {γ}^{2} - 1 )}^{i} ( \begin{matrix}n \\ 2 i\end{matrix} ) \frac{( 2 i ) !}{i !} {H}_{n - 2 i} ( x ) , \qquad ( 113 )$$

along with the property that Hermite polynomials are eigenfunctions of the Fourier transform, i.e.,

$${\int }_{- ∞}^{∞} {dxe}^{ikx} {e}^{- {x}^{2} / 2} {H}_{n} ( x ) = \sqrt{2 π} {( i )}^{n} {e}^{- \frac{1}{2} {k}^{2}} {H}_{n} ( k ) , \qquad ( 114 )$$

to take Eq. 108 and arrive at the result of:

$$κ {\sum }_{k = 0}^{n} {\sum }_{j = 0}^{⌊ \frac{n - k}{2} ⌋} {χ}_{j , k} {H}_{k} ( \sqrt{2} B ) {H}_{n - k - 2 j} ( \frac{γ}{A} ) \qquad ( 115 )$$

$$where$$

$$κ = \frac{{i}^{n} {e}^{\frac{t}{2} - i γ ( β / 2 - B ) + C}}{{A}^{n + 1} \sqrt{{2}^{n - 1} n !}} {e}^{- \frac{{γ}^{2}}{2 {A}^{2}}} \qquad ( 116 )$$

$${χ}_{j , k} = ( \begin{matrix}n \\ k\end{matrix} ) ( \begin{matrix}n - k \\ 2 j\end{matrix} ) \frac{( 2 j ! ) {A}^{2 j + k}}{j ! \sqrt{- {2}^{2 j + k}}} {( \frac{2}{{A}^{2}} - 1 )}^{j} . \qquad ( 117 )$$

We can now put everything back together and see that ƒₙ(x) is a polynomial of degree n with an exponential envelope. Using Eq. 106 along with the derived overlap in Eq. 114 and the intermediary definition of Eqs. 109 to 111, 116 and 117 lead to:

$${f}_{n} ( x ) = {e}^{- imx ( \frac{2 t}{1 + {t}^{2}} )} {e}^{- {x}^{2} \frac{{t}^{2} {r}^{2}}{2 + 2 {t}^{2}}} {f}_{n}^{′} ( x ) , \qquad ( 118 )$$

Where ƒₙ′(x) is the polynomial given by:

$${f}_{n}^{′} ( x ) = \frac{{i}^{n}}{\sqrt{{2}^{n - 1} n ! {( 1 + {t}^{2} )}^{n + 1}}} {\sum }_{k = 0}^{n} {\sum }_{j = 0}^{⌊ \frac{n - k}{2} ⌋} ( \begin{matrix}n \\ k\end{matrix} ) ( \begin{matrix}n - k \\ 2 j\end{matrix} ) \qquad ( 119 )$$

$$\frac{( 2 j ) ! {r}^{2 j}}{{2}^{j} j !} {( \frac{1 + {t}^{2}}{2} )}^{k / 2} {( - i )}^{k + 2 j} {H}_{k} ( \frac{- x \sqrt{2} {rt}^{2}}{1 + {t}^{2}} ) {H}_{n - k - 2 j} ( \frac{- mr}{t \sqrt{1 + {t}^{2}}} )$$

Subtraction-assisted teleportation can thus be recognized as a circuit of the form shown in FIG. 25A where ƒ is the resulting function from Eq. 118. The operator in the top wire is a function of \hat{Q} only so commutes with the Ĉ_{Z}, and we can make use of the fact that we can write the input momentum-squeezed state as:

$$\begin{matrix}{{\hat{S} ( {z}^{′} ) \vert 0 〉}_{N} = {π}^{- 1 / 4} \int {dte}^{- {t}^{2} / 2 {s}^{2}} \vert t 〉}_{Q} \\ {= {π}^{- 1 / 4} {e}^{- {\hat{Q}}^{2} / 2 {s}^{2}} \int dt \vert t 〉}_{Q} \\ {= {π}^{1 / 4} \sqrt{\frac{2}{s}} {e}^{- {\hat{Q}}^{2} / 2 {s}^{2}} \vert 0 〉}_{P}\end{matrix} , \qquad ( 120 )$$

where s=e^{r′}. In this form, the exponentiated function of \hat{Q} commutes through the C_{Z} gate to give the circuit shown in FIG. 25B which is easily recognizable as the teleportation circuit with additional operators applied both before and after the teleportation. The overall Kraus operator representation of the action of the circuit acting on the input is given by:

$$\hat{K} = {π}^{1 / 4} \sqrt{\frac{2}{s}} {e}^{- {\hat{Q}}^{2} / 2 {e}^{2}} \hat{R} ( \frac{π}{2} ) {f}_{n} ( \hat{Q} ) . \qquad ( 121 )$$

However, if we note that there is a Q-quadrature shift within ƒₙ(\hat{Q}) that we may wish to undo with feed-forward operations, we can commute this to the back of the Kraus operator. This leads to an alternate form of:

$$\hat{K} = \frac{{π}^{1 / 4} \sqrt{2}}{\sqrt{s}} {e}^{\frac{{m}^{2}}{{s}^{2}} {σ}^{2}} \hat{X} ( m σ ) \hat{R} ( \frac{π}{2} ) \times {e}^{- \frac{1}{2 {s}^{2}} {( \hat{P} - m σ )}^{2}} {e}^{- {\hat{Q}}^{2} \frac{σ t ( 1 - {t}^{2} )}{4}} {f}_{n}^{′} ( \hat{Q} ) , \qquad ( 122 )$$

where we define

$$σ = \frac{2 t}{1 + {t}^{2}} .$$

For weak beamsplitter reflectivity, we have that t→1 and σ→1, and in this limit, we can recover the form of the idealized case discussed in the main text. Taking the large squeezing limit s→∞ and weak beamsplitter reflectivity r→0, we have to leading order in r that,

$${f}_{n}^{′} ( \hat{Q} ) \to {\sum }_{j = 0}^{⌊ \frac{π}{2} ⌋} \frac{\sqrt{n !} {2}^{- j} {r}^{2 j}}{{2}^{n} j ! ( n - 2 j ) !} \times {\sum }_{k = 0}^{n - 2 j} ( \begin{matrix}n - 2 j \\ k\end{matrix} ) {H}_{k ( \frac{- Qr}{\sqrt{2}} ) {i}^{n - k - 2 j}} {H}_{n - k - 2 j ( \frac{- mr}{\sqrt{2}} ) .} \qquad ( 123 )$$

Defining the generalized probabilist's Hermite polynomial Hₑ_{ₙ}^{[α]}(x) as

$${H}_{{e}_{n}}^{[ α ]} ( x ) = {α}^{\frac{π}{2}} {H}_{{e}_{n}} ( \frac{x}{\sqrt{α}} ) = {( \frac{α}{2} )}^{\frac{π}{2}} {H}_{n} ( \frac{x}{\sqrt{2 α}} ) \qquad ( 124 )$$

and making using of the identity

$${H}_{{e}_{n}}^{[ α + β ]} ( x + y ) = {\sum }_{k = 0}^{n} ( \begin{matrix}n \\ k\end{matrix} ) {H}_{{e}_{n}}^{[ α ]} ( x ) {H}_{{e}_{n - k}}^{[ β ]} ( y ) , \qquad ( 125 )$$

along with the special case of

$${H}_{{e}_{n}}^{[ 0 ]} ( x ) = {( x )}^{n} \qquad ( 126 )$$

allows us to simplify Eq. 123 to:

$${f}_{n}^{′} ( \hat{Q} ) \to \frac{{r}^{n} \sqrt{n !}}{{2}^{n} \sqrt{{2}^{n}}} {\sum }_{j = 0}^{⌊ \frac{π}{2} ⌋} \frac{{( \sqrt{2} ( Q + im ) )}^{n - 2 j}}{j ! ( n - 2 j ) !} . \qquad ( 127 )$$

We can now simplify the above expression by using the expansion of the Hermite polynomial given by:

$${H}_{n} ( x ) = n ! {\sum }_{m = 0}^{⌊ \frac{π}{2} ⌋} \frac{{( - 1 )}^{m}}{m ! ( n - 2 m ) !} {( 2 x )}^{n - 2 m} , \qquad ( 128 )$$

which leads to the limiting case Kraus operator of

$$\hat{K} ∝ \hat{X} ( m ) {\hat{R}}_{( \frac{π}{2} )} {H}_{n} ( \frac{i \hat{Q} - m}{\sqrt{2}} ) . \qquad ( 129 )$$

### DEE-4) Hermite Polynomial

A proof of the relation below is provided in this section.

$${H}_{{e}_{n}} ( Q ) = {\sum }_{k = 0}^{n} ( \begin{matrix}n \\ k\end{matrix} ) {( - iP )}^{k} {( Q + iP )}^{n - k} . \qquad ( 130 )$$

This is easily verified to be true for the first few terms, so we proceed by induction. Assuming Eq. 130 is true for n, we can make use of the relation

$$( \begin{matrix}n + 1 \\ k\end{matrix} ) = ( \begin{matrix}n \\ k\end{matrix} ) + ( \begin{matrix}n \\ k - 1\end{matrix} )$$

to prove the validity for n+1 as follows:

$${\sum }_{k = 0}^{n + 1} ( \begin{matrix}n + 1 \\ k\end{matrix} ) {( - iP )}^{k} {( Q + iP )}^{n + 1 - k} = \qquad ( 131 )$$

$${\sum }_{k = 0}^{n} ( \begin{matrix}n \\ k\end{matrix} ) {( - iP )}^{k} {( Q + iP )}^{n - k} ( Q + iP ) + {\sum }_{k = 1}^{n} ( \begin{matrix}n \\ k - 1\end{matrix} ) {( - iP )}^{k} {( Q + iP )}^{n + 1 - k} + {( - iP )}^{n + 1} \qquad ( 132 )$$

$$= {H}_{{e}_{n}} ( Q ) ( Q + iP ) + {\sum }_{k = 0}^{n - 1} ( \begin{matrix}n \\ k\end{matrix} ) {( - iP )}^{k + 1} {( Q + iP )}^{n - k} + {( - iP )}^{n + 1} \qquad ( 133 )$$

$$= {H}_{{e}_{n}} ( q ) ( Q + iP ) + ( - iP ) ( {\sum }_{k = 0}^{n} ( \begin{matrix}n \\ k\end{matrix} ) {( - iP )}^{k} ( {( Q + iP )}^{n - k} ) \qquad ( 134 )$$

$$= {H}_{{e}_{n}} ( Q ) ( Q + iP ) + ( - iP ) {H}_{{e}_{n}} ( Q ) = {QH}_{{e}_{n}} ( Q ) + {\underbrace{\text{?} - {iP}_{i} {H}_{{e}_{n}} ( Q ) \text{?}}}_{- \text{?}} \qquad ( 135 )$$

$$= Q {H}_{{e}_{n}} ( Q ) - \frac{d {H}_{{e}_{n}} ( Q )}{dQ} ≡ {H}_{{e}_{n + s}} ( Q ) \qquad ( 136 )$$

$$\text{?} \text{indicates text missing or illegible when filed}$$

### DEE-5) Example Evolution

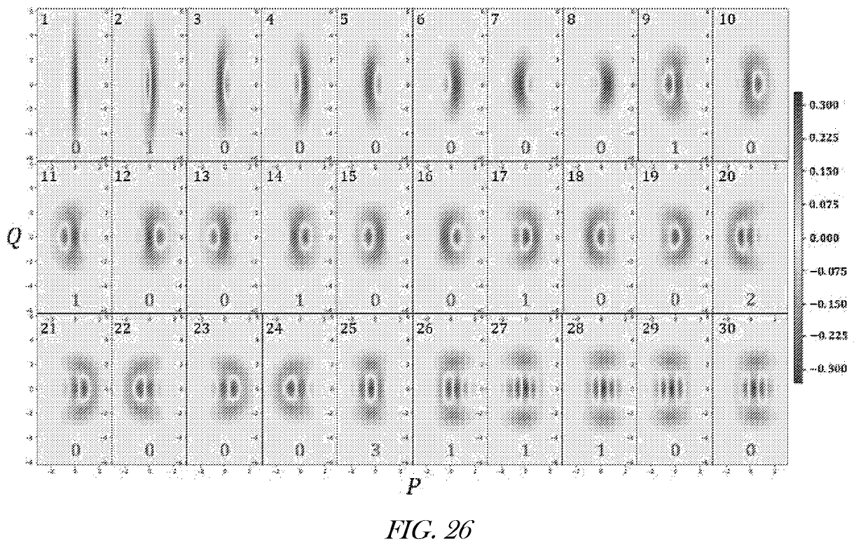

FIG. 26 shows the full progression of the PhANTM algorithm as quantum information is teleported along the canonical cluster state with photon subtraction attempted before homodyne measurements on every-other teleportation. Results are obtained from iterated PhANTM where measurement results are stochastic. Each Wigner function plotted shows what state is now Ĉ_{Z}′ed to the cluster after the M-th step (black numbering) where the number of subtraction photons from the corresponding step is shown in red. Steps without attempting photon subtraction are used for teleporting the state and applying a π/2 rotation to reorient the state. The Wigner function for the state at each step where subtraction was attempted is shown, with the number of actual photons subtracted listed in red. Each teleportation takes into account finite squeezing of 15 dB in the cluster state, randomly sampled homodyne and subtraction measurement outcomes, and a subtraction beamsplitter with reflectively chosen to have the same order damping effect as finite squeezing.

### DEE-6) Breeding on the Cluster State

Here we provide the analogous derivation for cluster states. Suppose we have a superposition of evenly spaced Gaussian peaks, which can generally be described by a product of cat-like operators acting on squeezed vacuum as:

$$\vert {Ψ}_{α , φ , r} 〉 ∝ ( α , φ ) \hat{S} ( r ) \vert 0 〉 . \qquad ( 137 )$$

where we define

$$( α , φ ) := {\prod }_{k} ( \hat{Z} ( α ) + {e}^{i {φ}_{k}} {\hat{Z}}^{†} ( α ) ) . \qquad ( 138 )$$

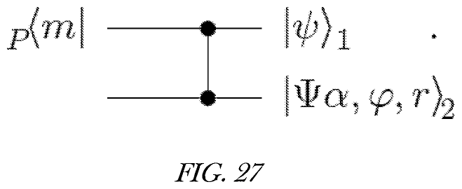

If one teleports through this state as opposed to the normal momentum squeezed state, then the circuit will appear as the circuit shown in FIG. 27. Writing the squeezed vacuum of mode two as an operator in \hat{Q} applied to a momentum eigenstate as in Eq. 19 and commuting all remaining operators on mode two through the Ĉ_{Z} reveals that the effect of this circuit is to apply the operator

$$= ( α , φ ) {e}^{- {\hat{Q}}^{2} / 2 {s}^{2}} {\hat{R}}_{( \frac{π}{2} )} {\hat{Z}}^{†} ( m ) , \qquad ( 139 )$$

where s=e^{r}. Suppose the input to this circuit was of the same form as Eq. 137, but first having undergone a Fourier transform. The transformed state would then be

$$\begin{matrix}\vert ϕ 〉 ∝ {\hat{R}}_{( \frac{π}{2} )} \vert {Ψ}_{{α}^{′} , {φ}^{′} , {r}^{′}} 〉 \\ ∝ ( α , φ ) {e}^{- {\hat{Q}}^{2} / 2 {s}^{2}} \hat{X} ( m ) \hat{R} ( π ) ( α , {φ}^{′} ) \hat{S} ( {r}^{′} ) \vert 0 〉 .\end{matrix} \qquad ( 140 )$$

Making use of the relations that

$$\hat{Z} ( {α}_{k} ) \hat{X} ( {α}_{j} ) = {e}^{i {α}_{k} {α}_{j}} \hat{X} ( {α}_{j} ) \hat{Z} ( {α}_{k} ) , \qquad ( 141 )$$

$${e}^{- {\hat{Q}}^{2} / 2 {s}^{2}} \hat{X} ( m ) = {e}^{{m}^{2} / 2 {s}^{2}} \hat{X} ( m ) {e}^{- \frac{1}{{s}^{2}} ( m \hat{Q} + {\hat{Q}}^{2} )} , \qquad ( 142 )$$

we can write the evolved state as

$$\vert ϕ 〉 ∝ \hat{X} ( m ) ( α , φ - 2 m α ) ( - α , {φ}^{′} ) {e}^{- \frac{1}{{s}^{2}} ( m \hat{Q} + {\hat{Q}}^{2} )} \hat{S} ( {r}^{′} ) \vert 0 〉 , \qquad ( 143 )$$

where φ−2mα indicates that each phase in the expanded product has been shifted by the measurement result and the value of α to be φₖ→φₖ−2mα. With the help of Eq. 19, the exponentiated quadratic in \hat{Q} applied to squeezed vacuum can be rewritten as

$$\begin{matrix}{{e}^{- \frac{1}{{s}^{2}} ( m \hat{Q} + {\hat{Q}}^{2} )} \hat{S} ( {r}^{′} ) \vert 0 〉 = {e}^{- \frac{1}{{s}^{2}} ( m \hat{Q} + {\hat{Q}}^{2} ) - \frac{1}{{s}^{′2}} {\hat{Q}}^{2}} \vert 0 〉}_{P} \\ {= \hat{X} ( B ) {e}^{- A {\hat{Q}}^{2}} {\hat{X}}^{†} ( B ) \vert 0 〉}_{P} \\ {= \hat{X} ( B ) {e}^{- A {\hat{Q}}^{2}} \vert 0 〉}_{P}\end{matrix} \qquad ( 144 )$$

$$where {s}^{′} = {e}^{{r}^{′}} and$$

$$A = \frac{1}{2} ( \frac{1}{{s}^{2}} + \frac{1}{{s}^{′ 2}} ) \qquad ( 145 )$$

$$B = \frac{m {s}^{2} {s}^{′}}{{s}^{2} + {s}^{′ 2}} . \qquad ( 146 )$$

Commuting the obtained position-quadrature shift to the left and converting the exponentiated \hat{Q}² back to a squeezer applied to vacuum, we have:

$$\vert ϕ 〉 ∝ \hat{X} ( m + B ) ( α , φ - 2 ( m + B ) α ) \times ( - α , {φ}^{′} + 2 B α ) \hat{S} ( {r}^{″} ) \vert 0 〉 ∝ \hat{X} ( m + B ) ( α , {φ}^{″} ) \hat{S} ( {r}^{″} ) \vert ϕ 〉 , \qquad ( 147 )$$

which is a state of the form of Eq. 137 with an additional displacement and modified squeezing

$${r}^{″} = r + {r}^{′} - \frac{1}{2} ln ( {e}^{2 r} + {e}^{2 {r}^{′}} ) \qquad ( 148 )$$

### DEE-7) Beamsplitter to C_{Z} Breeding

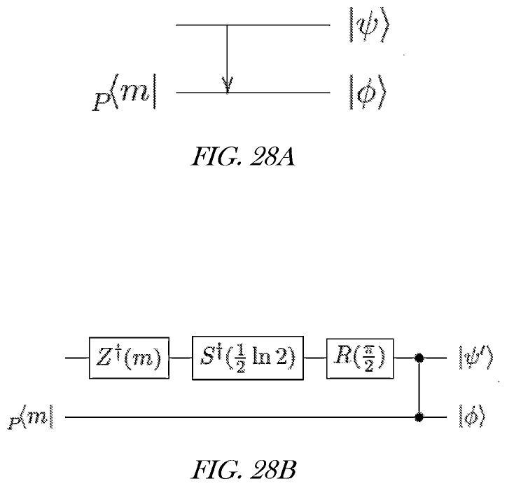

Several other works have discussed breeding cat states for enlargement or to make grid states in the context of beamsplitters followed by a homodyne measurement. Here, we show how this is translated to the canonical cluster state measurements through the use of the beamsplitter unitary decomposition. Breeding cat states is achieved by using the circuit shown in FIG. 28A where |ψ [symbol] and |ϕ [symbol] and the input cat states used for breeding. Up to an overall phase, the balanced beamsplitter can be decomposed as:

$${\hat{B}}_{12} = {e}^{- i {\hat{Q}}_{1} {\hat{P}}_{2}} ( {\hat{S}}_{1}^{†} ( \frac{1}{2} ln 2 ) {\hat{S}}_{2} ( \frac{1}{2} ln 2 ) ) {e}^{- i {\hat{P}}_{1} {\hat{Q}}_{2}} . \qquad ( 149 )$$

Performing a homodyne measurement in the P-basis to mode two after applying a beamsplitter can thus be written as

$$\begin{matrix}{}_{2 P} 〈 m \vert {\hat{B}}_{12} = {}_{2 P} 〈 m \vert {\hat{Z}}_{1}^{†} ( m ) ( {\hat{S}}_{1}^{†} ( ln \sqrt{2} ) {\hat{S}}_{2} ( \frac{1}{2} ln 2 ) ) {e}^{i {\hat{P}}_{1} {\hat{Q}}_{2}} \\ = {\hat{Z}}_{1}^{†} ( m ) {\hat{S}}_{1}^{†} ( ln \sqrt{2} ) {}_{2 P} 〈 {m}^{′} \vert {e}^{i {\hat{P}}_{1} {\hat{Q}}_{2}} ,\end{matrix} \qquad ( 150 )$$

where we have used that

$$\begin{matrix}{{{\hat{S}}^{†} ( r ) \vert m 〉}_{P} = \hat{Z} ( {m}^{′} ) {\hat{S}}^{†} ( r ) \vert 0 〉}_{P} \\ {= \vert {m}^{′} 〉}_{P}\end{matrix} \qquad ( 151 )$$

with m′=2^{-1/2}m. Finally, we can arrive at the Ĉ_{Z} gate we want by rewriting

$${e}^{i {\hat{P}}_{1} {\hat{Q}}_{2}} = {\hat{R}}_{1 ( \frac{π}{2} )} {\hat{C}}_{{Z}_{12}} {\hat{R}}_{1 ( \frac{π}{2} )}^{†} . \qquad ( 152 )$$

With the help of Eqs. 151 and 152, the starting circuit shown in FIG. 28A can be converted to the circuit shown in FIG. 28B, where ψ has been Fourier transformed to

$$\vert {ψ}^{′} 〉 = \hat{R} ( \frac{π}{2} ) \vert ψ .$$

Thus, if the input cat states are properly rotated, breeding with the beamsplitter is equivalent to breeding with a Ĉ_{Z} gate up to Gaussian operations that can be undone with further cluster-state processing and feed-forward displacements.

### DEE-8) Macronode P(m₂)

The probability of the Q-quadrature homodyne measurement m2 in the macronode circuit shown in FIG. 17A is given by:

$$P ( {m}_{2} ) ∝ {\int }_{- ∞}^{∞} dy {\vert}_{{Q}_{1}} {〈 y {\vert}_{{Q}_{2}} {〈 {m}_{2} \vert {\hat{B}}_{12} {e}^{- {\hat{Q}}_{2}^{2} / 2 {s}_{2}^{2}} \vert ψ 〉}_{1} \vert 0 〉}_{{P}_{2}} {\vert}^{2} . \qquad ( 153 )$$

where here \hat{B}₁₂ is a balanced beamsplitter, s₂=e^{r2} is the squeezing in the cluster state, and |ψ [symbol] ₁ is the input quantum state. This can be seen more easily by looking at the reduced circuit shown in FIG. 17C, where the m₂ homodyne measurement can be seen as occurring immediately after the first beamsplitter. Suppose the input state has the form of a weighted cat state:

$${\vert ψ 〉}_{1} ∝ ( A \hat{X} ( α ) + B {\hat{X}}^{†} ( α ) ) \hat{S} ( {r}_{1} ) \vert 0 〉 , \qquad ( 154 )$$

where we take A²+B²=1 and let α≥0 without loss of generality. Using this form of ψ, we have that:

$${{{{{\hat{B}}_{12} {e}^{- {\hat{Q}}_{2}^{2} / 2 {s}_{2}^{2}} \vert ψ 〉}_{1} \vert 0 〉}_{{P}_{2}} = {e}^{- \frac{{( {\hat{Q}}_{2} - {\hat{Q}}_{1} )}^{2}}{2 {s}_{2}^{2}}} {ψ}_{Q} ( \frac{{\hat{Q}}_{1} - {\hat{Q}}_{2}}{\sqrt{2}} ) \vert 0 〉}_{{P}_{1}} \vert 0 〉}_{{P}_{2}} \qquad ( 155 )$$

and so the integrand is, in the Q-basis,

$${\int \int {dxdx}^{′} {e}^{- \frac{{( z - {z}^{′} )}^{2}}{4 {s}_{2}^{2}}} {ψ}_{Q} ( \frac{x + {x}^{′}}{\sqrt{2}} ) \vert x 〉}_{{Q}_{1} {Q}_{2}} {〈 {m}_{2} \vert {x}^{′} 〉}_{{Q}_{2}} . \qquad ( 156 )$$

Thus, up to a normalization,

$$P ( {m}_{2} ) = {\int }_{- ∞}^{∞} dx {\vert {e}^{- \frac{{( z - {m}_{2} )}^{2}}{4 {s}_{2}^{2}}} ( {Ae}^{- \frac{x + {m}_{2} - α \sqrt{2}}{4 {s}_{1}^{2}}} + {B}^{- \frac{x + {m}_{2} - α \sqrt{2}}{4 {s}_{1}^{2}}} ) \vert}^{2} . \qquad ( 157 )$$

Performing the integral leads to the equations given in the main text.

### Example Quantum Computing System

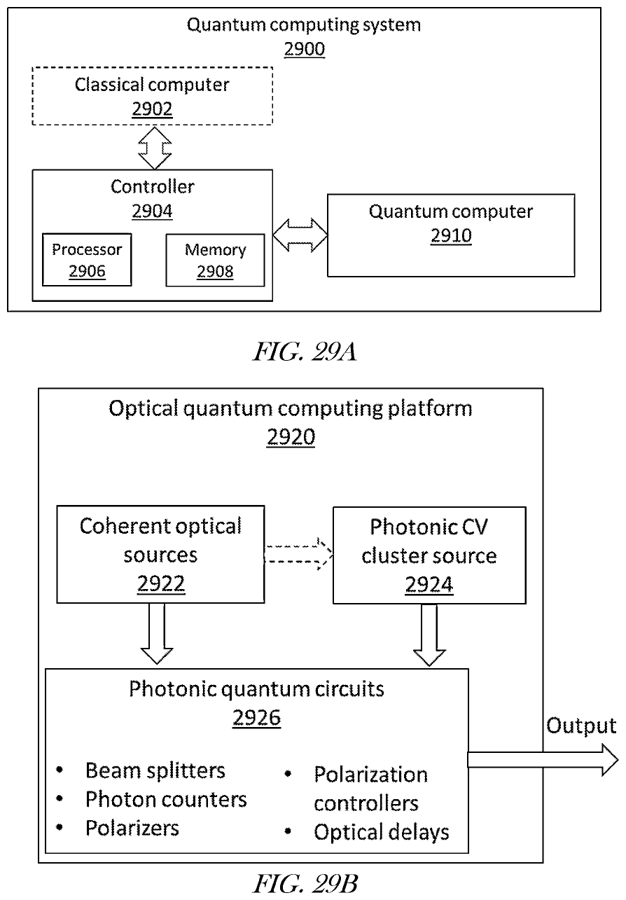

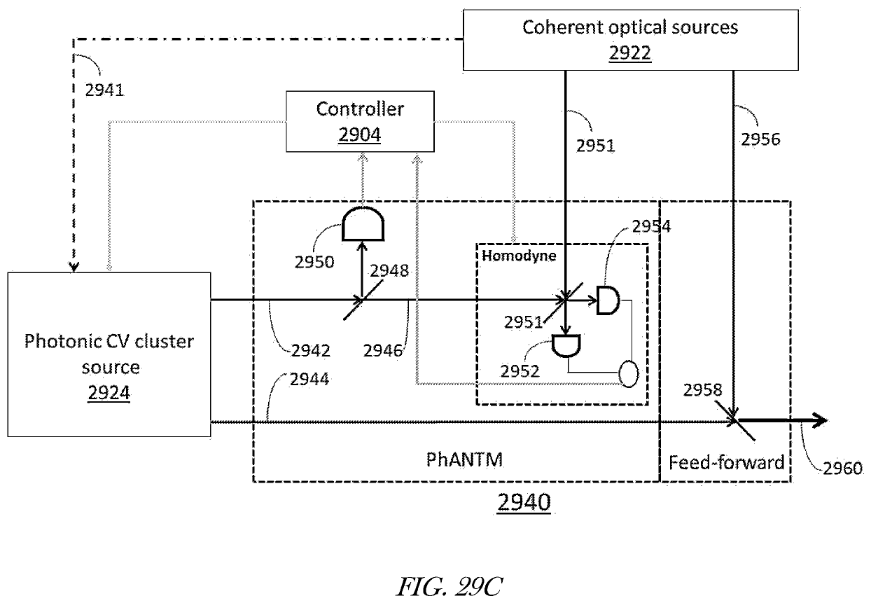

In various embodiments, the methods described above may be performed by a quantum computing system. FIG. 29A is a block diagram of an example quantum computing system 2900 that may be used to generate, control, and manipulate CV clusters.

In some embodiments, the quantum computing system 2900 may include a quantum computer 2902. In some examples, the quantum computer 2902 may comprise bosonic sources and a platform for implementing quantum circuits that perform quantum operations on bosonic field. A controller 2904 may control the operation of the quantum computer 2910. The controller may include at least one processor configured to execute computer executable instructions stored in a non-transitory memory to control the operation of the quantum computer 2910. In some cases, the quantum computing system 2900 may additionally include a classical computer 2902 in communication with the quantum computer 2902. The classical computer 2902 may include its own hardware processor and non-transitory memory. The control 2904 may also control the flow of data and/or commands between the quantum computer and user interface and the classical computer 2902. In some cases, the classical computer 2902 may send data and commands to the to the quantum computer 2910, directly or via the controller 2904, to configure one or more quantum circuits, perform a quantum operation, or a measurement, and the like.

In some cases, the classical computer and the quantum computer can be in communication via a data link. The data link can be a wired or wireless data link. The wireless data link may comprise a local area network (LAN), a Wi-Fi connection, or a wide area network (WLAN).

In some cases, the quantum computer can be a quantum computer based on any quantum computing technology (e.g., trapped ions, photons, superconducting circuits, and the like).

In some cases, a quantum computer may comprise a plurality of quantum computers interconnected, for example, using quantum communication channels.

In some cases, a quantum computer may be implemented on a photonic platform that enables generation, control, measurement, and manipulation of photons (optical fields), e.g., to form and configure CV cluster states comprising Gaussian and non-Gaussian states. In some cases, the platform may include optical components such as optical beam splitters, lasers, optical polarization controllers, photon counters, photo detectors, homodyne detection device and system systems, optical delays, and the like. In some embodiments, a one or more optical components can be on-chip components. In some embodiments, the platform may include on-chip and/or free space optical components.

In some cases, a controller (e.g., a classical computer) may be used to configure and manipulate cluster states, e.g., by performing operations and measurements on the optical fields in the photonic platform.

In some cases, a quantum computing system may include a measurement system configured to perform measurement on optical fields of the individual modes of the modes of a cluster state. The measurement system may include homodyne measurement devices, coherent optical sources, photon counters, and the like.

The controller may include a non-transitory memory configured to store specific computer-executable instructions for controlling and measuring the optical fields. The controller may include an electronic processor in communication with the non-transitory memory and configured to execute the specific computer-executable instructions to select modes in the cluster state, perform photon subtraction on a mode, split optical field associated with a mode (e.g., using a beam splitter), perform a photon-number-resolving detection on an optical filed or a portion of an optical field associated with a mode, perform a homodyne detection on a mode, perform a feed-forward Gaussian operation on a mode, and the like.

FIG. 29B is block diagram of an optical (or photonic) quantum computing platform 2920 that may be used to generate, control, and manipulate a photonic CV cluster. The optical quantum computing platform may include coherent optical sources 2922 for generating coherent light at different wavelengths, a photonic CV cluster source 2924 for generating entangled optical modes and photonic clusters or macronode clusters, and a photonic quantum circuits that receive, control, and tailor, optical fields received from the coherent optical sources 2922 and/or the photonic CV cluster source 2924. In some cases, the photonic CV cluster source 2924 may generate a cluster using light received from the coherent optical sources 2922. In some other cases, the photonic CV cluster source 2924 may include internal optical sources for generating a cluster. The photonic quantum circuits 2926 may control the optical fields associated with the optical clusters and light received from the photonic CV cluster source 2924 or coherent optical sources 2922 by performing various operation, to embed a non-Gaussian state in the cluster (e.g., using PhANTM process), transport non-Gaussian states in the cluster, breed cat states, or other process described above. The photonic quantum circuits 2926 may include beamsplitters, polarizers, polarizations controllers, photon counters, optical delays and other optical components. In some embodiments, one or more of these optical components can be integrated optical components fabricated (e.g., monolithically fabricated), on a substrate. In these cases, the optical components may comprise integrated optical waveguides for guiding and controlling light.

FIG. 29C is block diagram of a photonic quantum circuit 2940 for generating a non-Gaussian state (e.g., a cat state) embedded in a cluster state. In some examples, the optical quantum platform 2940 may be used to perform a process comprising a PhANTM method or the process 145 described above with respect to FIG. 1E. In some cases, the photonic quantum circuit 2940 may be included in the optical quantum computing platform 2920 that could be a platform used and controlled as part of the quantum computer 2910 of the quantum computing system 2900.

In some embodiments, the photonic CV cluster source 2924 may generate a photonic CV cluster comprising a plurality of entangled optical modes having Gaussian states. In some cases, the photonic CV cluster source 2924 may generate the cluster state using light 2941 received form the coherent optical sources 2922 of the optical quantum computing platform 2920. In some cases, the photonic CV cluster source 2924 may generate the cluster state using internal optical sources independent of the coherent optical sources 2922. The photonic CV cluster source 2924 may provide a pair of entangled modes of the cluster to the photonic quantum circuit 2940 as two entangled light beams 2942/2944. The first light beam 2942 may be associated with a first mode of the pair of entangled modes and the second light beam 2944 may be associated with a second mode of the pair of entangled modes. A portion (e.g., a small portion) of the light beam 2942 may be separated (subtracted) and redirected, by the beam splitter 2948, toward the photodetector 2950 (e.g., a single photon detector) that performs PNR on the redirected portion. The photodetector 2950 may generate an electric signal indicative of a number of photons detected in the redirected portion and provide the signal to the controller 2904. A transmitted portion 2946 of the first light beam 2642 (transmitted through the beam splitter 2948), is received by a homodyne measurement device that includes at least one beam splitter 2951 and a pair of photodetectors (balanced photodetectors) 2952/2954. Additionally, the homodyne device may receive a coherent beam of light 2951 from the coherent optical sources 2922. The coherent beam of light 2951 and the 2946 are incident on the beam splitter 2951 resulting in generation of two transmitted beams of light each received by one of the photodetectors of the pair of photodetectors 2952/2954. The pair of photodetectors 2952/2954 may generate a signal 2953 upon receiving the beams transmitted via the beam splitter 2951 and provide the signal 2953 to the controller 2904. As a result of the measurements performed on the first light beam 2942, an initial state of second beam of light (the second mode of the cluster) may be transformed to a non-Gaussian state (e.g., a cat-like state). In some cases, a feedforward operation may be performed of the second beam of light 2944 to transform the cat-like state to a cat state. In some examples, the feedforward operation may comprise interfering the second beam of light 2944 and a coherent beam of light 2656 received from the coherent optical sources 2922, to generate an output beam 2960 that is in a cat state embedded in the cluster generated by the photonic CV cluster source 2924.

### Example Embodiments

Some additional nonlimiting examples of embodiments discussed above are provided below. These should not be read as limiting the breadth of the disclosure in any way.

### Group 1

Example 1. A method of generating a first cat state embedded in a one-dimensional (1D) canonical cluster state, wherein the 1D canonical cluster state is a continuous variable (CV) quantum cluster state, the method comprising:
receiving a pair of entangled modes from a source of entangled cluster state modes comprising a first mode having a first initial state and a second mode having a second initial state, wherein the pair of entangled modes is associated with the 1D canonical cluster state;
selecting a first mode of the pair of entangled modes in the 1D canonical cluster state, wherein the first mode comprises a first optical field;
performing photon subtraction on the first mode by splitting the first optical field into a first portion and a second portion of the first optical field;
performing a photon-number-resolving detection on the first portion to transform the first initial state of the first mode to a non-Gaussian state;
performing a first homodyne detection on the second portion to teleport the non-Gaussian state to the second mode and transform the second initial state of the second mode to a teleported non-Gaussian state; and
performing a feed-forward Gaussian operation on the second mode to transform the teleported non-Gaussian state of the second mode to the first cat state embedded in the 1D canonical cluster state.
Example 2. The method of Example 1, wherein the non-Gaussian state is a cat-like state.
Example 3. The method of Example 1, wherein the teleported non-Gaussian state is a displaced cat state
Example 4. The method of Example 1, wherein the feed-forward Gaussian operation is a displacement operation.
Example 5. The method of Example 1, further comprising teleporting the first cat state from the second mode to a second cat state of a fourth mode of the cluster state by:
performing a second homodyne detection on the first cat state of the second mode to teleport the first cat state to a rotated cat state of a third mode in the 1D canonical cluster state, wherein the third mode is immediately adjacent to the second mode;
performing photon subtraction by splitting a second optical field associated with the third mode into a third portion and a fourth portion of the second optical field;
performing a photon-number-resolving detection on the third portion to transform the rotated cat state of the third mode to a second non-Gaussian state;
performing a homodyne detection on the fourth portion to teleport the second non-Gaussian state to the fourth mode and transform an initial state of the fourth mode to a second teleported non-Gaussian state; and
performing a feed-forward Gaussian operation on the second teleported non-Gaussian state to transform the state of the fourth mode to the second cat state.
Example 6. The method of Example 5, wherein performing the second homodyne detection comprises performing a π/2 phase-space rotation on the first cat state of the second mode.
Example 7. The method of Example 5, wherein an amplitude of the second cat state is larger than an amplitude the first cat state.
Example 8. The method of Example 1, wherein the 1D canonical cluster state is separated from an N-dimensional canonical cluster state, and wherein the first cat state is entangled to the N-dimensional canonical cluster state.
Example 9. The method of Example 8, further comprising performing homodyne detection in momentum basis to entangle the first cat state to a second cat state generated by transforming a second 1D canonical cluster state separated from the N-dimensional canonical cluster state to the second cat state.
Example 10. The method of Example 8 or 9, wherein the 1D dimensional cluster state is separated from the N-dimensional canonical cluster state by performing homodyne detection in position basis on selected modes of the N-dimensional canonical cluster state.
Example 11. The method of Example 1, further comprising:
selecting a reflectivity of a beam splitter used to perform photon subtraction to reduce a probability of coupling more than one photon to the first portion such that a mathematical operator representing the teleportation of the quantum state in the 1D canonical cluster state to the first cat state comprises applying a single factor of the quadrature operator \hat{Q} on the 1D canonical cluster state.
Example 12. The method of Example 11, wherein three quantum states of the 1D cluster state are teleported to a third cat state by teleporting the first cat state to a second cat state, and the second cat state to the third cat state, wherein teleportation of the three quantum states to the third cat state can be represented by an operator comprising 3^{rd} order polynomial in \hat{Q}.
Example 13. A method for generating a squeezed cat state embedded in a one dimensional (1D) canonical cluster state, the method comprising:
receiving a pair of entangled modes from a source of entangled cluster state modes, wherein the pair of entangled modes is associated with the 1D canonical cluster state;
selecting a first mode of the pair of entangled modes in the 1D canonical cluster state;
performing a squeezing operation on the first mode of the pair of entangled modes in the cluster state, to squeeze the state of the first mode; and
performing a photon-number-resolving detection on the first mode to transform the state of the unmeasured second mode of the pair of the entangled modes to the squeezed cat state.
Example 14. A method of preserving an amplitude of a cat state of a first mode of a cluster state transported from the first mode to a second mode of the cluster state, the method comprising:
performing photon subtraction by splitting light associated with the first mode to a first portion and a second portion, wherein the first mode comprises the cat state;
performing a photon-number-resolving detection on the first portion;
performing a homodyne detection on the second portion to teleport the cat state to a non-Gaussian state of the second mode; and
performing a feed-forward Gaussian operation on the second mode to transport the non-Gaussian state to a cat state of the second mode.
Example 15. A method for enlarging cat states embedded within a cluster state, the method comprising:
receiving a pair of entangled modes comprising a first mode prepared in a first cat state and a second mode prepared in a second cat state, wherein the first cat state has a superposition displacement along the p-quadrature, and the second cat state is a cat state identical to the first cat state rotated by π/2.
performing a homodyne detection on the first mode to transform the state of the second mode from the second cat state to a non-Gaussian state; and
performing a feed-forward Gaussian operation on the second mode to transform the non-Gaussian state to an enlarged cat state, wherein the enlarged cat state has an amplitude larger than the amplitude of the first or the second cat state.
Example 16. A method of breeding grid states in a cluster state comprising cat states, the method comprising:
receiving a pair of entangled modes comprising a first mode prepared in a first cat state and a second mode prepared in a second cat state, wherein the first cat state has a superposition displacement along the q-quadrature, and the second cat state is a cat state identical to the first cat state rotated by π/2.
performing a homodyne detection on the first mode to transform the state of the second mode to a displaced grid state; and
performing a feed-forward Gaussian operation on the second mode to transform the displaced grid state to a grid state.
Example 17. The method of Example 16, wherein the grid state comprises a Gottesman-Kitaev-Preskill (GKP) state.
Example 18. The method of Example 16, wherein the second mode is entangled to a third mode of the cluster state, and the third mode is entangled to a fourth mode of the cluster state, the method further comprising transforming the state of the fourth mode to an enlarged grid state by:
performing a p-basis homodyne measurement on the second mode to transform the state of the third mode to a rotated grid state, wherein the rotated grid state comprises the grid state rotated by π/2;
performing a p-quadrature homodyne detection on the third mode to transform the state of the fourth mode to a displaced grid state; and
performing a feed-forward Gaussian operation on the fourth mode to transform the displaced grid state to the enlarged grid state.
Example 19. A method of estimating the phase of an operator configured to operate on a cluster state, the method comprising:
receiving a first mode of the cluster state wherein the first mode comprises quantum information;
receiving a second mode of the cluster state wherein the second mode is in a squeezed cat state;
performing a homodyne measurement on the second mode; and
performing a feed-forward operation on the first mode to generate an output state.
Example 20. The method of Example 19, further comprising connecting the first mode to the second mode by applying a controlled Z-gate before performing the homodyne and the feed-forward operations.
Example 21. The method of Example 20, wherein the controlled Z-gate is applied by teleporting a quantum state of the first mode to a neighboring mode of the second mode.
Example 22. The method of Example 20, wherein the controlled Z-gate is applied by measuring modes of the cluster state between the first and the second mode.
Example 23. The method of Example 19, further comprising performing a Fourier transformation on the output state.
Example 24. A method of teleporting the states of the modes of a macronode of a one-dimensional macronode cluster state to a cat state, the method comprising:
performing photon subtraction by splitting light associated with a first mode of a macronode in the macronode cluster state into a first portion and a second portion;
performing a photon-number-resolving detection on the first portion;
performing a p-basis homodyne detection on the second portion to and performing a q-basis homodyne detection on a second mode of the macronode, to teleport states of the first and the second mode to the third mode of a neighboring macronode and transform a state of the third mode to a displaced cat state.
Example 25. The method of Example 24, further comprising performing a feed forward operation on the third mode to transform the displaced cat state to a cat state.
Example 26. A method of teleporting states of modes of a macronode of a one-dimensional macronode cluster state to a cat state, the method comprising:
performing a first photon subtraction by splitting light associated with a first mode of a macronode mode in the macronode cluster state, into a first portion and a second portion;
performing a second photon subtraction by splitting light associated with a second mode of the macronode mode in the macronode cluster state, into a third portion and a fourth portion;
splitting the second portion into a second transmitted portion and a second reflected portion;
splitting the third portion into a third transmitted portion and a third reflected portion;
forming a first mixed portion by interfering the second reflected portion and the third transmitted portion;
forming a second mixed portion by interfering the third reflected portion and the second transmitted portion;
performing a first photon-number-resolving detection on the first mixed portion;
performing a second photon-number-resolving detection on the second mixed portion;
performing a p-basis homodyne detection on the first portion and performing a q-basis homodyne detection on the fourth portion, to teleport states of the first and the second mode to the third mode of a neighboring macronode; and
performing a feed-forward operation on the third mode to transform a state of the third node to the cat state.
Example 27. A method of teleporting the states of modes of a macronode of a one-dimensional macronode cluster state to a cat state, the method comprising:
performing a p-basis homodyne detection on first mode of a macronode mode in a macronode cluster state to teleport the state of the first mode to a third mode of a neighboring macronode;
performing a first photon subtraction by splitting light associated with a second mode of the macronode mode in the macronode cluster state, into a first portion and a second portion;
performing a second photon subtraction by splitting light associated with a third mode of a neighboring macronode mode in the macronode cluster state, into a third portion and a fourth portion;
splitting the second portion into a second transmitted portion and a second reflected portion;
splitting the third portion into a third transmitted portion and a third reflected portion;
forming a first mixed portion by interfering the second reflected portion and the third transmitted portion;
forming a second mixed portion by interfering the third reflected portion and the second transmitted portion;
performing a first photon-number-resolving detection on the first mixed portion;
performing a second photon-number-resolving detection on the second mixed portion;
performing a q-basis homodyne detection on the first portion to teleport the state of the second mode to the third mode; and
performing a feed-forward operation on the third mode to transform a state of the third mode to a cat state.
Example 28. A method of teleporting the state of macronodes of a one-dimensional macronode cluster state to a cat state, the method comprising:
performing a squeezing operation on the first mode of a macronode in the macronode cluster state, to generate a first squeezed state of the first mode;
performing a photon-number-resolving detection on the first squeezed state;
performing a p-basis or a q-basis homodyne detection on a second mode of the macronode to teleport a state of the second mode to a third mode of a neighboring macronode; and
performing a feed-forward operation on the third mode to transform a state of the third mode to a cat state.
Example 29. A quantum system for generating a first cat state embedded in a one-dimensional (1D) canonical cluster state, wherein the 1D canonical cluster state is a continuous variable (CV) quantum cluster state of a plurality of modes, and wherein each individual mode of the plurality of modes comprises an optical field, the system comprising:
a quantum apparatus configured to generate the plurality of modes forming the 1D canonical cluster state, the plurality of modes comprising at least one pair of entangled modes comprising a first mode having a first initial state and a second mode having a second initial state;
a measurement system configured to control and perform measurement on optical fields of the individual modes of the plurality of modes, the measurement system comprising:
a beam splitter configured to split the optical fields;
a homodyne measurement device;
a photon counter; and
a controller comprising:
   a non-transitory memory configured to store specific computer-executable instructions for controlling and measuring the optical fields; and
   an electronic processor in communication with the non-transitory memory and configured to execute the specific computer-executable instructions to at least:
      select a first mode of the pair of entangled modes and split a first optical field associated with the first mode into a first portion and a second portion of the first optical field using the beam splitter;
      perform a photon-number-resolving detection on the first portion using the photon counter, wherein the photon-number-resolving detection transforms the initial state of the first mode to a non-Gaussian state;
      perform a homodyne detection on the second portion using the homodyne measurement device, to teleport the non-Gaussian state to the second mode to transform the state of the second mode from the second initial state to a teleported non-Gaussian state; and
      perform a feed-forward Gaussian operation on the second mode to transform the teleported non-Gaussian state of the second mode to the first cat state embedded in the 1D canonical cluster state.
Example 30. The system of Example 29, wherein the first and the second initial states comprise encoded states.
Example 31 The system of Example 29, wherein the electronic processor is configured to perform the feed-forward Gaussian operation by:
directing a second optical field associated with the second mode to a first port of a second splitter and providing a coherent laser beam to a second port of the second beam splitter; and
controlling the amplitude and/or the phase of the coherent laser beam to displace the state of the second mode.
Example 32. A method of generating a first compass state, the method comprising:
the method of Example 1, further comprising performing photon subtraction by splitting a second optical field associated with the first cat state of the second mode into a third portion and a fourth portion of the second optical field;
performing a photon-number-resolving detection on the third portion;
performing a homodyne detection on the fourth portion to teleport the cat state to the fourth mode and transform an initial state of the fourth mode to a third non-Gaussian state; and
performing a feed-forward Gaussian operation on the third non-Gaussian state to transform the state of the fourth mode to the first compass state.
Example 33. The method of Example 32, wherein the compass state is a four-component cat-like state.
Example 34. The method of Example 32 where the first initial state of the first mode is a vacuum state.
Example 35. The method of Example 32, wherein a first initial state of the first mode is an initial compass state, and wherein an amplitude of the first compass state is larger than the amplitude of the initial compass state.
Example 36. A method of teleporting the state of a macronode in a one-dimensional macronode cluster state to a displaced weighted compass state, the method comprising:
performing a first photon subtraction by splitting light associated with a first mode of the macronode into a first portion and a second portion;
performing a photon-number-resolving detection on the first portion;
performing a second photon subtraction by splitting light associated with a second mode of the macronode into a third portion and a fourth portion;
performing a photon-number-resolving detection on the third portion; and
performing a p-basis homodyne detection on the second portion and a q-basis homodyne detection on the fourth portion to teleport the states of the first macronode to the third mode of a neighboring macronode and to transform the state of the third mode to a displaced weighted compass state.
Example 37. The method of Example 36, further comprising performing a feed forward operation on the third mode to transform the state of the third mode to a compass state.
Example 38. The method of Example 36 wherein an initial state of the second mode is a squeezed state.
Example 39. The method of Example 38, wherein the initial state of the first mode is a vacuum state, and the displaced weighted compass state has a 90-degree symmetry.
Example 40. The method of Example 38, wherein the initial state of the first mode is an initial compass state, and the displaced weighted compass state is an enlarged compass state.
Example 41. The method of Example 38, wherein the initial state of the first mode is a cat state or a squeezed state, and the displaced weighted compass state has a rectangular symmetry.

### Group 2

Example 1. A method of generating a first cat state embedded in a one-dimensional (1D) canonical cluster state, wherein the 1D canonical cluster state is a continuous variable (CV) quantum cluster state, the method comprising:
receiving a pair of entangled modes from a source of entangled cluster state modes comprising a first mode having a first initial state and a second mode having a second initial state, wherein the pair of entangled modes is associated with the 1D canonical cluster state;
selecting the first mode of the pair of entangled modes in the 1D canonical cluster state, wherein the first mode comprises a first optical field;
performing photon subtraction on the first mode by at least splitting the first optical field into a first portion and a second portion of the first optical field;
performing a photon-number-resolving detection on the first portion to transform the first initial state of the first mode to a non-Gaussian state;
performing a first homodyne detection on the second portion to teleport the non-Gaussian state of the first mode to the second mode and transform the second initial state of the second mode to a teleported non-Gaussian state; and
performing a feed-forward Gaussian operation on the second mode to transform the teleported non-Gaussian state of the second mode to the first cat state embedded in the 1D canonical cluster state.
Example 2. The method of Example 1, wherein the non-Gaussian state is a cat-like state.
Example 3. The method of any of Examples 1-2, wherein the first initial state and the second initial state comprise squeezed states.
Example 4. The method of any of Examples 1-3, wherein the pair of entangled modes are generated by applying a CZ gate to two squeezed vacuum states.
Example 5. The method of any of Examples 1-4, wherein the teleported non-Gaussian state is a displaced cat state.
Example 6. The method of any of Examples 1-5, wherein the feed-forward Gaussian operation is a displacement operation.
Example 7. The method of any of Examples 1-6, further comprising teleporting the first cat state from the second mode to a second cat state of a fourth mode of the cluster state by:
performing a second homodyne detection on the first cat state of the second mode to teleport the first cat state to a rotated cat state of a third mode in the 1D canonical cluster state, wherein the third mode is immediately adjacent to the second mode;
performing photon subtraction by on the third mode by splitting a second optical field associated with the third mode into a third portion and a fourth portion of the second optical field;
performing a photon-number-resolving detection on the third portion to transform the rotated cat state of the third mode to a second non-Gaussian state;
performing a homodyne detection on the fourth portion to teleport the second non-Gaussian state to the fourth mode and transform an initial state of the fourth mode to a second teleported non-Gaussian state; and
performing a feed-forward Gaussian operation on the second teleported non-Gaussian state to transform the state of the fourth mode to the second cat state.
Example 8. The method of Example 7, wherein performing the second homodyne detection comprises performing a π/2 phase-space rotation on the first cat state of the second mode.
Example 9. The method of any of Examples 7-8, wherein an amplitude of the second cat state is larger than an amplitude the first cat state.
Example 10. The method of any of Examples 7-9, further comprising:
selecting a reflectivity of a first beam splitter used to perform the photon subtraction on the first mode and a reflectivity of a second beam splitter used to perform the photon subtraction on the third mode, to reduce a probability of coupling more than one photon to the first portion and one photon to the third portion such that a mathematical operator representing the transformation of the first initial state of the first mode to the second teleported non-Gaussian state of the fourth mode comprises applying a polynomial comprising \hat{Q}² on the first initial state.
Example 11. The method of any of Examples 1-10, wherein the 1D canonical cluster state is separated from an N-dimensional canonical cluster state, and wherein the first cat state is entangled to the N-dimensional canonical cluster state.
Example 12. The method of Example 11, further comprising performing homodyne detection in momentum basis to entangle the first cat state to a second cat state generated by transforming a second 1D canonical cluster state separated from the N-dimensional canonical cluster state to the second cat state.
Example 13. The method of any of Examples 11-12, wherein the 1D cluster state is separated from the N-dimensional canonical cluster state by performing homodyne detection in position basis on selected modes of the N-dimensional canonical cluster state.
Example 14. The method of any of Examples 1-13, wherein performing photon subtraction on the first mode comprises subtracting n photons from the first optical field such that a mathematical operator representing the transformation of the first initial state of the first mode to the teleported non-Gaussian state of the second mode comprises applying an nth degree polynomial in \hat{Q}.
Example 15. The method of Example 14, wherein the nth degree polynomial in operator \hat{Q} comprises the Hermite polynomial of degree n.
Example 16. The method of Example 1, further comprising:
selecting a reflectivity of a beam splitter used to perform the photon subtraction on the first mode to reduce a probability of coupling more than one photon to the first portion such that a mathematical operator representing the transformation of the first initial state of the first mode to the teleported non-Gaussian state of the second mode comprises applying a polynomial comprising a single factor of the quadrature operator \hat{Q} on the first initial state.
Example 17. A method for generating a squeezed cat state embedded in a one dimensional (1D) canonical cluster state, the method comprising:
receiving a pair of entangled modes from a source of entangled cluster state modes, wherein the pair of entangled modes is associated with the 1D canonical cluster state;
selecting a first mode of the pair of entangled modes in the 1D canonical cluster state;
performing a squeezing operation on the first mode of the pair of entangled modes in the cluster state to squeeze the state of the first mode; and
performing a photon-number-resolving detection on the first mode to transform the state of a second mode of the pair of the entangled modes to the squeezed cat state, wherein the second mode is an unmeasured mode.
Example 18. A method of preserving an amplitude of a cat state transported from a first mode of a cluster state to a second mode of the cluster state, the method comprising:
receiving a pair of entangled modes from a source of entangled cluster state modes comprising the first mode and the second mode;
performing photon subtraction by at least splitting light associated with the first mode into a first portion and a second portion, wherein the first mode comprises a first cat state having a first amplitude and a first nodal location;
performing a photon-number-resolving detection on the first portion;
performing a homodyne detection on the second portion to teleport the first cat state to a non-Gaussian state of the second mode; and
performing a feed-forward Gaussian operation on the second mode to transform the non-Gaussian state to a second cat state in a second nodal location that has a transport distance from the first nodal location, wherein the second cat state has a second amplitude that has reduced decay relative to the first amplitude compared to a cat state that is transported over the same transport distance without performing photon subtraction.
Example 19. A method for enlarging cat states embedded within a cluster state, the method comprising:
receiving a pair of entangled modes in the cluster state, the pair of entangled modes comprising a first mode prepared in a first cat state and a second mode prepared in a second cat state, wherein the first cat state comprises a superposition displacement along the p-quadrature, and the second cat state comprises a cat state identical to the first cat state rotated by π/2;
performing a homodyne detection on the first mode to transform the state of the second mode from the second cat state to a non-Gaussian state; and
performing a feed-forward Gaussian operation on the second mode to transform the non-Gaussian state to an enlarged cat state embedded in the cluster state, wherein the enlarged cat state has an amplitude larger than the amplitude of the first or the second cat state.
Example 20. A method of breeding grid states in a cluster state comprising cat states, the method comprising:
receiving a pair of entangled modes in the cluster state, the pair of entangled modes comprising a first mode prepared in a first cat state and a second mode prepared in a second cat state, wherein the first cat state has a superposition displacement along the q-quadrature, and the second cat state is rotated by π/2 with respect to the first cat state;
performing a homodyne detection on the first mode to transform the state of the second mode to a first displaced grid state; and
performing a feed-forward Gaussian operation on the second mode to transform the first displaced grid state of the second mode to a grid state embedded in the cluster state.
Example 21. The method of Example 20, wherein the grid state comprises a Gottesman-Kitaev-Preskill (GKP) state.
Example 22. The method of Example 20 wherein the amplitude of the first and the second cat states are approximately the same.
Example 23. The method of Example 22, further comprising applying squeezing on the first and the second cat states to make their amplitudes approximately the same.
Example 24. The method of Example 20, wherein the second mode is entangled to a third mode of the cluster state, and the third mode is entangled to a fourth mode of the cluster state having a superposition displacement along the p-quadrature, the method further comprising transforming the state of the fourth mode to an enlarged grid state embedded in the cluster state by:
performing a p-basis homodyne measurement on the second mode to transform the state of the third mode to a rotated grid state, wherein the rotated grid state comprises the grid state rotated by π/2;
performing a p-quadrature homodyne detection on the third mode to transform the state of the fourth mode to a second displaced grid state; and
performing a feed-forward Gaussian operation on the fourth mode to transform the second displaced grid state of the fourth mode to the enlarged grid state embedded in the cluster state.
Example 25. The method of Example 24, wherein the third mode is an unaltered mode of the cluster state.
Example 26. A method of estimating a phase of an operator configured to operate on a cluster state, the method comprising:
receiving a first mode of the cluster state, wherein the first mode comprises quantum information;
receiving a second mode of the cluster state, wherein the second mode is in a squeezed cat state;
performing a homodyne measurement on the second mode to teleport the squeezed cat state to a transformed state of the first mode;
performing a feed-forward Gaussian operation on the first mode to generate an output state from the transformed state; and
estimating the phase of the operator by at least measuring the output state and processing the result of the output state measurement.
Example 27. The method of Example 26, further comprising connecting the first mode to the second mode by applying a controlled Z-gate before performing the homodyne and the feed-forward operations.
Example 28. The method of Example 27, wherein the controlled Z-gate is applied by teleporting a quantum state of the first mode to a neighboring mode of the second mode.
Example 29. The method of Example 27, wherein the controlled Z-gate is applied by measuring modes of the cluster state between the first mode and the second mode.
Example 30. The method of Example 27, further comprising performing a Fourier transformation on the output state before estimating the phase of the operator.
Example 31. A method of teleporting states of modes of a macronode of a one-dimensional (1D) macronode cluster state to a non-Gaussian state, the method comprising:
performing photon subtraction by splitting light associated with a first mode of the macronode in the macronode cluster state into a first portion and a second portion;
performing a photon-number-resolving detection on the first portion;
performing a p-basis homodyne detection on the second portion and performing a q-basis homodyne detection on a second mode of the macronode, to teleport states of the first and the second mode to a third mode of a neighboring macronode causing transformation of a state of the third mode to the non-Gaussian state.
Example 32. The method of Example 31, further comprising performing a feed forward operation on the third mode to remove a displacement of the non-Gaussian state.
Example 33. A method of teleporting states of modes of a macronode of a one-dimensional (1D) macronode cluster state to a non-Gaussian state, the method comprising:
performing a first photon subtraction by splitting light associated with a first mode of the macronode mode in the macronode cluster state, into a first portion and a second portion;
performing a second photon subtraction by splitting light associated with a second mode of the macronode mode in the macronode cluster state, into a third portion and a fourth portion;
splitting the second portion into a second transmitted portion and a second reflected portion;
splitting the third portion into a third transmitted portion and a third reflected portion;
forming a first mixed portion by interfering the second reflected portion and the third transmitted portion;
forming a second mixed portion by interfering the third reflected portion and the second transmitted portion;
performing a first photon-number-resolving detection on the first mixed portion;
performing a second photon-number-resolving detection on the second mixed portion;
performing a p-basis homodyne detection on the first portion and performing a q-basis homodyne detection on the fourth portion, to teleport states of the first and the second mode to a third mode of a neighboring macronode causing transformation of a state of the third mode to the non-Gaussian state; and
performing a feed-forward operation on the third mode to remove a displacement of the non-Gaussian state.
Example 34. A method of teleporting states of modes of a macronode of a one-dimensional (1D) macronode cluster state to a non-Gaussian state, the method comprising:
performing a p-basis homodyne detection on a first mode of the macronode in the 1D macronode cluster state to teleport a state of the first mode to a third mode of a neighboring macronode;
performing a first photon subtraction by splitting light associated with a second mode of the macronode in the 1D macronode cluster state, into a first portion and a second portion;
performing a second photon subtraction by splitting light associated with a third mode of a neighboring macronode mode in the macronode cluster state, into a third portion and a fourth portion;
splitting the second portion into a second transmitted portion and a second reflected portion;
splitting the third portion into a third transmitted portion and a third reflected portion;
forming a first mixed portion by interfering the second reflected portion and the third transmitted portion;
forming a second mixed portion by interfering the third reflected portion and the second transmitted portion;
performing a first photon-number-resolving detection on the first mixed portion;
performing a second photon-number-resolving detection on the second mixed portion;
performing a q-basis homodyne detection on the first portion to teleport the state of the second mode to the third mode causing transformation of a state of the third mode to the non-Gaussian state; and
performing a feed-forward operation on the third mode to remove a displacement of the non-Gaussian state.
Example 35. A method of teleporting states of a macronodes of a one-dimensional (1D) macronode cluster state to a non-Gaussian state, the method comprising:
performing a squeezing operation on the first mode of the macronode in the 1D macronode cluster state, to generate a first squeezed state of the first mode;
performing a photon-number-resolving detection on the first squeezed state;
performing a p-basis or a q-basis homodyne detection on a second mode of the macronode to teleport a state of the second mode to a third mode of a neighboring macronode causing transformation of a state of the third mode to the non-Gaussian state; and
performing a feed-forward operation on the third mode to remove a displacement of the non-Gaussian state.
Example 36. The method of any of Examples 31-35, wherein the non-Gaussian state is a cat state or a weighted cat state.
Example 37. The method of any of Examples 31-34, wherein teleporting the states of the modes of the macronode comprises applying polynomials in \hat{Q} or \hat{P} on the teleported states.
Example 38. A quantum system for generating a first cat state embedded in a one-dimensional (1D) canonical cluster state, wherein the 1D canonical cluster state is a continuous variable (CV) quantum cluster state of a plurality of modes, and wherein each individual mode of the plurality of modes comprises an optical field, the system comprising:
a quantum apparatus configured to generate the plurality of modes forming the 1D canonical cluster state, the plurality of modes comprising at least one pair of entangled modes comprising a first mode having a first initial state and a second mode having a second initial state;
a measurement system configured to control and perform measurement on optical fields of the individual modes of the plurality of modes, the measurement system comprising:
a beam splitter configured to split the optical fields;
a homodyne measurement device;
a photon counter; and
a controller comprising:
a non-transitory memory configured to store specific computer-executable instructions for controlling and measuring the optical fields; and
an electronic processor in communication with the non-transitory memory and configured to execute the specific computer-executable instructions to at least:
select a first mode of the pair of entangled modes and split a first optical field associated with the first mode into a first portion and a second portion of the first optical field using the beam splitter;
perform a photon-number-resolving detection on the first portion using the photon counter, wherein the photon-number-resolving detection transforms the initial state of the first mode to a non-Gaussian state;
perform a homodyne detection on the second portion using the homodyne measurement device, to teleport the non-Gaussian state to the second mode to transform the state of the second mode from the second initial state to a teleported non-Gaussian state; and
perform a feed-forward Gaussian operation on the second mode to transform the teleported non-Gaussian state of the second mode to the first cat state embedded in the 1D canonical cluster state.
Example 39. The system of Example 38, wherein the first and the second initial states comprise encoded states.
Example 40. The system of Example 38, wherein the electronic processor is configured to perform the feed-forward Gaussian operation by:
directing a second optical field associated with the second mode to a first port of a second splitter and providing a coherent laser beam to a second port of the second beam splitter; and
controlling the amplitude and/or the phase of the coherent laser beam to displace the state of the second mode.
Example 41. A method of generating a compass state embedded in the 1D canonical cluster state, the method comprising:
the method of Example 1, further comprising performing photon subtraction by splitting a second optical field associated with the first cat state of the second mode into a third portion and a fourth portion of the second optical field;
performing a photon-number-resolving detection on the third portion;
performing a homodyne detection on the fourth portion to teleport the cat state to a fourth mode of the 1D cluster state causing transformation of an initial state of the fourth mode to a third non-Gaussian state; and
performing a feed-forward Gaussian operation on the third non-Gaussian state to transform the state of the fourth mode to the compass state embedded in the 1D canonical cluster state.
Example 42. The method of Example 41, wherein the compass state is a four-component cat-like state.
Example 43. The method of Example 41 where the first initial state of the first mode is a vacuum state.
Example 44. The method of Example 41, wherein the first initial state of the first mode is an initial compass state, and wherein an amplitude of the first compass state is larger than the amplitude of the initial compass state.
Example 45. A method of teleporting states of a macronode in a one-dimensional (1D) macronode cluster state to a displaced weighted compass state embedded in the 1D macronode cluster state, the method comprising:
performing a first photon subtraction by splitting light associated with a first mode of the macronode into a first portion and a second portion;
performing a photon-number-resolving detection on the first portion;
performing a second photon subtraction by splitting light associated with a second mode of the macronode into a third portion and a fourth portion;
performing a photon-number-resolving detection on the third portion; and
performing a p-basis homodyne detection on the second portion and a q-basis homodyne detection on the fourth portion to teleport the states of the first macronode to a third mode of a neighboring macronode and to transform the state of the third mode to a displaced weighted compass state.
Example 46. The method of Example 45, further comprising performing a feed forward operation on the third mode to transform the state of the third mode to a compass state.
Example 47. The method of any of Examples 45-46 wherein an initial state of the second mode is a squeezed state.
Example 48. The method of Example 47, wherein the initial state of the first mode is a vacuum state, and the displaced weighted compass state has a 90-degree symmetry.
Example 49. The method of Example 47, wherein the initial state of the first mode is an initial compass state, and the displaced weighted compass state is an enlarged compass state.
Example 50. The method of Example 47, wherein the initial state of the first mode is a cat state or a squeezed state, and the displaced weighted compass state has a rectangular symmetry.

### Group 3

Example 1. A method of generating a first non-Gaussian state embedded in a cluster state, wherein the cluster state is a continuous variable (CV) quantum cluster state, the method comprising:
performing photon subtraction on a first mode of the cluster state to transform a first initial state of the first mode to a first initial non-Gaussian state, wherein the first mode is entangled to a second mode of the cluster state; and
teleporting the first initial non-Gaussian state of the first mode to the second mode to transform a second initial state of the second mode to the first non-Gaussian state of the second mode, embedded in the cluster state.
Example 2. The method of claim 51, further comprising performing a feed-forward Gaussian operation on the second mode to transform the first non-Gaussian state of the second mode to a first cat state embedded in the cluster state.
Example 3. The method of claim 51, wherein the CV quantum cluster state comprises a one-dimensional cluster state.
Example 4. The method of claim 51, wherein performing photon subtraction on the first mode comprises performing a Photon-Number-Resolved detection on a portion of the optical field associated with the first mode.
Example 5. The method of claim 54, further comprising generating the portion of the optical field associated with the first mode using a beam splitter.
Example 6. The method of claim 51, further comprising teleporting the first non-Gaussian state from the second mode to a second non-Gaussian state of a fourth mode of the cluster state by:
teleporting the first non-Gaussian state to a rotated non-Gaussian state of a third mode in the cluster state, wherein the third mode is entangled to the second mode;
performing photon subtraction on the third mode to transform the rotated non-Gaussian state of the third mode to the second initial non-Gaussian state;
teleporting the second initial non-Gaussian state to the fourth mode to transform an initial state of the fourth mode to the second non-Gaussian state, wherein the fourth mode is entangled to the third mode.
Example 7. The method of claim 56, further comprising performing a feed-forward Gaussian operation on the fourth mode to transform the second non-Gaussian state of the fourth mode to a second cat state embedded in the cluster state.
Example 8. The method of any of claims 51-57, wherein performing photon subtraction comprises subtracting and counting at least one photon.
Example 9. A method of generating a continuous variable (CV) quantum cluster state having an embedded non-Gaussian state, the method comprising:
receiving a first mode and a second mode each having a squeezed vacuum quantum state;
entangling the first mode to the second mode to form an entangled pair;
performing photon subtraction on the first mode of the entangled pair to transform an initial state of the first mode to an initial non-Gaussian state;
teleporting the initial non-Gaussian state of the first mode to the second mode to transform an initial state of the second mode to a non-Gaussian state of the second mode to a non-Gaussian state;
entangling the second mode to a third mode; and
entangling the second mode to a fourth mode.
Example 10. The method of claim 59, wherein entangling comprises entangling using a controlled Z-gate.
Example 11. A method for generating a squeezed cat state embedded in a cluster state, the method comprising:
performing a squeezing operation on a first mode of a pair of entangled modes in the cluster state to squeeze the state of the first mode; and
performing a photon subtraction on the first mode to transform the state of a second mode of the pair of the entangled modes to the squeezed cat state.
Example 12. A quantum system for generating a non-Gaussian state embedded in a continuous variable (CV) quantum cluster state of a plurality of modes, and wherein each individual mode of the plurality of modes comprises an optical field, the system comprising:
a quantum apparatus configured to receive a pair of entangled modes of the plurality of modes comprising a first mode having a first initial state and a second mode having a second initial state;
a measurement system configured to control and perform measurement on optical fields of the individual modes of the plurality of modes, the measurement system comprising:
a photon counter configured to measure a number of photons in optical fields;
a homodyne measurement device;
a controller comprising:
   a non-transitory memory configured to store specific computer-executable instructions for controlling and measuring the optical fields; and
   an electronic processor in communication with the non-transitory memory and configured to execute the specific computer-executable instructions to at least:
      select a first mode of the pair of entangled modes and perform a photon-number-resolving detection on a portion of an optical field associated with the first mode using the photon counter, wherein the photon-number-resolving detection transforms the initial state of the first mode to an initial non-Gaussian state;
      perform a homodyne detection on the second portion using the homodyne measurement device, to teleport the initial non-Gaussian state to the second mode and to transform the state of the second mode from the second initial state to the non-Gaussian state.
Example 13. The quantum system of claim 62, wherein the electronic processor is further configured to execute the specific computer-executable instructions to perform a feed-forward Gaussian operation on the second mode, to transform the non-Gaussian state of the second mode to a cat state embedded in the cluster state.
Example 14. The quantum system of claim 63, wherein the feed-forward Gaussian operation comprises a homodyne measurement.
Example 15. The quantum system of claim 63, wherein the feed-forward Gaussian operation comprises interfering an optical field associated with the second mode with a coherent beam of light.
Example 16. The quantum system of claim 65, wherein the amplitude or the phase of the coherent beam of light is controlled based at least in part on an outcome of the homodyne detection.
Example 17. A method of preserving an amplitude of a first non-Gaussian state transported from a first nodal location in a cluster state to a second nodal location in the cluster state, the method comprising:
performing photon subtraction on a first mode at the first nodal location, the first mode comprising the non-Gaussian state and having a first amplitude;
performing a homodyne detection on the first mode to teleport the non-Gaussian state to a second non-Gaussian state of a second mode at the second nodal location, wherein the second non-Gaussian state has a second amplitude that has reduced decay relative to the first amplitude compared to a non-Gaussian state that is transported over the same transport nodal distance without performing photon subtraction.

### Terminology

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware. Further, the computing system may include, be implemented as part of, or communicate with, a computation network or a cloud computing system.

Many other variations than those described herein will be apparent from this disclosure. For example, depending on the embodiment, certain acts, events, or functions of any of the algorithms described herein can be performed in a different sequence, can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together. The terms “in one/some case(s)” or “in one/some implementation(s)” represent various embodiments.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

Many variations and modifications may be made to the above-described embodiments, the elements of which are to be understood as being among other acceptable examples. All such modifications and variations are intended to be included herein within the scope of this disclosure.

1. A method of generating a first cat state embedded in a one-dimensional (1D) canonical cluster state, wherein the 1D canonical cluster state is a continuous variable (CV) quantum cluster state, the method comprising:
receiving a pair of entangled modes from a source of entangled cluster state modes comprising a first mode having a first initial state and a second mode having a second initial state, wherein the pair of entangled modes is associated with the 1D canonical cluster state;
selecting the first mode of the pair of entangled modes in the 1D canonical cluster state, wherein the first mode comprises a first optical field;
performing photon subtraction on the first mode by at least splitting the first optical field into a first portion and a second portion of the first optical field;
performing a photon-number-resolving detection on the first portion to transform the first initial state of the first mode to a non-Gaussian state;
performing a first homodyne detection on the second portion to teleport the non-Gaussian state of the first mode to the second mode and transform the second initial state of the second mode to a teleported non-Gaussian state; and
performing a feed-forward Gaussian operation on the second mode to transform the teleported non-Gaussian state of the second mode to the first cat state embedded in the 1D canonical cluster state.

2. The method of claim 1, wherein the non-Gaussian state is a cat-like state.

3. The method of claim 1, wherein the first initial state and the second initial state comprise squeezed states.

4. The method of claim 1, wherein the pair of entangled modes are generated by applying a CZ gate to two squeezed vacuum states.

5. The method of claim 1, wherein the teleported non-Gaussian state is a displaced cat state.

6. The method of claim 1, wherein the feed-forward Gaussian operation is a displacement operation.

7. The method of claim 1, further comprising teleporting the first cat state from the second mode to a second cat state of a fourth mode of the 1D canonical cluster state by:
performing a second homodyne detection on the first cat state of the second mode to teleport the first cat state to a rotated cat state of a third mode in the 1D canonical cluster state, wherein the third mode is immediately adjacent to the second mode;
performing photon subtraction by on the third mode by splitting a second optical field associated with the third mode into a third portion and a fourth portion of the second optical field;
performing a photon-number-resolving detection on the third portion to transform the rotated cat state of the third mode to a second non-Gaussian state;
performing a homodyne detection on the fourth portion to teleport the second non-Gaussian state to the fourth mode and transform an initial state of the fourth mode to a second teleported non-Gaussian state; and
performing a feed-forward Gaussian operation on the fourth mode to transform the second teleported non-Gaussian state to the second cat state.

8. The method of claim 0, wherein performing the second homodyne detection comprises performing a π/2 phase-space rotation on the first cat state of the second mode.

9. The method of claim 7, wherein an amplitude of the second cat state is larger than an amplitude the first cat state.

10. The method of claim 7, further comprising:
selecting a reflectivity of a first beam splitter used to perform the photon subtraction on the first mode and a reflectivity of a second beam splitter used to perform the photon subtraction on the third mode, to reduce a probability of coupling more than one photon to the first portion and one photon to the third portion such that a mathematical operator representing the transformation of the first initial state of the first mode to the second teleported non-Gaussian state of the fourth mode comprises applying a polynomial comprising \hat{Q}² on the first initial state.

11. The method of claim 1, wherein the 1D canonical cluster state is separated from an N-dimensional canonical cluster state, and wherein the first cat state is entangled to the N-dimensional canonical cluster state.

12. The method of claim 11, further comprising performing homodyne detection in momentum basis to entangle the first cat state to a second cat state generated by transforming a second 1D canonical cluster state separated from the N-dimensional canonical cluster state to the second cat state.

13. The method of claim 1, wherein the 1D canonical cluster state is separated from the N-dimensional canonical cluster state by performing homodyne detection in position basis on selected modes of the N-dimensional canonical cluster state.

14. The method of claim 1, wherein performing photon subtraction on the first mode comprises subtracting n photons from the first optical field such that a mathematical operator representing the transformation of the first initial state of the first mode to the teleported non-Gaussian state of the second mode comprises applying an n^{th} degree polynomial in \hat{Q}.

15. The method of claim 14, wherein the n^{th} degree polynomial in \hat{Q} comprises a Hermite polynomial of degree n.

16. The method of claim 1, further comprising:
selecting a reflectivity of a beam splitter used to perform the photon subtraction on the first mode to reduce a probability of coupling more than one photon to the first portion such that a mathematical operator representing the transformation of the first initial state of the first mode to the teleported non-Gaussian state of the second mode comprises applying a polynomial comprising a single factor of a quadrature operator \hat{Q} on the first initial state.

17. A method for generating a squeezed cat state embedded in a one dimensional (1D) canonical cluster state, the method comprising:
receiving a pair of entangled modes from a source of entangled cluster state modes, wherein the pair of entangled modes is associated with the 1D canonical cluster state;
selecting a first mode of the pair of entangled modes in the 1D canonical cluster state;
performing a squeezing operation on the first mode of the pair of entangled modes in the 1D canonical cluster state to squeeze an initial state of the first mode; and
performing a photon-number-resolving detection on the first mode to transform an initial state of a second mode of the pair of the entangled modes to the squeezed cat state, wherein the second mode is an unmeasured mode.

18-37. (canceled)

38. A quantum system for generating a first cat state embedded in a one-dimensional (1D) canonical cluster state, wherein the 1D canonical cluster state is a continuous variable (CV) quantum cluster state of a plurality of modes, and wherein each individual mode of the plurality of modes comprises an optical field, the quantum system comprising:
a quantum apparatus configured to generate the plurality of modes forming the 1D canonical cluster state, the plurality of modes comprising at least one pair of entangled modes comprising a first mode having a first initial state and a second mode having a second initial state; and
a measurement system configured to control and perform measurement on optical fields of the individual modes of the plurality of modes, the measurement system comprising:
a beam splitter configured to split the optical fields;
a homodyne measurement device;
a photon counter; and
a controller comprising:
a non-transitory memory configured to store specific computer-executable instructions for controlling and measuring the optical fields; and
an electronic processor in communication with the non-transitory memory and configured to execute the specific computer-executable instructions to at least:
select a first mode of the pair of entangled modes and split a first optical field associated with the first mode into a first portion and a second portion of the first optical field using the beam splitter;
perform a photon-number-resolving detection on the first portion using the photon counter, wherein the photon-number-resolving detection transforms the first initial state of the first mode to a non-Gaussian state;
perform a homodyne detection on the second portion using the homodyne measurement device, to teleport the non-Gaussian state to the second mode to transform the second initial state of the second mode to a teleported non-Gaussian state; and
perform a feed-forward Gaussian operation on the second mode to transform the teleported non-Gaussian state of the second mode to the first cat state embedded in the 1D canonical cluster state.

39. The quantum system of claim 0, wherein the first and second initial states comprise encoded states.

40. The system of claim 0, wherein the electronic processor is configured to perform the feed-forward Gaussian operation by at least:
directing a second optical field associated with the second mode to a first port of a second beam splitter and providing a coherent laser beam to a second port of the second beam splitter; and
controlling an amplitude and/or a phase of the coherent laser beam to displace the teleported non-Gaussian state of the second mode.

41-50. (canceled)

51. A method of generating a first non-Gaussian state embedded in a cluster state, wherein the cluster state is a continuous variable (CV) quantum cluster state, the method comprising:
performing photon subtraction on a first mode of the cluster state to transform a first initial state of the first mode to a first initial non-Gaussian state, wherein the first mode is entangled to a second mode of the cluster state; and
teleporting the first initial non-Gaussian state of the first mode to the second mode to transform a second initial state of the second mode to the first non-Gaussian state of the second mode, embedded in the cluster state.

52. The method of claim 51, further comprising performing a feed-forward Gaussian operation on the second mode to transform the first non-Gaussian state of the second mode to a first cat state embedded in the cluster state.

53. The method of claim 51, wherein the CV quantum cluster state comprises a one-dimensional cluster state.

54. The method of claim 51, wherein performing photon subtraction on the first mode comprises performing a Photon-Number-Resolved detection on a portion of an optical field associated with the first mode.

55. The method of claim 54, further comprising generating the portion of the optical field associated with the first mode using a beam splitter.

56. The method of claim 51, further comprising teleporting the first non-Gaussian state from the second mode to a second non-Gaussian state of a fourth mode of the cluster state by:
teleporting the first non-Gaussian state to a rotated non-Gaussian state of a third mode in the cluster state, wherein the third mode is entangled to the second mode;
performing photon subtraction on the third mode to transform the rotated non-Gaussian state of the third mode to the second non-Gaussian state; and
teleporting the second non-Gaussian state to the fourth mode to transform an initial state of the fourth mode to the second non-Gaussian state, wherein the fourth mode is entangled to the third mode.

57. The method of claim 56, further comprising performing a feed-forward Gaussian operation on the fourth mode to transform the second non-Gaussian state of the fourth mode to a second cat state embedded in the cluster state.

58. The method of claim 51, wherein performing photon subtraction comprises subtracting and counting at least one photon.

59-67. (canceled)
